(19) United States
(12) Patent Application Publication
(10) Pub. No.: US 2025/0307786 A1
(43) Pub. Date: Oct. 2, 2025

(54) Full-Loop Method, Process and System for Enhancing Customer Convenience in Tandem with Increasing the Infrastructure of Recycling through Increasing Recycling of Single-Use Plastic Cups

(71) Applicant: Robert Coghlan, Hialeah, FL (US)

(72) Inventor: Robert Coghlan, Hialeah, FL (US)

(21) Appl. No.: 19/180,401

(22) Filed: Apr. 16, 2025

Related U.S. Application Data
(60) Provisional application No. 63/678,610, filed on Aug. 2, 2024.

(51) Int. Cl. G06Q 10/30; B29B 17/00

(52) U.S. Cl. CPC G06Q 10/30; B29B 17/00; B29B 2017/0089

(57) ABSTRACT

Full-loop, method, process and system for the manufacture, utilization, and reclamation of single-use plastic cups including a cup and a compostable coupling that inhabits the recess of the subjacent frustoconical recess of the cup and is comprised of hydrophilic, biodegradable composites that absorb condensation. The invention provides for customer convenience while enhancing recycling initiatives. Comprising a full-loop system that originates at inception with purposeful design and compostable composites the invention functions through behavioral prompting visual animating indicia during utilization. The invention revolves within compostable composites and their respective data and motif characterizations that are digitally visible on hydraulically crushed cups which instruct reclamation robotics to programmatically recognize, target and sort single-use plastic cups, collectively enabling a systemic pathway of manufacture, utilization, and reclamation of the cup and coupling for the purpose of expanding the infrastructure of recycling and accordingly preserve the life-sustaining elements of air, water, and soil.

### CROSS-REFERENCE TO RELATED APPLICATIONS

This application is a Continuation-in-Part of U.S. Provisional Patent Application No. 63/678,610, filed on Aug. 2, 2024, the disclosure of which is hereby incorporated by reference in its entirety. This application claims the benefit of priority to the aforementioned provisional application under 35 U.S.C. § 119 (e), including all subject matter disclosed therein.

### PETITION TO MAKE SPECIAL

The present application contains a Petition to Make Special under MPEP § 708.02 (a) based on the invention's material contribution to the enhancement of environmental quality. The petition is submitted herewith as part of the application.

### BACKGROUND OF THE INVENTION

The widespread adoption of single-use plastic drinkware, particularly Liquid Carrying Containers (LCCs) like plastic drinking cups, has introduced significant environmental challenges. These challenges include the improper disposal of plastic waste, leading to pollution in terrestrial and aquatic ecosystems, and the inefficiency of current recycling practices. Additionally, condensation that forms on cold drink containers creates secondary problems, such as surface wetting and slipping hazards, which contribute to operational inefficiencies and increased waste from additional cleaning supplies like napkins or towels.

Existing solutions to manage condensation, such as absorbent coasters, sleeves, or wraps, focus narrowly on improving utilizer convenience or moisture control but fail to address broader ecological concerns. Furthermore, current methods lack an integrated mechanism for promoting sustainable utilizer behavior or actively encouraging recycling. The present invention addresses these limitations by introducing a method and process for enhancing customer convenience in tandem with increasing recycling of single-use plastic cups. The invention's RNC utilizes hydrophilic materials to manage condensation effectively and incorporates water-activated animated ink to display ecological narratives. The RNC's hydrophilic properties in tandem with its narratives that educate utilizers about recycling during real-time usage, thus integrating practical functionality with environmental consciousness. Unlike prior art, which emphasizes structural reinforcement or moisture absorption in isolation, the present invention uniquely integrates condensation management with utilizer engagement to promote recycling. This approach not only mitigates the environmental impact of single-use drinkware but also aligns consumer behavior with sustainability goals, advancing the broader mission of reducing plastic waste and fostering environmental stewardship.

### Background of Plasticenes and their Impact Upon the Environment

Plasticenes have become a ubiquitous part of modern society as they and their utilization have revolutionized the way humans live their lives. However, the widespread utilization of plasticenes has come at a cost to the environment. Plastic waste, in the form of LCCs such as plastic cups, as well as bags, bottles, packaging, and microplastics, have become a major problem for the health of our planet and its inhabitants. Plasticenes are slow to degrade and can linger in the environment for hundreds of years.

Accordingly, when plastic waste accumulates in the environment, it causes a wide range of environmental problems. For example, though not limited to the following examples, plastic waste that has been discarded into the ecosystem can harm wildlife inclusive of marine organisms such as though not limited to sea turtles and whales, who mistake plastic bags and other debris for food, and as well, impact the food chain of smaller organisms inclusive of microorganisms. Plastic pollution can also release harmful chemicals into the soil and water, which contaminates food and water sources for humans and wildlife such as though not limited to birds and terrestrial dwelling animals alike. Additionally, the process of producing plasticenes releases toxic chemicals and greenhouse gases into the air, further contributing to ecological degradation. And plastic litter can be harmful to terrestrial animals, as plastic pollutants interfere with plant growth leading to a decline in biodiversity. Accordingly, a key ambition of the present invention is directed towards the cause of a fresh innovative approach of communicating recycling narratives. Of peculiar importance therefore is the present invention's major utility that is directed towards its main objective of materially enhancing the quality of the environment by the methods set forth in its claims, abstract, drawings and specification whereby the present invention's methods contribute to the restoration or maintenance of the basic life-sustaining natural elements, i.e., air, water, and soil.

Estimates range that some five hundred billion plastic cups are produced each year globally, some presenting common and timeworn, unheeded recycle messages, and those that have been disposed of have led to unprecedented crisis levels of a magnitude of global environmental concern as illustrated herein. The present invention and the manner by which it is formed into an LCC/RNC ensemble is directed towards the cause of enhancing the quality of the environment by supporting a sustainable alternative for the health of our planet's ecosystem and future generations through its methods that materially mitigate the disposal of plastic cups by providing an inked imprinted, invisible to visible, animated recycling narrative upon the outer shell of its RNC that propagates during utilization and arouses recycling endeavors of the ensemble.

Advocating for recycling via a dynamical auto-molecularly operating narrative that emerges upon the outer shell of the RNC when condensation droplets form on the sidewall of the LCC and are drawn downwards by a gravitational field to the RNC and interact with its invisible ink a reaction between the ink and the water occurs and propagates an inked visible narrative on the outer shell of the RNC sparks imagination and is fun to watch as it unfolds over a period of time and accordingly, though there is no audio, the animation, in a sense, ‘visually speaks’ in an excitable format that rekindles and invigorates recycling. And, as condensation droplets form upon the side of a cup when fluid within the cup in relation to natural atmospheric conditions are ripe for producing such naturalistic happenings, effectually, through the process and methods as illustrated herewith in terms of a recycle narrative emerging as an animation upon the RNC, nature is visually speaking to humans and requesting of the humans to save nature itself by more often recycling the plastic cup and coaster ensemble. Within the essence of nature visually speaking to humans and requesting of human to save it, principals of pleasure are stimulated when what is a commonly unnoticed recycle message print on the side of conventionally produced cups, sometimes even being translucent on a translucent cup and being nearly unseen, into a refreshing animation that is colorized in contrast to its carthy hemp colorized background with the appearance of an carthy green color that increases clarity and rejuvenates enthusiasm for recycling and ushers in a fresh new recycling era in relation plastic cups.

While in the present invention the recycling narrative is drawn up in such a fashion as to be illustrative and not limiting, the inventor of the present invention envisions practitioners of the art of production of recyclable tableware, and those associated with its production inclusive of though not limited to commercial graphic artists, marketers, and designers, to stir and set their imaginations free and increase the utility and likewise the art of animation upon the outer shell of the RNC by creating forms of artful narratives that move imagination and likewise move the nature of the present invention's concept forward during the lifetime of the practice of its art. All of these pursuits are beneficial to the utility and cause to which the present invention is directed; to materially enhance the quality of the environment by contributing to the restoration or maintenance of the basic life-sustaining natural elements, notably, the air, water and soil and the species that depend on their health.

Artisans of manufacture, manufacturers, or of practice, restaurateurs, in the field of endeavor to which the present invention pertains or is most closely connected to, will appreciate its qualities in the form that single-use beverage containers, are precisely made for one use, as they have no accompanying RNC. The present invention, and its appreciable benefits are that it bears a unified utility; for preventing condensation from pooling on a surface, for drying a wet surface as it may be manually governed and animating a recycling narrative that enhances recycling interests through methods set forth herein, and in turn, the quality of the environment. In view of these interests, the present invention's RNC's auto-molecular methods save time and likewise money in mitigating labor hours and similarly, saves money in mitigating supply utilization and reduces the amounts of plasticenes in landfills and for such reasons, materially enhances the quality of the environment.

### SUMMARY OF THE INVENTION

The present invention introduces an eco-conscious solution designed to increase recycling efforts for single-use plastic cups by integrating a unified apparatus that combines a Liquid Carrying Container (LCC) with a Recycle Narrating Coupling (RNC) that is nested with the recess of the subjacent frustoconical structural rib of the cup, forming and herein understood as and, “LCC/RNC”. The RNC, constructed from biodegradable and recyclable composites such as hemp, features advanced hydrophilic properties that absorb and retain condensation. This moisture management occurs through capillary action and an embedded reservoir region, which collect streaming condensation from pooling on surfaces, keeping them dry and hygienic. Additionally, the invention incorporates water-activated invisible ink imprinted indicia on the RNC, which undergoes a colorization phase transition from invisible to visible ecological messages during use, educating utilizers about proper recycling practices. Or alternatively, the ink can be tinted to match or camouflage with the color of the hemp that comprises the coupling which in a general sense a beige or pastel ochre color. Then when interacting with water it undergoes a dynamic colorized phase transition whereby its colorization contrasts with the beige or pastel ochre colorization of the hemp-colored coupling and becomes thereof visually readable.

The LCC/RNC is ergonomically configured to function as a unified system, with the RNC securely mounted by frictional engagement to the recess of the subjacent frustoconical structural rib of the cup. The structural compatibility ensures stability during use and a seamless integration between the two components for the purpose of providing case of condensation water droplets to transfer from the cup's outer shell and into the coupling. The innovative coupling mechanism not only enhances utilizer convenience but also contributes to sustainability by reducing the reliance on disposable coasters or separate moisture-absorbing solutions.

A dual-purpose configuration sets the invention apart from known art as it combines practical functionality with ecological education. The condensation activated messaging system actively engages utilizers, encouraging them to guide the apparatus toward recycling bins after use. This approach addresses the long-standing challenge of increasing utilizer compliance with recycling programs by introducing an interactive and educational element to single-use beverage containers. Furthermore, the use of eco-friendly materials such as biodegradable composites aligns with the invention's sustainability objectives. The RNC's hydrophilic composition and capillary action reduce the need for traditional cleaning methods, mitigating labor and material costs in commercial settings. By addressing both environmental and practical challenges, the invention not only supports existing recycling infrastructures but also promotes broader ecological awareness through an innovative, interactive utilizer solution.

### Methods of Practice

In all views (Claims) of the invention, and their eco-friendly composites maintain a singular species as the utilities of the present invention are ‘unified’, Specifically, the three purposes (utilities) of the present invention, more notably the third, a water activated inked imprinted invisible to visible animated ecological educational narrative that propagates upon the outer shell of the, for the purpose of this disclosure, and LCC/RNC and the ECPC during utilization, are ‘unified’ in the sense that for the third and more notable utility to be realized, the first two functional utility is performed and engages the ongoing utilities. Simply, the condensation droplets activate the recycling narrative. In this sense, the entirety of the present invention's utilitarian purposes are unified. The terms, ‘purposes’ and ‘utilities’ are utilized interchangeably in the present application and are determined by context. In providing the present application in such a manner, the present application's intention is to provide a step-by-step illustration of how the functionality of the present invention's utilities are realized.

### Artisans and how to Utilize the Present Invention

The present application herein illustrates, for enablement requirements, to one ordinarily skilled in the art of the utilization of disposable tableware, how to utilize the present invention in relation to its unified utilities; preserving a dry surface that an ECPC is placed upon, and also drying a wet surface and provide ECPCs during certain atmospheric conditional elements. Accordingly, an ECPC may be utilized in its field of endeavor in at least the following ways. One, to preserve a dry surface when a cup is carrying a liquid and emanating condensation, two, to dry a pre-wet surface, and to incentivize patrons to recycle the EC that accompanies the PC.

With the aforementioned set of dynamics of steps for manufacture and the selected composite of hemp in mind the inventor of the present invention provides an outline in relation to utilization of the present invention. For a purview of the present invention's utilization take the current relations together with the drawing portions of the present application. See drawings.

### Practice of the Art of the Present Invention

An artisan, in the instance of the present invention, commonly, a restaurateur, would initially select an ECPC or set of ECPCs predicated on necessity. Necessity would be determined by the restaurateur's inventory of current disposable tableware at the restaurant. The restaurateur would as well survey the activity of the restaurant's patrons in relation to their utilization of current supplies of plastic cups. Next, the restauranteur would consider the condensation that emanates upon and drips from the shell of the plastics cups and collects in pools of water on surfaces at the restaurant. Subsequently, the restaurateur would upgrade the supplies of plastic cups to ECPCs of sizes and volumes that best address the aforementioned necessity.

During certain atmospheric conditional elements, particularly when warmer climatological conditions are prevailing and when patrons are requesting chilled beverages are indicator to artisans, in the present instance, restaurateurs, that ECPCs should more often be implemented as condensation droplets are more likely to emanate upon the PC's sidewall and engage the EC's utilities. Thus, a restaurateur would monitor prevailing and forecast climatological conditions to ensure proper stocks of EC and proper climatological conditions to deploy them.

Restaurateurs as also aware of the concept of offsetting costs of the ECs and in fact, reduce overall supply costs, and likewise increase overall profit margins through the reduction of overall supplies. As objective of the present invention is to decrease overall supply usage which I in turn beneficial to the environment, and as well save time and money in the form of reducing labor cost related to wicking pooled condensation and the materials needed perform the task of doing so. To this point as free-standing self-serve beverage dispensaries are a customary practice in restaurants, the restaurateur would set up the beverage dispensaries with the RNCs and perhaps with other non ECPC ensembles. Of noteworthy interest in relation to the practice of the present invention, when a patron selects an ECPC such activity indicates their willingness to cooperate in recycling interests and the benefits of the present invention are realized.

In this view, restaurateurs would deploy quantities of the ECPCs in strategic areas, likely in a cup dispensary or free standing, in localized immediacy to where beverages are being poured into cups by employees. Or place the ECPC in proximity to self-serve beverage dispensaries, and as well display a recycle emblem placard on the dispensary so patrons may easily identify and access the ECs in order to fill them with beverages. The artisan would train the employees in relation to how and when to utilize an ECPC. For example, training employees to dispatch ECs when patrons are utilizing outdoor seating on relatively warm days or when conditions of both indoor and outdoor areas of the establishment are conducive to generating condensation on the sidewalls of PCs. And professionally train the employees in relation to how the ECPCs are utilized to perform their function as detailed herein, and as well illustrated in the drawings section of the present application.

The restaurateur would provide a patron that has ordered a beverage with an ECPC containing the beverage. The patron would likely either handhold the ECPC and/or place it upon a surface in the restaurant where it would remain stationary, except when the patron is consuming the beverage. Or an employee would place the ECPC on the surface of a table, dinette countertop or bar surface at the restaurant, dinette, bar, or the like. Next, in the eventuality the PC emits condensation the functional methods of the present invention would actualize as illustrated herein. Accordingly, there would be little to no need for the patron to take further action as the auto-molecular forces of the present invention would perform the functions auto-molecularly. Although, where the patron would self-initiate drying a wet surface, the patron would manually govern the ECPC as previously entailed and dry a surface by gripping the ECPC in an area above the RNC and circulate the undercarriage of the ECPC in a liquid drying motion upon the water that is on a surface at the restaurant. The ECPC would dry the surface by utilizing the same methods of auto molecular forces, though in the current manner of operation, the ECPC would be in motion as per the manual efforts of the patron.

Lastly, and as illustrated likewise in an associated portion of the present application, as an increasing volumetric of water is being stowed in the EC's reservoir region, the reservoir region of the EC expands. The expansion of the EC's reservoir region creates a convex profile on the EC. The convex profile indicates to one ordinarily skilled in the art of disposable tableware that the EC is filling or has filled with water. Once the EC is filled with water the artisan will dispose of it into a recyclable bin as in the present invention's preferred embodiment, the EC's composite is comprised of the recyclable composite of hemp.

### Introduction to the Narrative of: “Psychological of Ergonomics and its Motivations in Light of Customer Convenience and Influence on Recycling Efforts”

In light of the concept of the invention being centered upon two (2) primary utilities and how such utilities influence customer convenience and recycling efforts it is important to narrate about the customer's sentiment and how the utilities of the invention motivate the customer to want and utilize the invention. Accordingly, a narrative of the nature of the customer's psychology in the absence of the invention and in turn, the presence of the invention will help in understanding why the invention was invented. What follows is a case study of a theoretical customer. The case study and respective reflection upon the customer, who is in this instance is one person visiting a café on a warm day to enjoy an iced coffee in a single-use plastic cup is presented herein. It illustrates the customer's mindset and likewise activities as the customer arrives and goes about the activities of entering the café, ordering an iced coffee, finding, and sitting at a table in the café, and the decisions and efforts the customer needs to make in order to be comfortably seated at a dry and relatively hygienic café table. The narrative also illustrates the mutual mindset of the customer when realizing the café has taken their interests of convenience into consideration and provided them with the invention, and in return, the customer's activity of reciprocating the conscientiousness of the cafe and recycles the invention.

While different manifestation of the same activities may occur in family groups or larger gatherings of people, the activities of such groups and gatherings of people would be relatively the same as the single individual. Therefore, it is important to take the account of the single individual not in a limited sense, though as illustrative of the concept and associated functional utilities of the invention in its application across diverse sets of people who are herein understood as a ‘customer,’ ‘consumer’ or ‘they.’ In order to form mutual understanding between the inventor of the present invention and those who will manufacture and utilize it at locations such as cafes a review of the content of the following narrative, though theoretical, should be understood as a realistic illustration of such a customer's experience.

Narrative—Absence of the invention

Afternoons, in fact mornings and evenings can be warm and often be accompanied with humidity. Chilled drinks are the best! Imagine if you will one of those idyllic days when the sun shines just bright enough to invite people outdoors. A gentle breeze sweeps through the streets, carrying the faint aroma of freshly brewed coffee and baked goods. The day, one might think, for enjoying a refreshing iced beverage at a local café, seated at one of their charming outdoor tables. This was precisely the thought of a customer as they strolled up to their favorite café, a place they often frequented for its ambiance, its convenient location, and most importantly, its promise of a calm, relaxing experience with a cold refreshing drink.

As they approached the cafe, the customer noticed that the outdoor seating was bustling with patrons. Several tables were occupied, and some were still available. Inside, the usual pleasant murmur of coffee orders, clinking cups, and friendly chatter filled the air. The customer proceeded to the counter, placing their order for an iced coffee, envisioning the cool condensation on the outside of the plastic cup, the clink of ice cubes, and the refreshing burst of coldness as they took their first sip. It was exactly what they had been looking forward to all day.

With iced coffee in hand, the customer stepped outside again, scanning for available tables. This is where the first subtle disruption to the envisioned experience emerged. All the available tables were wet by the unmistakable remnants of previous customer's drinks and their rings and pools of condensation scattered across the surfaces; reverberations of earlier patrons enjoying iced drinks in warm weather. The sight caused the customer to hesitate. What was meant to be an immediate act of sitting down and enjoying the drink had now been interrupted by an inconvenient reality: the table needed to be dried. The customer paused, iced coffee in hand, standing in indecision. They could take the initiative and dry the table themselves, or they could flag down one of the café employees to manage it. Neither option felt ideal.

### Psychological Impact of Inconvenience

The simple act of choosing a table, an ordinary subconscious decision, had now become a source of mild anxiety causing a change in their sentiment. The customer considered the options. Taking the matter into their own hands meant walking back inside to grab some paper napkins. In itself, this was not an arduous task, but it disrupted the seamless flow of what was supposed to be a relaxing experience. Worse, it came with certain psychological undertones, the customer would now have to dispose of the soggy napkins in a garbage or recycling bin or leave them scattered about on some corner of their table in a clump, something they would have rather avoided, especially at the beginning of their visit when their hygiene mode was heightened. This seemingly small interaction with the waste disposal or clumping the napkins upon the corner of their table disrupted the cleanliness they preferred to maintain when settling down to enjoy a cold drink.

As the customer contemplated this, their mind briefly wandered to the potential awkwardness of asking an employee to clean the table. The customer was not necessarily in the mood to engage with the staff beyond placing their order, especially not in a way that could be perceived as causing inconvenience to the busy employees. There was also the subconscious notion of appearing fussy or pretentious, something the customer wanted to avoid. The café was bustling, and while the staff would likely clean the table without issue, the customer felt that interacting with them for such a reason was unnecessary and even slightly uncomfortable. It created a sense of formality where none was expected, pulling the customer out of the envisioned solitary refreshing experience. Additionally, the customer was there on their own, which brought its own layer of complexity. Without the buffer of a companion, every interaction felt more significant. When you are with friends, requesting assistance from staff can feel like part of a group effort. On your own, however, it felt like more of a direct engagement with the employees, which only heightened the feeling of intrusiveness. The customer began to feel the mental tug-of-war between taking independent action and relying on someone else, neither of which aligned with the carefree and uninterrupted experience they had anticipated.

### Unanticipated Experience Disruption

The customer had not anticipated any of this. In fact, earlier in the day, while getting ready to leave home and on their way to the café, they had envisioned a much different scenario. They had imagined ordering their iced coffee, sitting down at one of the café's outdoor tables, and simply enjoying their drink while basking in the warm afternoon sun. They had not considered the possibility that they would need to dry pooled condensation rings from a table or request help from the staff. In their mind, the café was a place of respite, an oasis of minimal interaction and maximum relaxation. The iced coffee, the outdoor seating, the gentle breeze, it was all part of a meticulously crafted mental image that involved little to no inconvenience.

Though now, confronted with the reality of a table covered in condensation, the customer's expectations were interrupted. The minor inconvenience of needing to deal with the wet table was magnified by its discord with the imagined experience. What was supposed to be a brief respite had now turned into a situation requiring thought, sentiment shift, decision-making, and action, all of which detracted from the overall sense of ease the customer had been seeking.

### Internalized Psychological Conflict

In resolve, the customer opted to handle the situation themselves. They stepped back inside the café, retrieved a few paper napkins, and began wiping the condensation rings. With each swipe of the napkin, a small sense of dissatisfaction crept in with the unwarranted work. This was not how the experience was supposed to go. Now, having dried the table of its pooled condensation, they had to tuck them in some corner of their table or dispose of the damp napkins, which required visiting the garbage or recycling bin. At that moment, the customer could not help but feel that their sense of personal hygiene would be compromised. Coming in proximity or touching the bin, even indirectly, created a slight but noticeable discomfort, further detracting from the original expectation of a carefree, relaxing afternoon. There was also a fleeting feeling of wastefulness, the customer had used several napkins, far more than they would have liked, simply to dry the table. Again, this was a small matter, but in the context of their experience, it contributed to a growing sense of disruption. The action of drying the table from wet, pooled rings of condensation was neither planned nor desired, and though it was quickly done, it left an imprint on the customer's mood. They finally sat down with their iced coffee, but the experience had already shifted away from the serene, effortless moment they had imagined. The interruption, while minor, created a subtle undercurrent of dissatisfaction that lingered in the back of their mind.

### Unseen Effects on the Customer's Perception

The psychology of the customer in this scenario reveals a broader theme about the importance of convenience in shaping consumer experiences. Even small inconveniences, such as a wet table, can have a disproportionate impact on a customer's perception of their experience. In this case, the act of having to dry the table or ask an employee to do so created an internal conflict that affected how the customer viewed the café and their visit. The seamless, effortless experience they had envisioned was disrupted, and with that disruption came a cascade of minor dissatisfactions, each one compounding the next. From a psychological perspective, this illustrates how customers value not only the product they are purchasing, in this case, an iced coffee, but also the context in which they consume it. The cafe's ambiance, the condition of the seating, and the ease of settling into their chosen spot all contribute to the customer's overall experience. When these peripheral factors fail to meet the customer's expectations, it can tarnish the experience and sentiment in subtle but significant ways.

As the customer finally settled into their seat, sipping their iced coffee, they could not help but reflect on how the experience had been altered. The condensation on the table, the extra trip inside, the napkins, the brief interaction with the waste bin, the surprise decisions, all these minor inconveniences had, in some way, colored their perception of the café. While the iced coffee was refreshing, the experience was no longer the effortless escape for which they had hoped. Instead, it became a reminder of how even the smallest inconveniences can disrupt an otherwise peaceful moment.

### Presence of the Invention

As the customer enters their favorite café, they are greeted with the familiar ambiance of warm lighting, gentle music, and the pleasant hum of chatter. But today, something new catches their eye: an ergonomically designed cup with an carthy look and a hemp composite coupling situated around the invention's base. Not only does it look appealing, but it also speaks to a greater initiative of the café, one that places a priority on both customer convenience and environmental stewardship.

When the barista hands over their iced coffee in the invention, the customer feels an immediate sense of appreciation. This is not just any cup; it is designed to prevent condensation from collecting on tables, offering a balanced and thoughtful solution to an inconvenience they have encountered countless times before. The café has clearly invested in something that directly benefits its patrons, making it easier for them to enjoy their experience with minimal hassle. This small act, the restaurant's choice to provide the invention, demonstrates a mutual interest in comfort and care, fostering a deeper connection between the customer and the café. In that moment, the customer feels like more than just a transaction; they feel like a valued part of a community that is genuinely invested in their satisfaction.

### Change in Psychology: The Positive Transformation Through Ergonomics

With the introduction of the invention, the customer's experience at the café shifts to one of complete convenience, enhanced comfort, and enjoyment. The ergonomic design of the invention is thoughtfully crafted to adapt to the customer's needs, ensuring that every interaction is effortless and intuitive. As the customer enjoys an iced coffee at an outdoor café table on a warm day, the invention's design works seamlessly in the background, managing condensation, maintaining a clean surface, and providing a comfortable, easy-to-handle cup. This allows the customer to fully immerse themselves in their experience of the invention's enhanced ergonomics ensures that the customer's visit is not only more convenient but also more enjoyable, reinforcing a sense of ease and relaxation throughout their time at the café. The product elevates both the physical and psychological aspects of comfort, turning an ordinary visit into a memorable, carefree experience.

### A Fresh New Focus: The Influence of the Invention on Customer Experience

As soon as the customer receives a cold beverage served in the invention, their experience shifts to one of effortless relaxation and convenience. The enhanced ergonomic configuration of the invention immediately allows the customer to enjoy their time at the café, fully immersing themselves in the moment. Whether seated indoors or at an outdoor café table on a warm day, the customer no longer needs to think about condensation or maintaining a clean surface. The invention's adaptive, utilizer-friendly design collects condensation efficiently, keeping surfaces dry and the environment pleasant. This seamless functionality removes the need for extra accessories like napkins or coasters, providing a streamlined, hassle-free experience. The ergonomic qualities of the invention ensure the customer feels completely at ease, enhancing both their physical comfort and overall enjoyment. This positive, thoughtful design fosters a deeper appreciation of the café environment, where the customer feels their convenience and comfort are truly prioritized, leaving a lasting positive impression.

### An Intuitive, Streamlined Experience of Convenience

With the invention, the entire café experience becomes streamlined and effortless, ensuring that every moment of the customer's visit is enjoyable. The invention's enhanced ergonomic configuration seamlessly supports the customer, allowing them to move from one part of their visit to the next without interruption. The intuitive features of the invention effortlessly manage condensation, keeping surfaces clean and dry, allowing the customer to focus on more meaningful activities like conversations, reading, or simply relaxing. As the customer enjoys iced coffee, their mindset and sentiment naturally shifts to one of satisfaction and ease, as the invention adapts to their needs without any effort on their part. The cup remains stable and balanced on the table, as it collects streaming condensation into its hemp-based coupling. This well-designed, practical feature fosters a strong positive association with the café experience, creating an environment where everything feels natural and supportive. By eliminating the need for attention to minor inconveniences, the invention enhances the overall ambiance and strengthens the customer's connection to the café, leaving them with a deep sense of satisfaction. Knowing that the café cares about sustainability by choosing to provide eco-friendly products, the customer feels a sense of responsibility to reciprocate the café's consideration.

### Unified, Enjoyable, Streamlined Recycling Experience

The invention's adaptive and ergonomic design makes recycling an intuitive and enjoyable part of the customer's overall experience. When it is time to recycle the cup, the customer feels a sense of accomplishment, knowing they have used a product that prioritizes both comfort and environmental sustainability. The recycling process is effortless and aligns seamlessly with the convenience they experienced throughout their visit. The invention's thoughtful design, from condensation collection to compostable materials, empowers customers to make eco-friendly choices with ease. The product's ergonomics ensure that recycling feels like a natural extension of their interaction with the invention, not an additional task. By linking convenience with sustainability, the invention fosters a sense of well-being, leaving customers with a stronger connection to their positive experience and a reinforced sense of purpose and satisfaction.

### Mutuality Mindset

As the customer leaves the café, the benefits of the invention continue to shape their positive mindset. The ergonomically enhanced configuration, paired with its eco-conscious features, naturally encourages customers to embrace environmentally responsible behaviors. The transition from enjoying a cold beverage to participating in recycling feels effortless, thanks to the utilizer-friendly design of the invention. The final act of recycling is a seamless reflection of the overall experience, where convenience and sustainability work hand-in-hand to enhance both customer satisfaction and environmental responsibility. The customer departs feeling fulfilled, knowing they have made responsible choices with no extra effort. The invention fosters this mindset by integrating ergonomic convenience and sustainability in a way that feels natural and easy. Through this seamless interaction, the invention inspires customers to make responsible, eco-friendly decisions, ultimately fostering a positive mindset that enhances both their sense of contribution to sustainability and encouraging their reflections of the café. Over time, this small gesture fosters a culture of mutuality, where customers feel inspired to return and contribute to the cafe's eco-conscious efforts regularly. Each visit reinforces a trusting relationship that goes beyond just coffee; it becomes a partnership rooted in shared values and a commitment to creating a balanced, supportive environment. The café, through its thoughtfulness, has not only won the customer's loyalty but has also cultivated a community that values sustainability and cooperation. In future visits, the customer finds themselves naturally drawn to engage in this cycle of mutuality. This cooperative exchange, initiated by the cafe through the thoughtful introduction of the invention, strengthens their bond and builds a foundation of mutual respect and trust. The café's investment in its patrons' comfort and in sustainable practices has fostered a supportive relationship that encourages customers to give back by participating in eco-friendly practices.

### Principle Effects of Letters, Words, Symbols, Icons; Collectively ‘Indicia’ and Associated Human Actions in Relation to the Indicia on the Invention and Associated Human Actions

Letters, words, symbols, icons, and indicia often have a principal effect to compel individuals to take specific actions that parallel the concepts of the indicia they engage with. Such effects are well evidenced in history, contemporary and current practice. This principle is exemplified through universally recognized prompts like the word “PULL” on a door, which transforms the abstract concept of the wording from ambiguous interactions into unambiguous actions by providing clear, actionable guidance. Similarly, the invention leverages the principles of abstract messaging by presenting dynamic ecological narratives that propagate on its coupling during use. Its narratives serve as a medium to educate and prompt individuals toward recycling actions, rooted in the same behavioral tendencies that make clear indicia like the word, “PULL” on a door effective.

People are more likely to act based on the information they directly engage with, especially when it is presented in an immediate and accessible manner. In fact, people engage with letters, words, and indicia throughout their day in the form of traffic signage that instructs them, printed text on documents, digitally text and imagery that instructs them and visual displays in advertisement both printed and digital that informs them. It should be apparent that the invention joins the rhythm of people engaging in with letters, words and indicia throughout their day by embedding its messaging into an interactive and visible context, by the imprinting of the animated narratives on the compostable coupling that characterizes the invention as a single parcel and ensures that utilizers encounter the narratives at precisely the moments when behavioral decisions-like recycling—are made. By combining engaging ecological messaging with practical functionality, the invention underscores the principle that well-designed abstract indicia not only inform but also increase the likelihood of corresponding actions, thereby enhancing its utility and impact. See following.

### Parallels Between the Invention's Recycling Messaging and Instructional Signage

The practice of aligning abstract concepts with tangible actions has long been a cornerstone in behavior modification and instructional design. When applied effectively, such mechanisms bridge the gap between passive understanding and active participation. Consider the ubiquitous word “PULL” emblazoned on a door. This single, simple term provides immediate clarity, prompting individuals to execute the correct action-pulling the door-thereby eliminating confusion or missteps. Similarly, the innovative messaging on the invention (See Drawings for example narratives), serve as an educational and behavioral prompts, encouraging individuals to recycle cups and coasters with greater frequency. The abstract ecological educational messaging on the invention mirrors the utility and effectiveness of the “PULL” instruction, thereby creating a compelling case for recognizing the functional significance of such messaging with the claims of the present invention.

### Abstract Messaging as a Behavioral Catalyst

The word “PULL” on a door exemplifies how abstract instruction can transform an ambiguous interaction into an unambiguous action. Before encountering the instruction, individuals might hesitate, push instead of pulling, or experience frustration. The clarity of the word “PULL” removes the guesswork, prompting the correct action almost instinctively. This clarity fosters efficiency, reduces errors, and enhances utilizer satisfaction. Similarly, the invention's ecological messages, activated dynamically through condensation and invisible ink, transform a passive interaction-merely holding or observing a beverage container-into an active moment of ecological awareness. The messaging on the invention transcends mere ornamentation. It educates and inspires action by visually animating recycling narratives. This dynamic interaction rekindles interest and enthusiasm for recycling, making it more likely that individuals will recycle the invention and its accompanying cup. Just as “PULL” helps individuals navigate doors without hesitation, the ecological narratives guide individuals toward an environmentally conscious decision without requiring external intervention or additional resources.

### Visual Clarity and Immediate Impact

Both “PULL” signs and the invention's narratives rely on the immediacy of their visual clarity to elicit action. In the case of the invention, the animated interplay between condensation and invisible ink captivates the audience. The gradual appearance of the recycling message sparks curiosity and engagement, holding the observer's attention long enough to deliver its ecological message. This mirrors the instant recognition of the “PULL” instruction, which is designed to capture attention at precisely the moment of need. Furthermore, the use of visually engaging narratives in the invention elevates its functionality beyond that of traditional recycling symbols, which often go unnoticed. Conventional recycling logos on translucent or opaque plastic cups fail to stand out, diminishing their effectiveness as behavioral prompts. The invention addresses this limitation by using contrasting colors, dynamic animations, and creative slogans that demand attention and foster a sense of responsibility. This enhancement parallels the way a well-placed “PULL” sign resolves confusion and ensures compliance.

### Bridging Abstract Concepts and Practical Application

One might argue that recycling narratives are inherently abstract and thus non-patentable. However, this overlooks the role of such narratives in bridging the gap between abstract ecological principles and concrete recycling behaviors. The invention's messaging transforms abstract educational concepts into practical applications by embedding them into a tangible, interactive medium. Similarly, the “PULL” sign bridges abstract spatial orientation-understanding how a door mechanism operates—with the physical act of pulling. In both events, the medium becomes the message. The invention messages and the “PULL” sign are not merely passive conveyers of information; they actively shape behavior by presenting information at the critical moment of decision-making. This immediacy ensures that the abstract concept-whether it be ecological responsibility or the correct way to open a door-is internalized and acted upon without delay.

### Encouraging Repetition and Habit Formation

Another compelling parallel is the role of these mechanisms in habit formation. When individuals encounter a “PULL” sign repeatedly, they begin to internalize the correct behavior, eventually executing it without conscious thought. The invention's dynamic narratives have a similar potential to establish new recycling habits. By repeatedly presenting engaging and thought-provoking messages, the invention ensures that the act of recycling becomes associated with positive reinforcement and a sense of purpose. Moreover, the use of varied and creative narratives on the invention prevents monotony and sustains interest over time. This approach aligns with the principles of effective habit formation, which emphasize the importance of novelty and engagement in reinforcing desired behaviors. The “PULL” sign achieves this through its universal application and simplicity, while the invention achieves it through its artistic and ecological innovation.

### Enhancing Utility Through Contextual Relevance

The utility of the invention extends beyond individual behavior to address broader environmental challenges. The narratives, tailored to resonate with ecological themes, foster a sense of collective responsibility and urgency. This contextual relevance amplifies their impact, much like the “PULL” sign's relevance in navigating physical spaces enhances its utility. Both examples demonstrate that abstract concepts, when contextualized effectively, can drive meaningful change. the LCC/RNC's emphasis on ecological education serves a dual purpose: it informs individuals about the importance of recycling and motivates them to participate actively. This duality enhances the product's overall utility, aligning it with the goals of environmental sustainability. Similarly, the “PULL” sign contributes to a safer, more efficient environment by reducing confusion and facilitating seamless navigation.

### The LCC/RNC's Relation to Human Behavior

Human behavior is inherently complex and often defies strict predictability, even in the presence of clear instructional cues. This complexity is a critical consideration when evaluating the utility of the ecological messaging on the coupling of the invention. While the messaging encourages individuals to recycle the cup and coupling, it is important to address potential arguments that such prompts cannot guarantee recycling behavior. Similarly, one might argue that a “PULL” sign on a door ensures that all individuals will pull rather than push the door. However, this oversimplifies the dynamics of human behavior. The presence of indicia like ecological messaging or instructional signage significantly increases the likelihood of the desired action-recycling or pulling the door-without guaranteeing universal compliance. By examining these parallels, it becomes evident that the invention is designed to encourage recycling more often much like a “PULL” sign that influences proper door operation more often.

A clear example of the unpredictability of human behavior can be observed with doors that bear the “PULL” sign. While the sign provides direct and unambiguous instructions, individuals sometimes push the door instead of pulling it. This might happen because they find pushing easier while carrying something in one arm, or simply out of habit or momentary inattention. Even among literate individuals who see and understand the sign, personal preference or convenience may override the instructional indicia. Despite this variability, the “PULL” sign significantly increases the probability that individuals will pull the door correctly. Without such indicia, people would resort to trial and error, pushing and pulling until they determined the correct operation. The presence of the sign reduces this ambiguity, guiding a majority of individuals toward the intended action.

In the same way, the invention's ecological messaging functions as a behavioral prompt. When individuals see the animated recycling narratives on the coupling, they are encouraged to recycle the ensemble. This prompt transforms a passive interaction into an active decision, aligning personal action with environmental responsibility. However, just as with the door, some individuals may choose not to follow the prompt. They might dispose of the coupling in a waste bin instead of a recycling bin, perhaps out of convenience or disregard for the message. This variability does not negate the utility of the messaging. Rather, it underscores its purpose: to make recycling more likely.

While no claim of the present invention is directed toward human behavior, the notion that the invention anticipates human behavior misses its inventive concept. The invention's purpose is to increase the frequency of recycling compared to scenarios where no messaging is present. The comparison to the “PULL” sign is particularly apt in illustrating this point. In the absence of instructional indicia, people are left to guess or follow their inclinations, which often results in suboptimal behavior. Without ecological messaging, individuals are less likely to recycle a cup and coupling. While long and well known in the practice of the art of printing recycling messages on objects that can be recycled, the dynamic, animated narratives of the invention elevate the art, making recycling not only a clear choice but also an engaging one. This engagement is key to influencing behavior, as it taps into curiosity, interest, and environmental awareness.

To support clarity of mutual understanding of the predictability of behavior, it is essential to emphasize that indicia are tools for influence, not guarantees of compliance. Human behavior is shaped by a multitude of factors, including context, habit, and convenience. Indicia like the messaging on the invention or the “PULL” sign on a door operates within this framework to guide decisions. They do not eliminate variability but significantly reduce it. The value of these prompts lies in their ability to shift the odds toward the desired outcome. For the LCC/RNC, this means more frequent recycling of the cup and coupling, contributing to environmental sustainability.

The parallels between the invention and the “PULL” sign reinforce such concept. Both are designed to address the same fundamental challenge: guiding human behavior in a specific direction. Just as a “PULL” sign reduces the guesswork and increases correct door operation, the invention's ecological messaging reduces the likelihood of improper disposal and increases recycling rates. In both cases, the absence of indicia leads to less predictable and often less desirable outcomes. Conversely, their presence creates a clear, accessible pathway for individuals to make better decisions.

### Summary of Indica Utility

The parallels between the “PULL” sign and the invention's recycling narratives underscore the transformative power of abstract concepts when embedded within functional designs. Both examples illustrate how well-executed messaging can bridge the gap between understanding and action, fostering new behaviors and enhancing utility. The invention's ability to increase recycling rates through engaging and dynamic narratives demonstrates its functional significance and aligns it with the principles of effective behavioral design. By recognizing the parallels between these two examples, it becomes evident that abstract educational concepts, when coupled with innovative materials and methods, can achieve their goal as the invention's ecological messaging is not merely decorative; it is an integral component of its function, much like the “PULL” sign's role in facilitating seamless navigation of the proper operation of a door. Together, these examples reinforce the idea that abstract concepts, when applied with purpose and precision, drive meaningful change and merit recognition as functional innovations as the invention's messaging fulfills one of its primary functional utilities of enhancing recycling frequency and promoting environmental responsibility.

### BRIEF DESCRIPTION OF THE DRAWINGS

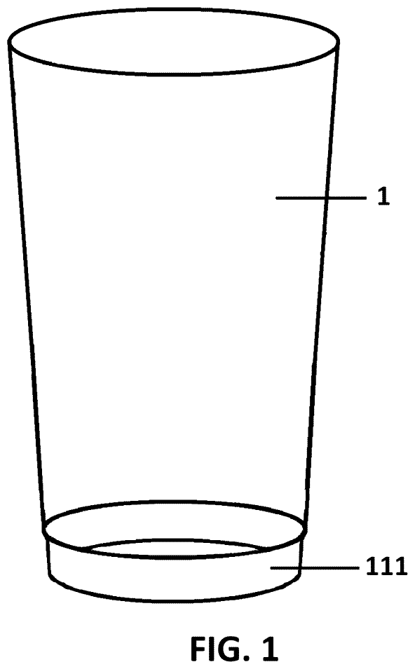

1) FIG. 1 illustrates a single-use plastic cup and the recess of its integrally formed subjacent structural rib.

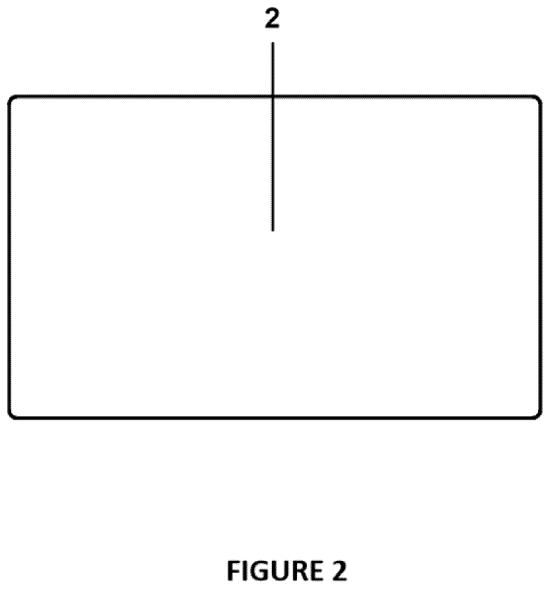

2) FIG. 2 illustrates a substantially horizontal planar surface of a beverage serving establishment.

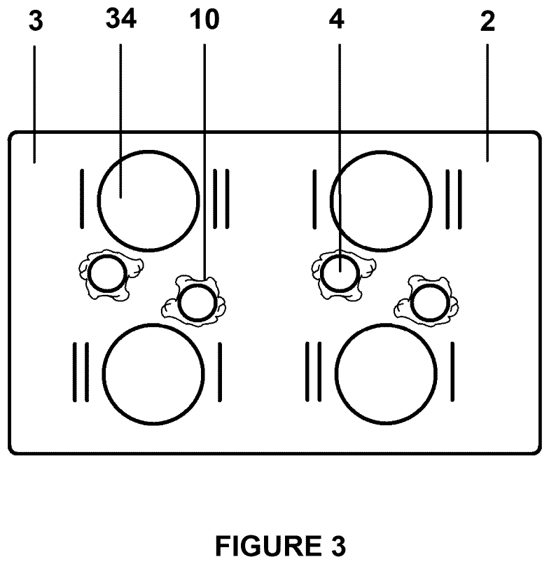

3) FIG. 3 illustrates a substantially horizontal planar surface of a beverage serving establishment. In the present instance the substantially planar surface is a table at a restaurant that is set with LCC's, cutlery and plates.

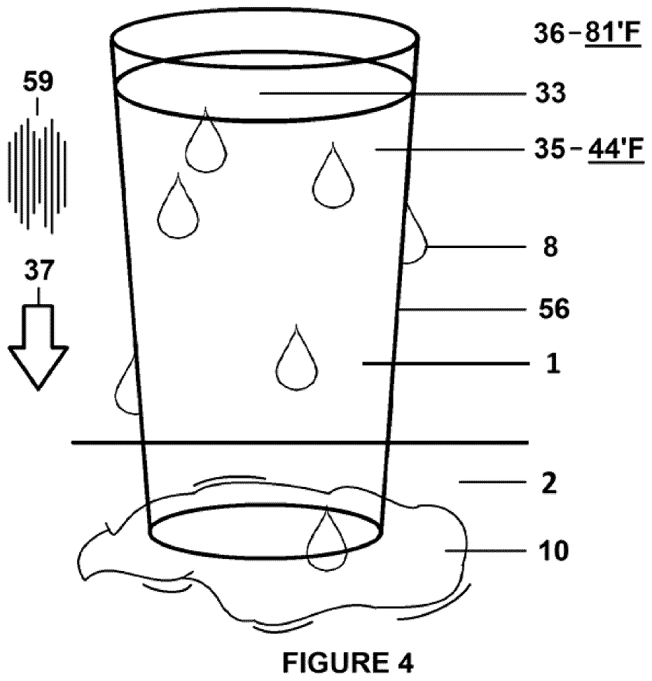

4) FIG. 4 illustrates a Liquid Carrying Container, (LCC) or cup. The LCC is presently filled with a volumetric of liquid, in the present instance, water.

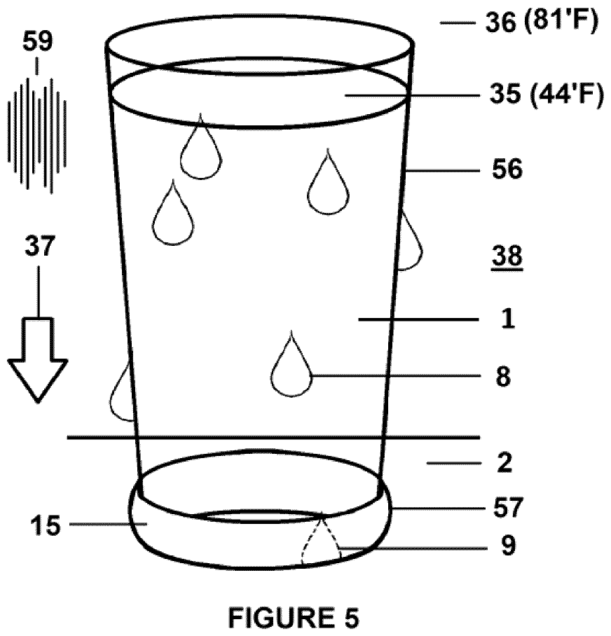

5) FIG. 5 illustrates an ensemble of a Liquid Carrying Container or cup, and a Recycle Narrating Coupling, (LCC/RNC) and the surface that the RNC is placed upon. The RNC has been form-fitted to accompany the LCC upon a substantially lower portion of the RNC.

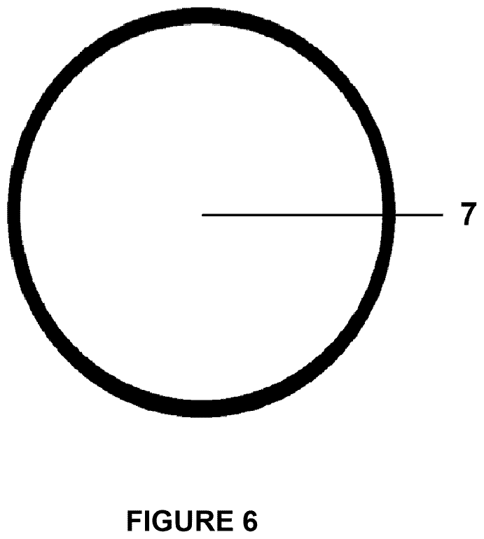

6) FIG. 6 illustrates a view of the substantially planar undercarriage of the RNC.

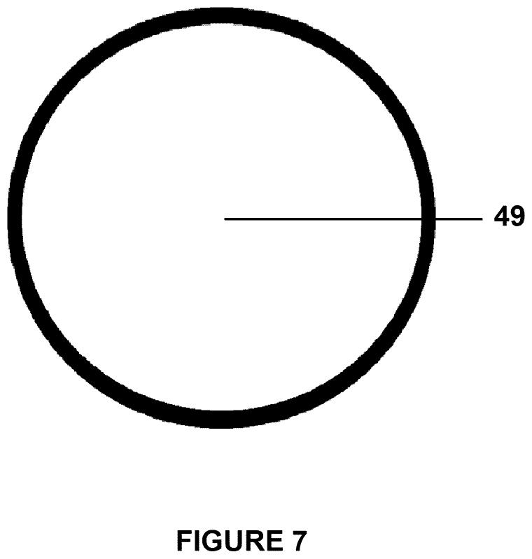

7) FIG. 7 illustrates an aerial view of the interior cabin of the RNC.

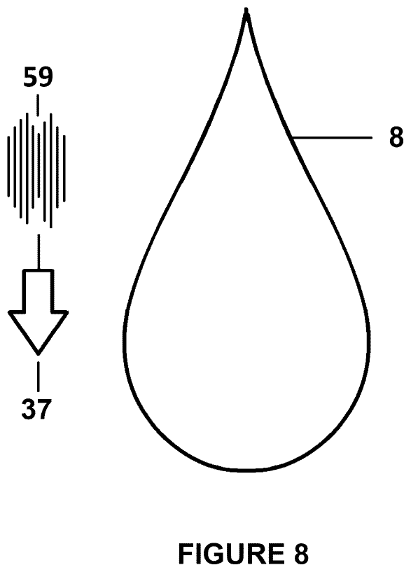

8) FIG. 8 illustrates a detail of a condensation droplet on the sidewall of an LCC being drawn downward by a gravitational field.

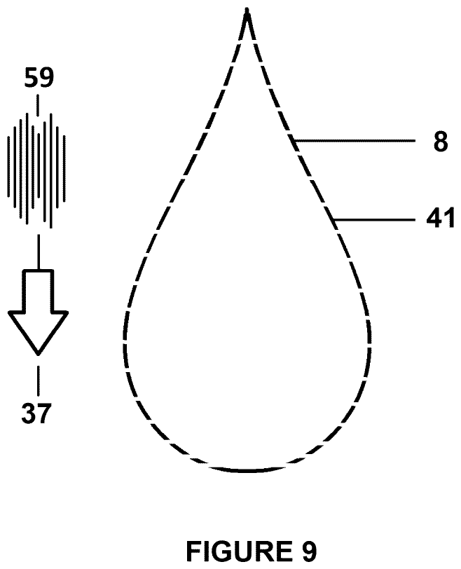

9) FIG. 9 illustrates a detail of a condensation droplet that has been drawn downward on the sidewall of the LCC by a gravitational field to the RNC and is being absorbed by the composite of the RNC.

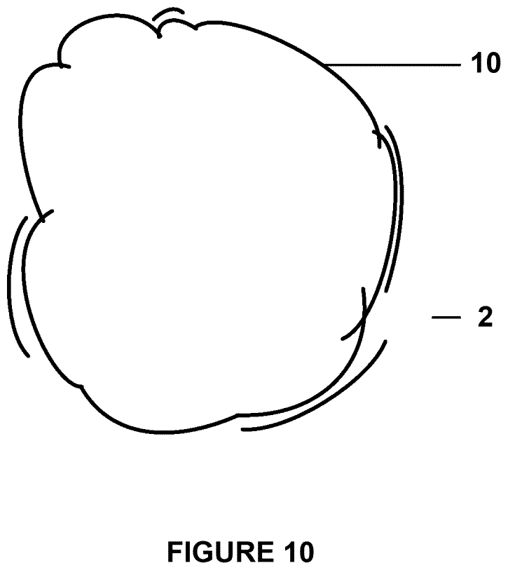

10) FIG. 10 illustrates a pool of water.

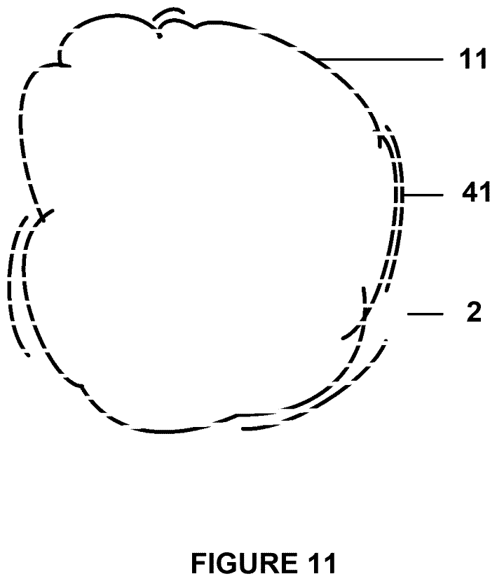

11) FIG. 11 illustrates a pool of water on a surface that is being absorbed by an RNC.

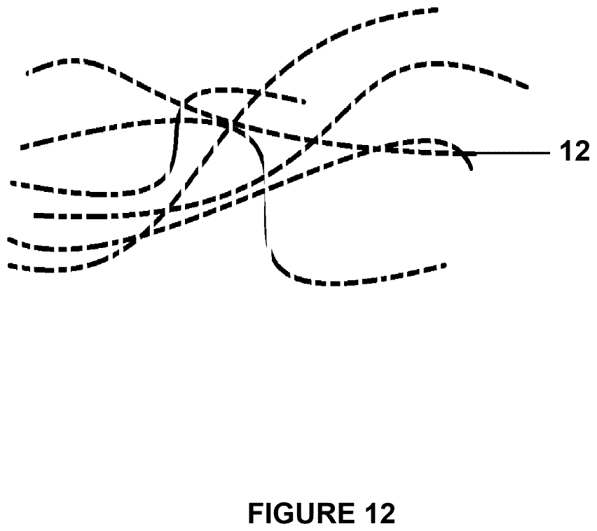

12) FIG. 12 illustrates hemp fibers particles in micro-hurd pulp.

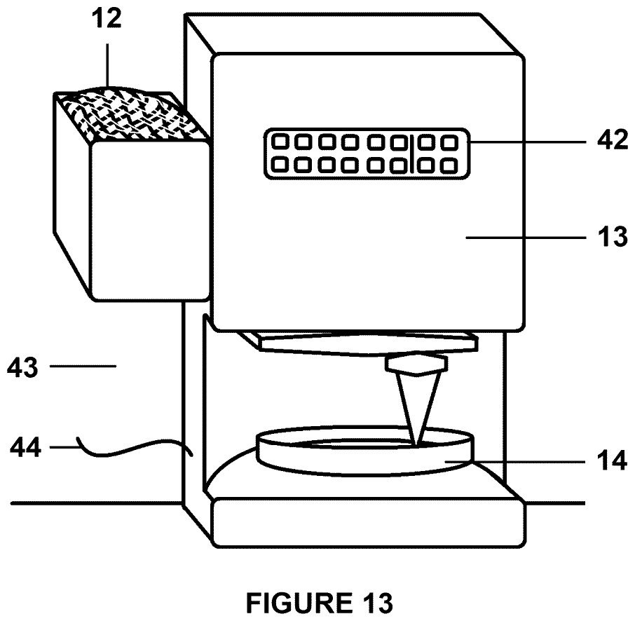

13) FIG. 13 illustrates an operative three-dimensional (3D) printer in the process of printing a RNC from aerated hemp fibers particles in micro-hurd pulp.

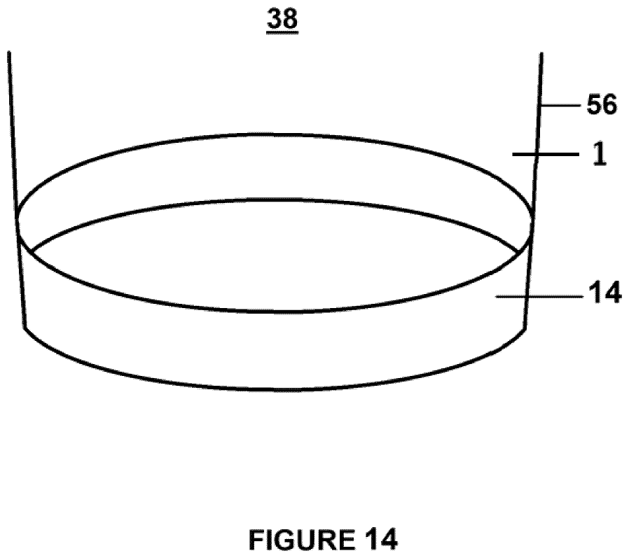

14) FIG. 14 illustrates a detailed view of an ensemble of an LCC/RNC with the LCC being securely form fitted into the interior cabin of the RNC. The LCC is empty and the RNC is unexpanded.

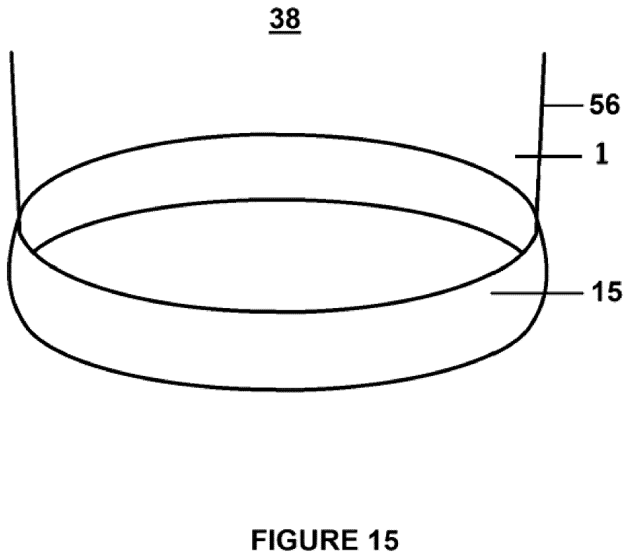

15) FIG. 15 illustrates a detailed view of an ensemble of an LCC/RNC with the LCC being securely form-fitted into the interior cabin of the RNC. The LCC presently contains chilled water of 44° F. in is in a warm atmosphere of 88° F. Condensation droplets formed and were drawn downward on the sidewall of the LCC by a gravitational field and have been absorbed by the composite of the RNC that is expanded in light of the water being stowed in the reservoir region substantially vertical outer shell of the RNC.

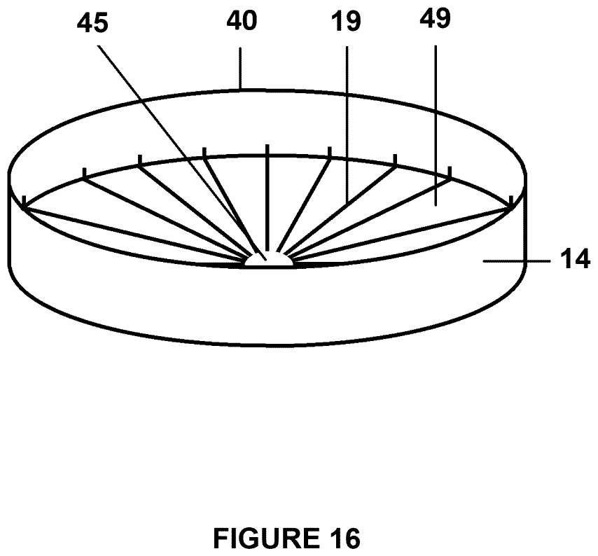

16) FIG. 16 illustrates a cross-sectional view of an unexpanded RNC with its interior cabin and capillaries.

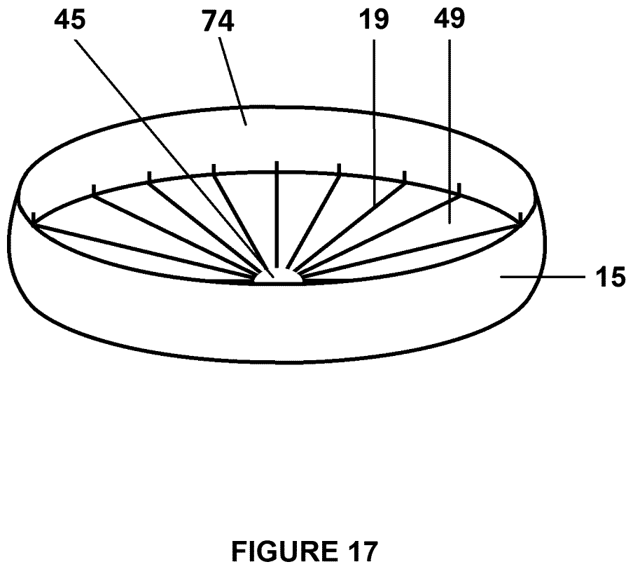

17) FIG. 17 illustrates a cross-sectional view of an expanded RNC with its interior cabin and capillaries.

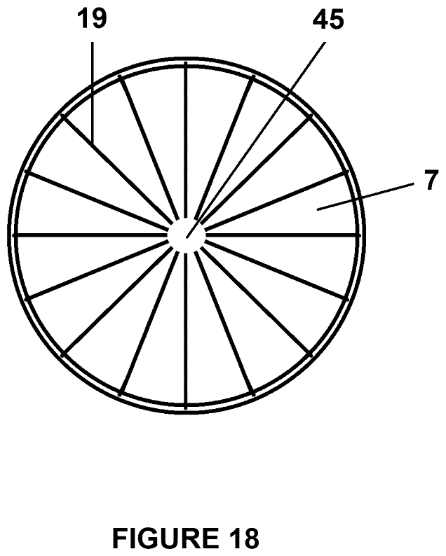

18) FIG. 18 illustrates an aerial view of the interior cabin of the RNC with its center section, and the capillaries that are embedded in the substantially planar undercarriage of the RNC and within the ply of the RNC composite.

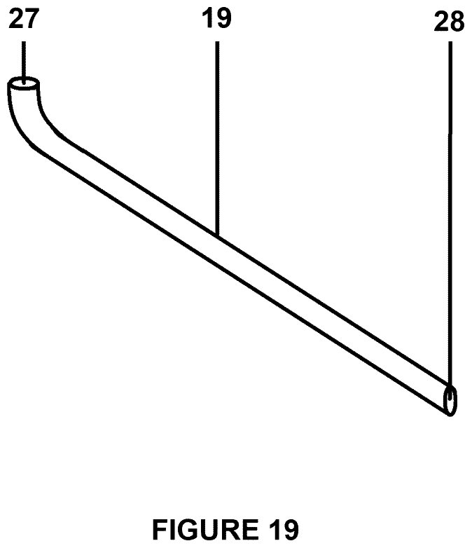

19) FIG. 19 illustrates a liquid conveying capillary.

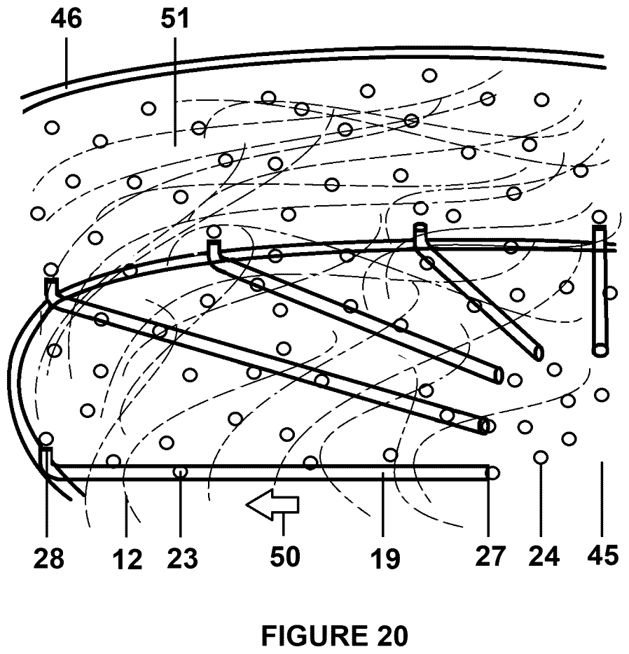

20) FIG. 20 illustrates a cross-sectional view of the RNC's substantially planar undercarriage, its substantially vertical outer shell, liquid conveying capillaries, water, and the hemp that comprises the composite of the RNC.

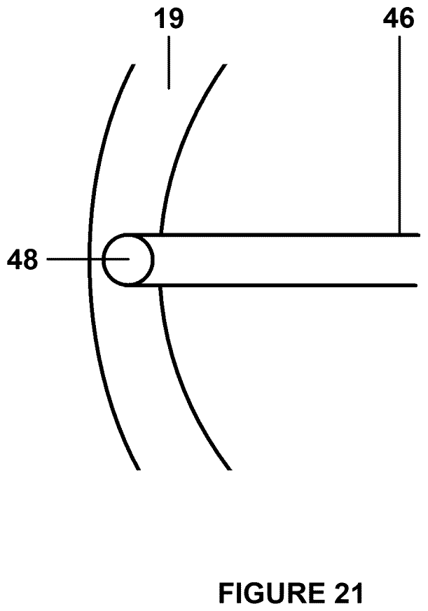

21) FIG. 21 illustrates aerial view of the outlet orifice of the liquid conveying capillary and its arrangement in the RNC's substantially vertical outer shell.

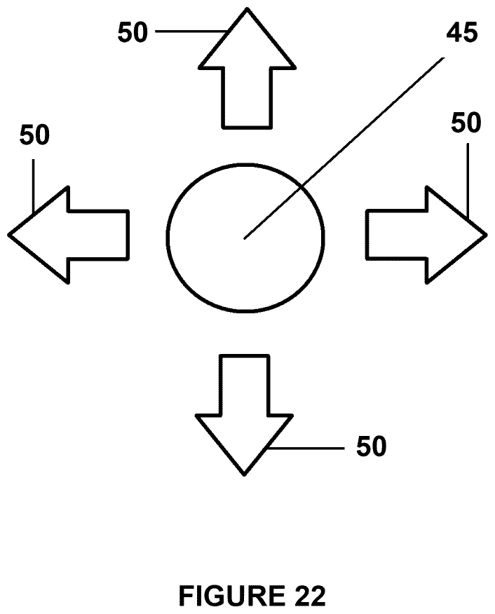

22) FIG. 22 illustrates directions of fluid flow in relation to the center section of the RNC.

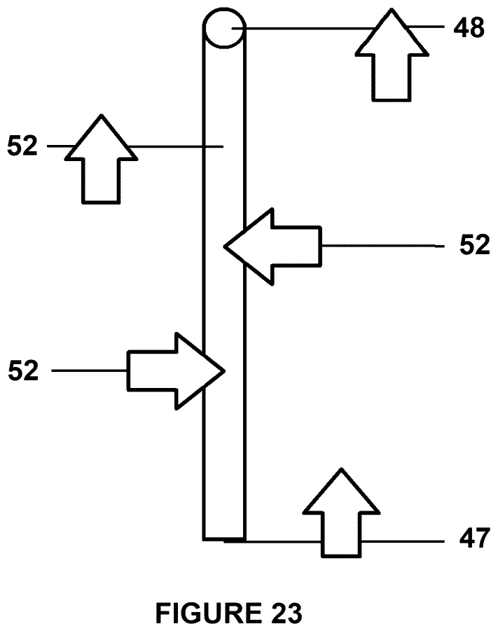

23) FIG. 23 illustrates directions of fluid flow going into, through and out of a capillary.

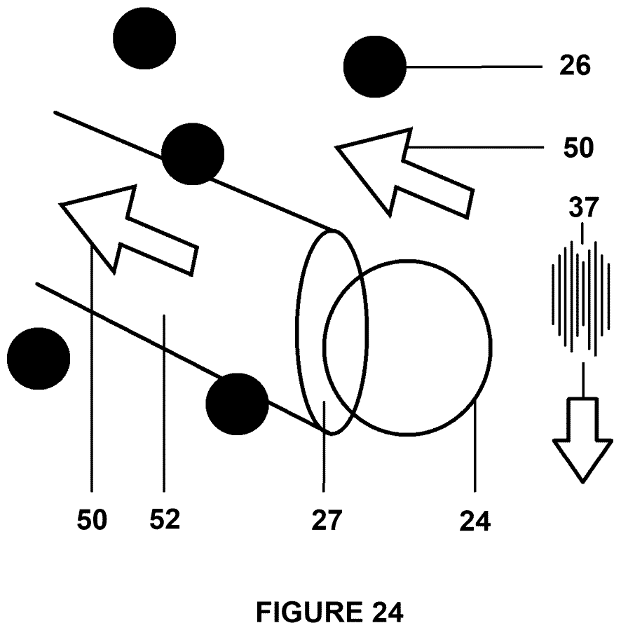

24) FIG. 24 illustrates an inlet of a liquid conveying capillary where it is truncated at the border of the center section of the RNC and with cross sectional views of the hemp that comprises the composite of the RNC.

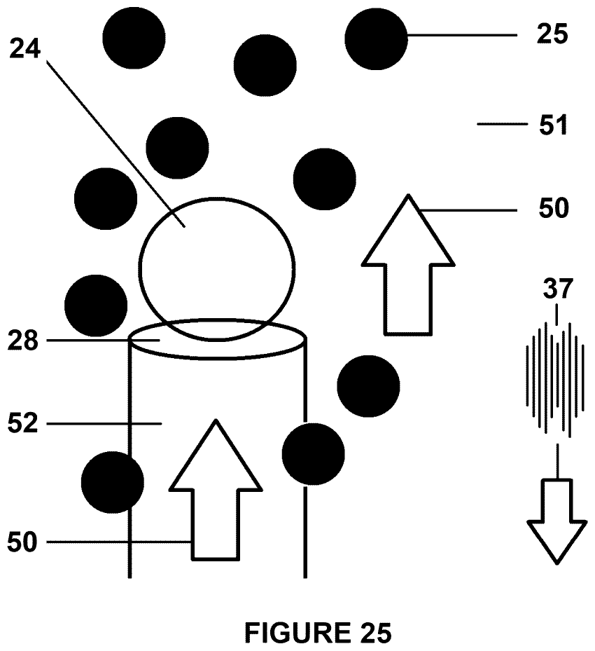

25) FIG. 25 illustrates an outlet of a liquid conveying capillary where it is truncated within the substantially vertical outer shell of the RNC's reservoir region and with cross sectional views of the hemp that comprises the composite of the RNC.

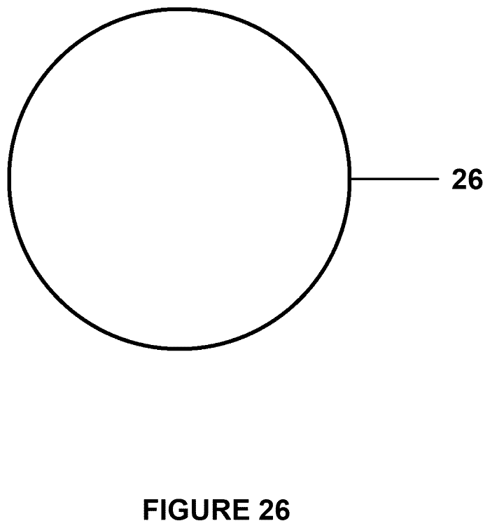

26) FIG. 26 illustrates a water molecule or volumetric of water molecules.

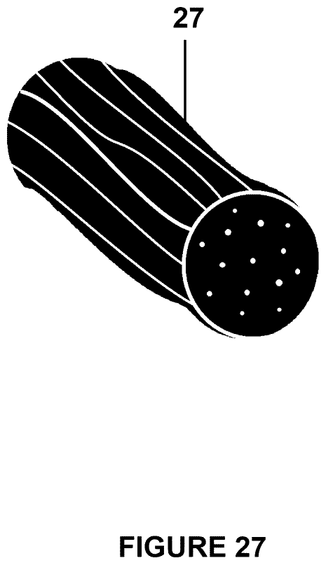

27) FIG. 27 illustrates a cross-sectional view of micro-hurd hemp.

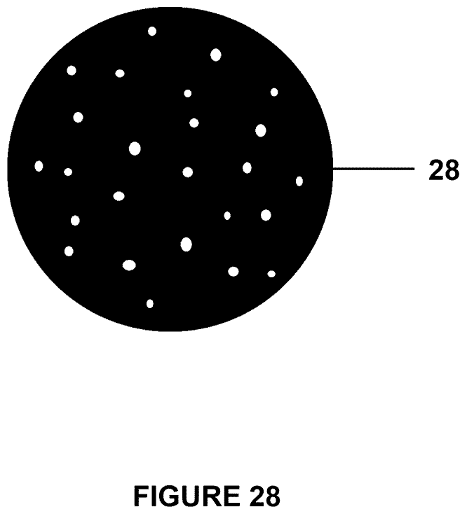

28) FIG. 28 illustrates a detailed view of one end of a cross-sectional view of micro-hurd hemp.

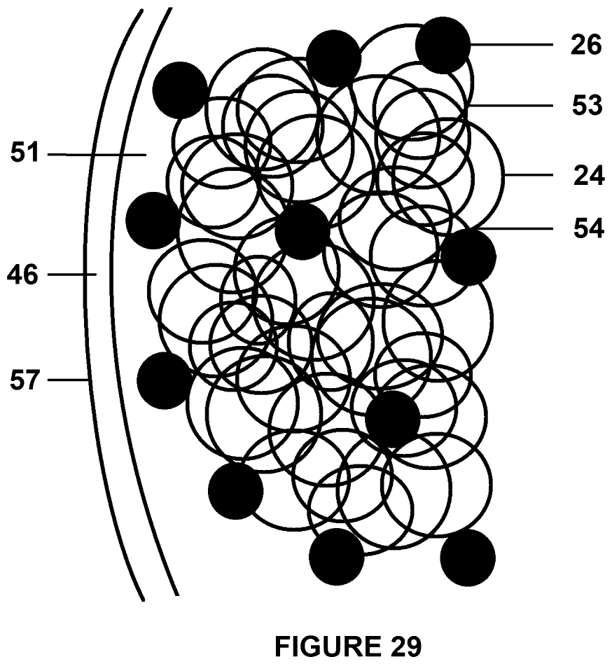

29) FIG. 29 illustrates a cross-sectional view of the expanded substantially vertical outer shell of the RNC's reservoir region.

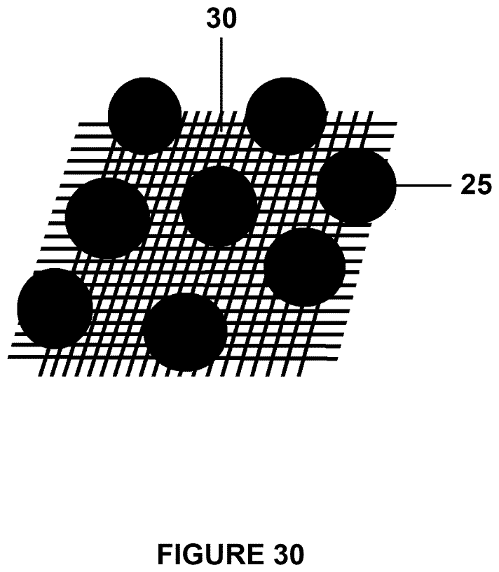

30) FIG. 30 illustrates a water permeable aerated pliable binding agent binding a cross-section of micro-hurd hemp together.

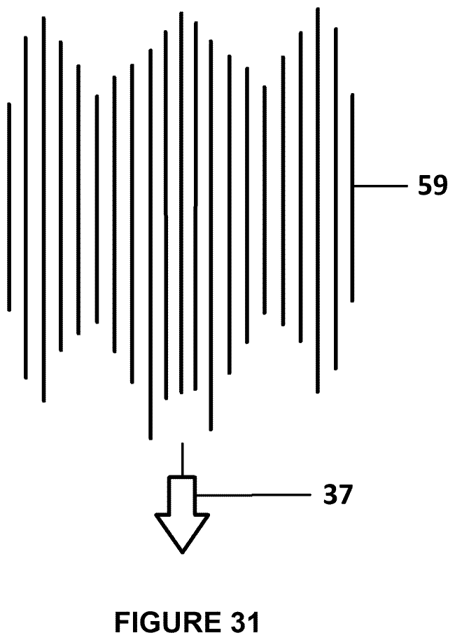

31) FIG. 31 illustrates a gravitational field acting downward.

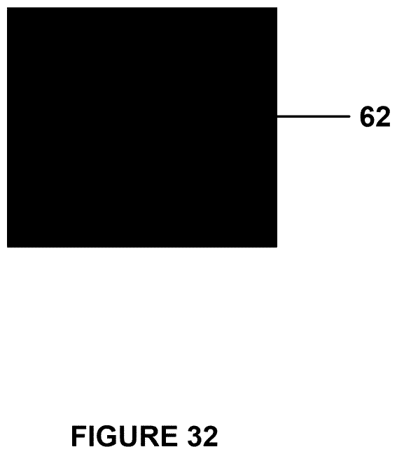

32) FIG. 32 illustrates an invisible ink earthy green colorized swatch.

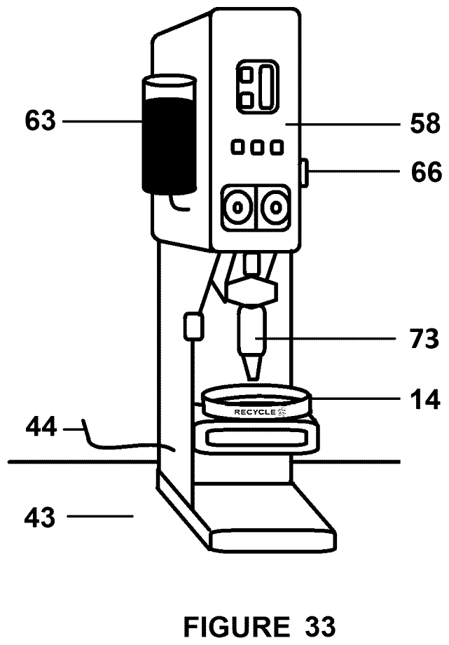

33) FIG. 33 illustrates a computerized tampography printer that is connected to a network and imprinting an ink ecological educational narrative recycle message upon the outer shell of an RNC.

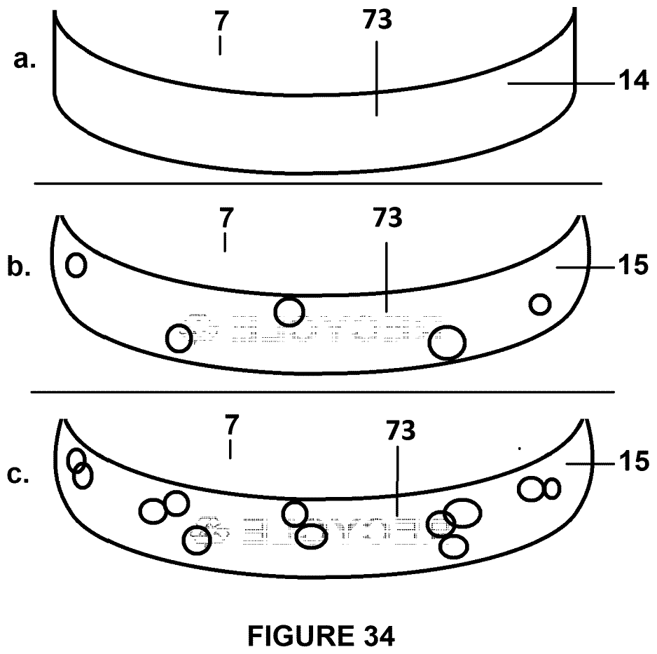

34) FIG. 34 illustrates a cross-sectional point of view of the RNC's reservoir region from the undercarriage of the RNC. The RNC's reservoir region is expanding in light of water stowing within it.

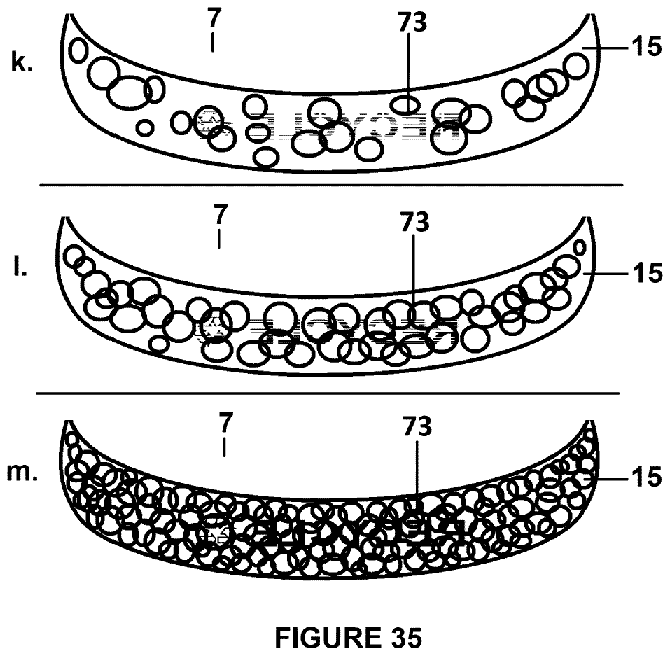

35) FIG. 35 illustrates a cross-sectional point of view of the RNC's reservoir region from the undercarriage of the RNC. The RNC's reservoir region is expanding in light of water stowing within it.

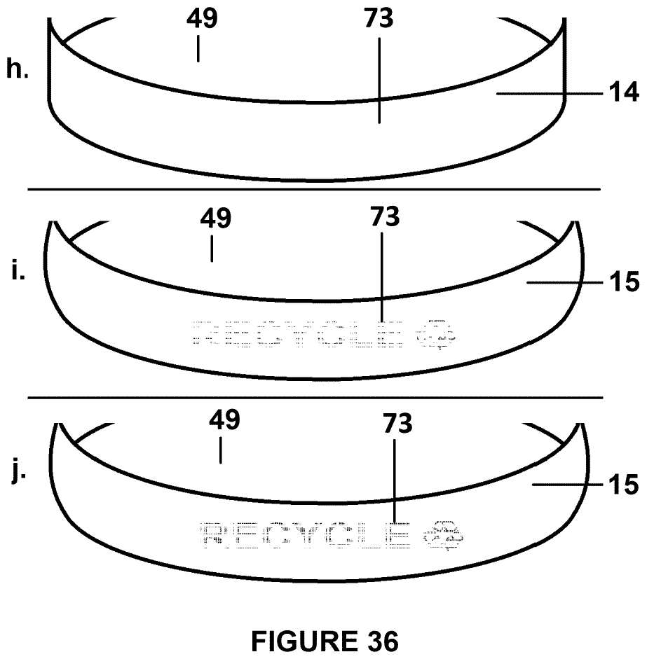

36) FIG. 36 illustrates the outer shell of the RNC that is expanding as water stows within the RNC's reservoir region. The RNC's reservoir region is expanding in light of water stowing within it.

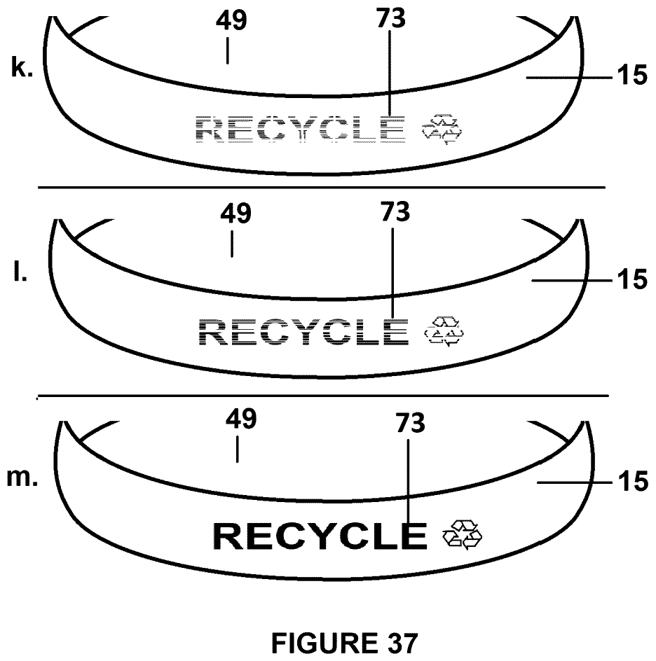

37) FIG. 37 illustrates the outer shell of the RNC that is expanding as water is stowing within the RNC's reservoir region. The RNC's reservoir region is expanding in light of water stowing within it.

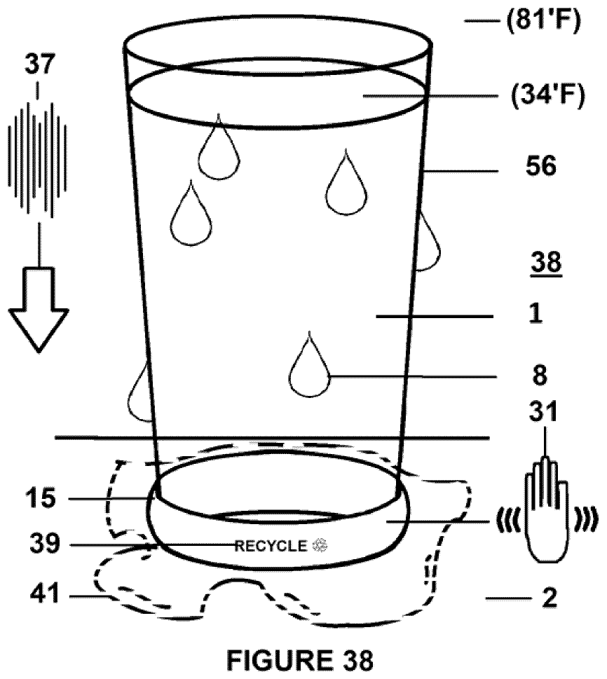

38) FIG. 38 illustrates an ensemble, LCC/RNC that is being manually governed to dry a pre-wet surface as indicated by the intermittent line.

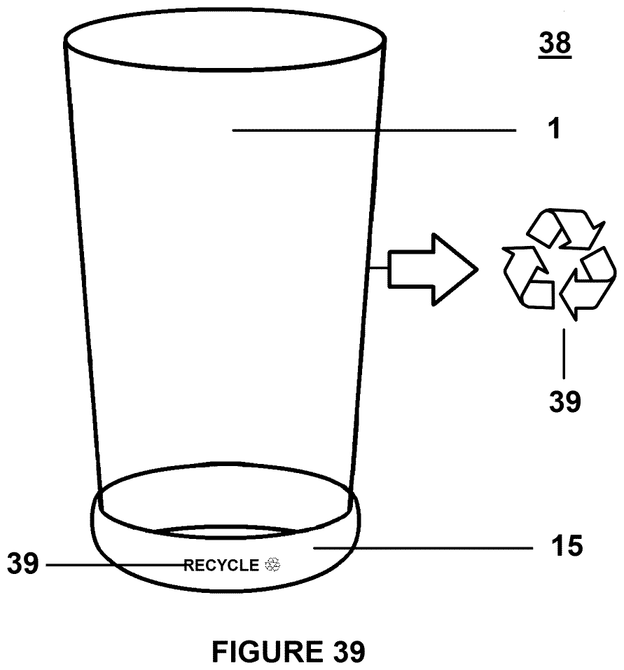

39) FIG. 39 illustrates an empty ensemble, LCC/RNC that has been utilized and is being recycled.

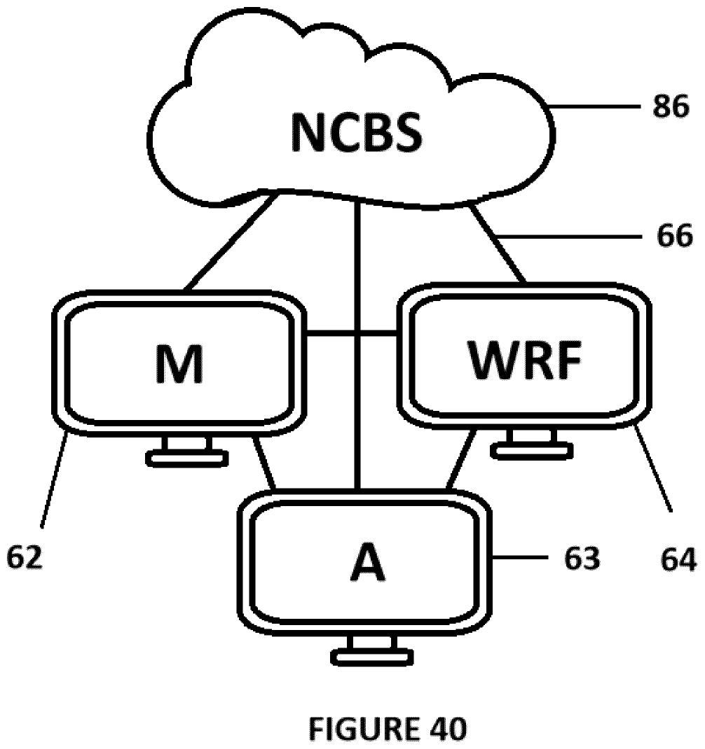

40) FIG. 40 illustrates the Networked Cloud Based Server (NCBS) that is connected by the network of the World Wide Web. The NCBS and the computerized devices of the manufacturer, artisan and Waste and Recycling Facility are all interconnected through the network.

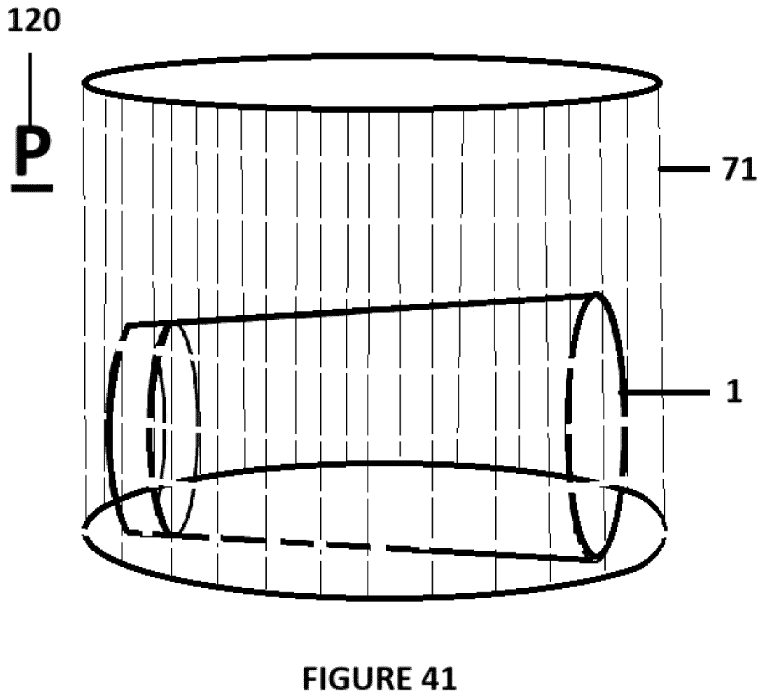

41) FIG. 41 illustrates a POSITA determining the characteristics of a SPC.

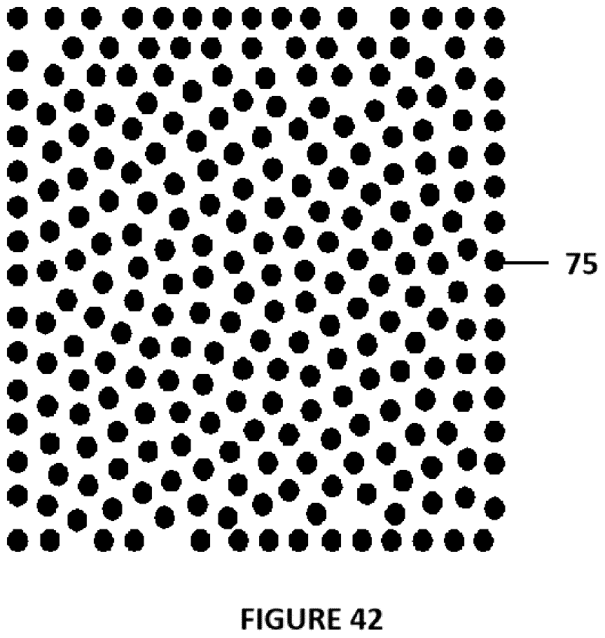

42) FIG. 42 illustrates a unique identifying motif that contains the characteristics of the SPC that were characterized by the POSITA.

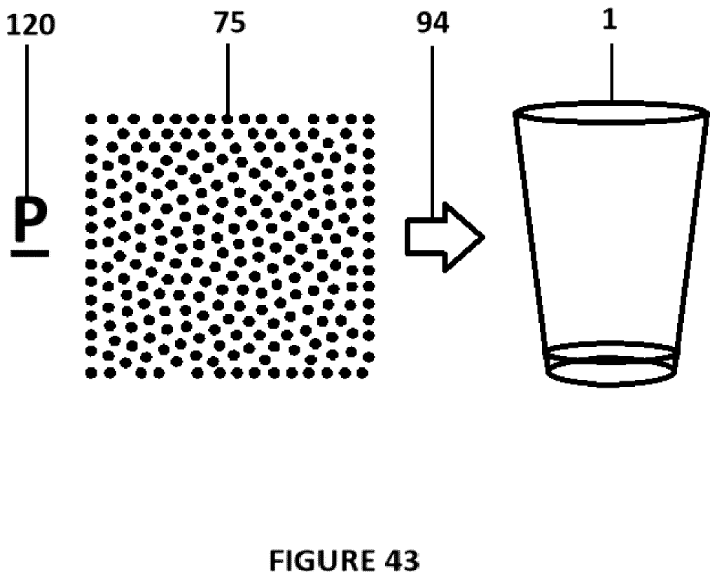

43) FIG. 43 illustrates the POSITA assigning the unique identifying motif that contains the characteristics of the SPC to the SPC.

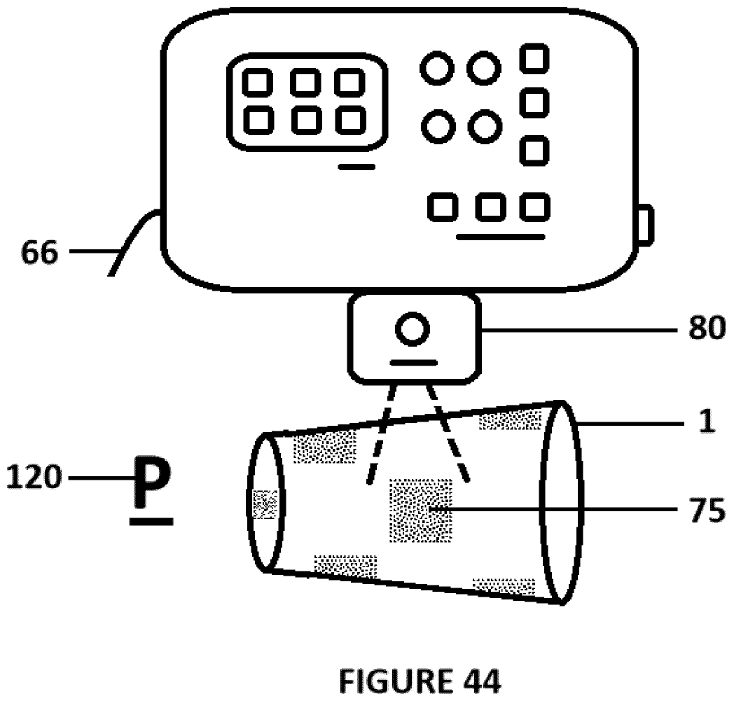

44) FIG. 44 illustrates the POSITA uploading the motif that contains the unique characteristics of the SPC into the network and imprinting the motif on the SPC.

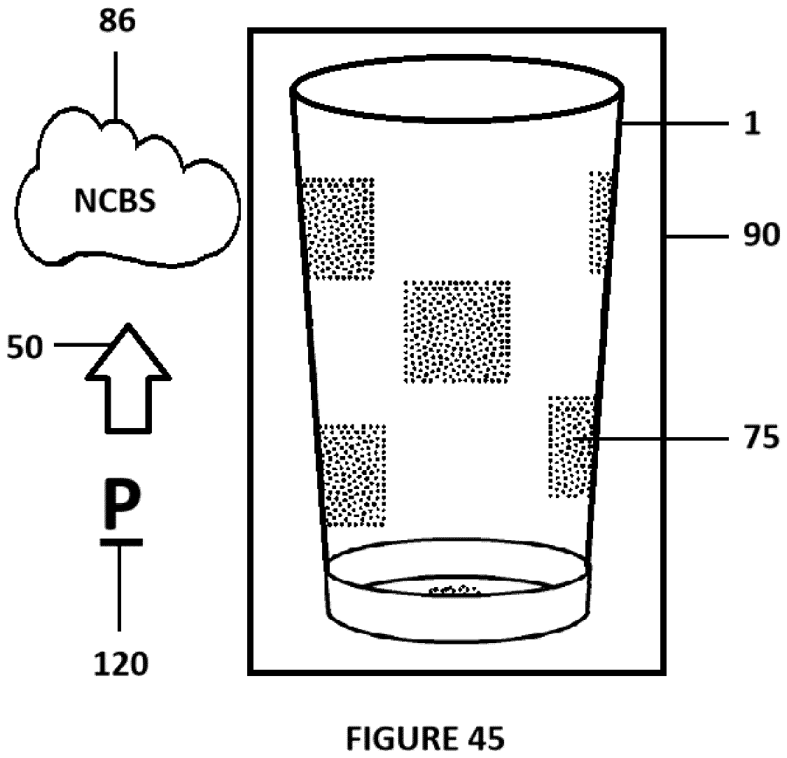

45) FIG. 45 illustrates a digital image of a prior to utilization SPC with the imprint of its unique identifying motif that has been uploaded into the NCBS by the POSITA.

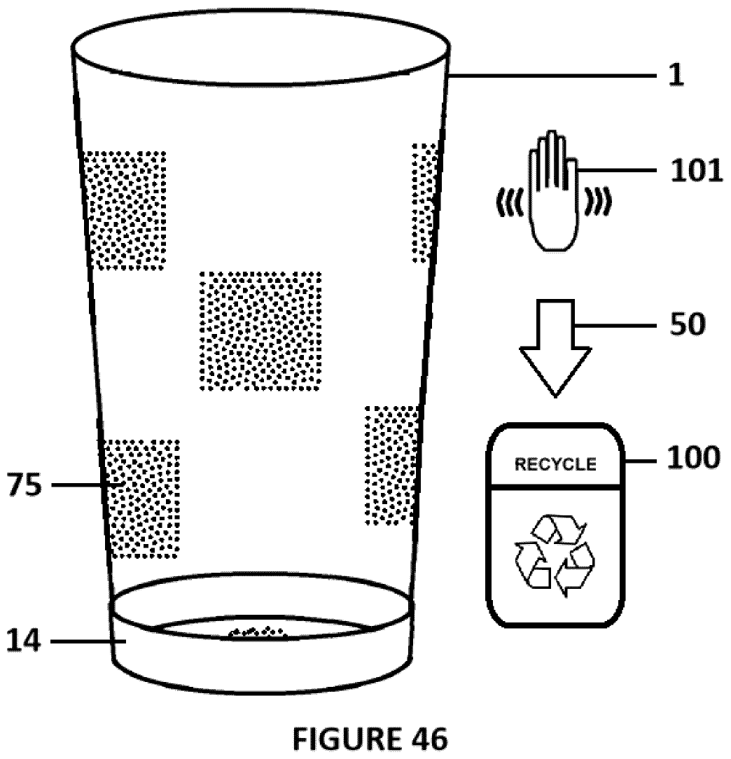

46) FIG. 46 illustrates an SPC imprinted with its unique identifying motif and attached CCCC being reclaimed into the infrastructure of recycling by the customer.

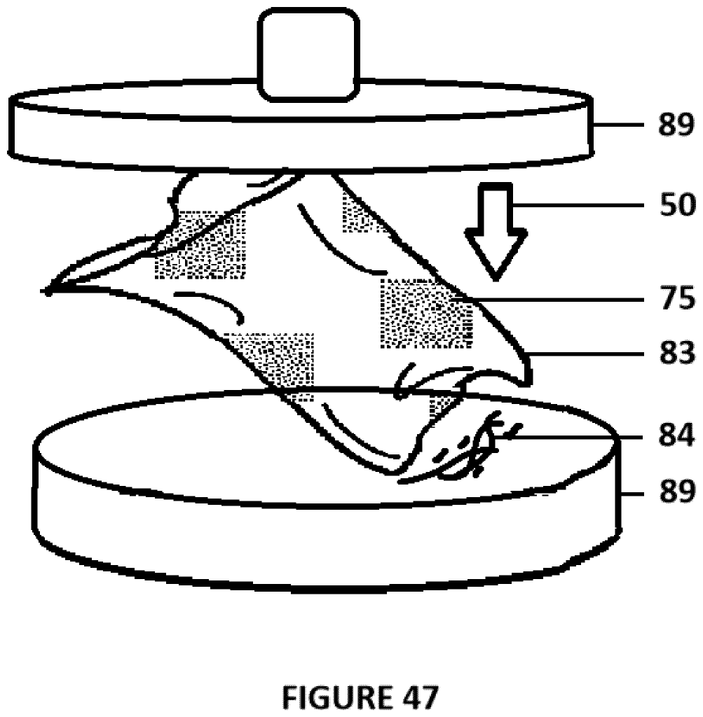

47) FIG. 47 illustrates an SPC that is imprinted with its unique identifying motif being hydraulically crushed, flattened, and deformed and it CCCC being shattered and falling off of the SPC.

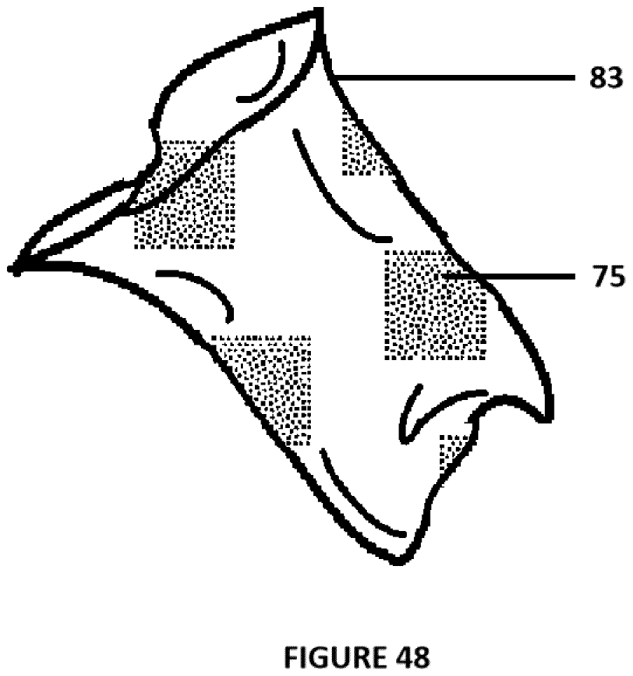

48) FIG. 48 illustrates a hydraulically crushed and flattened SPC and its unique identifying motifs that appear on several areas of the SPC.

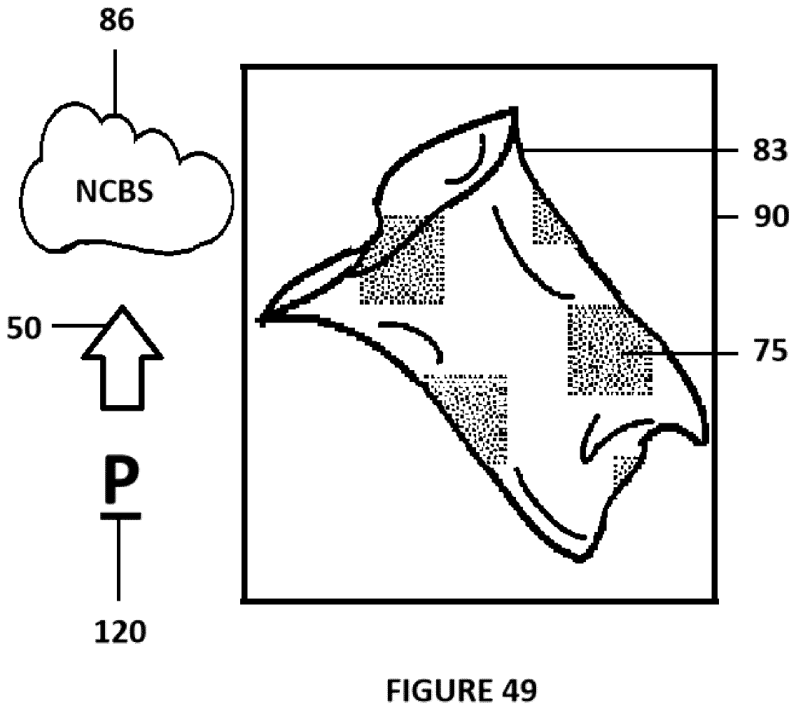

49) FIG. 49 illustrates a digital image of a hydraulically crushed and flattened SPC and its unique identifying motifs that appear on several areas of the SPC that has been uploaded into NCBS by the POSITA.

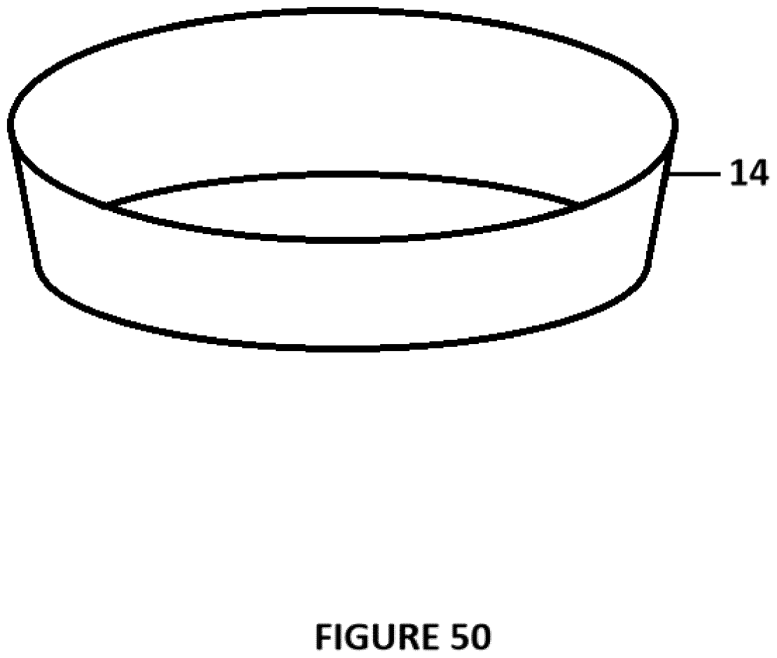

50) FIG. 50 illustrates a prior to utilization unattached CCCC.

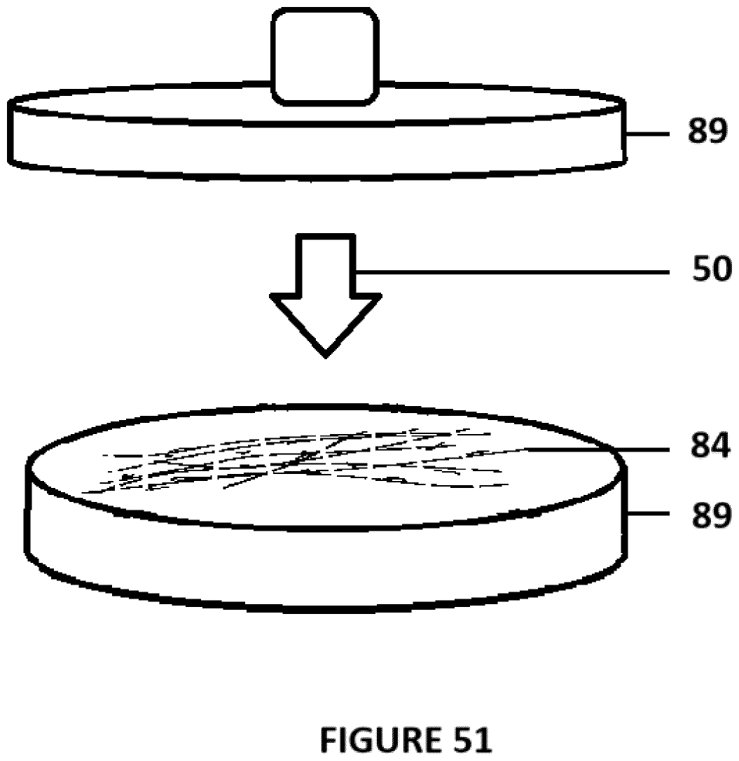

51) FIG. 51 illustrates the composites of the CCCC being hydraulically crushed.

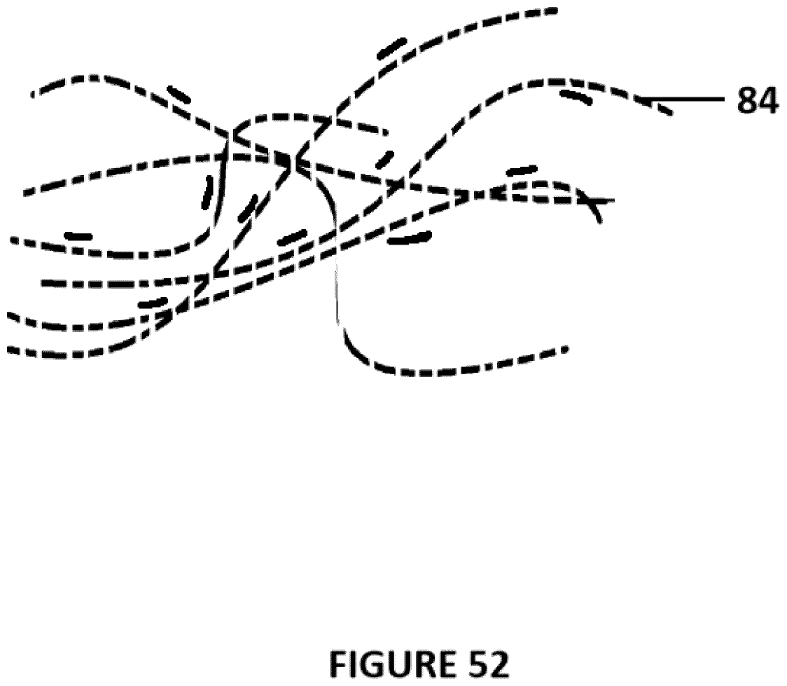

52) FIG. 52 illustrates the composites of the hydraulically crushed CCCC.

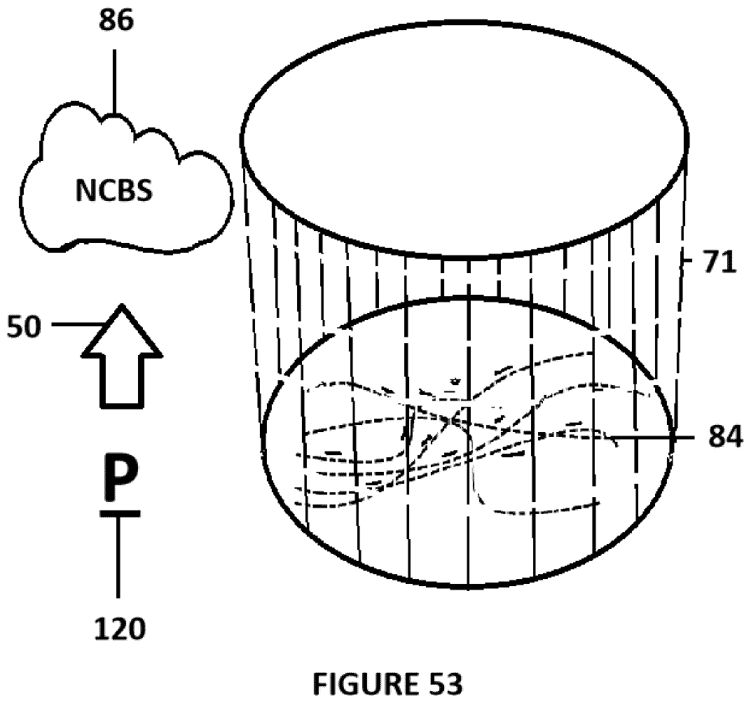

53) FIG. 53 illustrates a POSITA determining the characteristics of the composite of the CCCC.

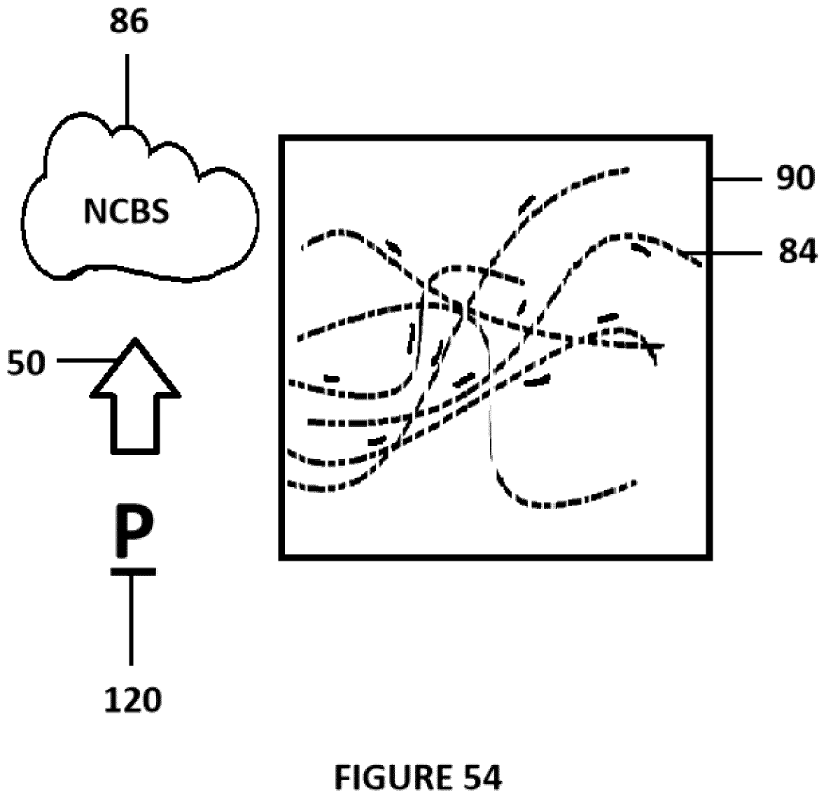

54) FIG. 54 illustrates a digital image of the composites of the hydraulically crushed CCCC that has been uploaded into the NCBS.

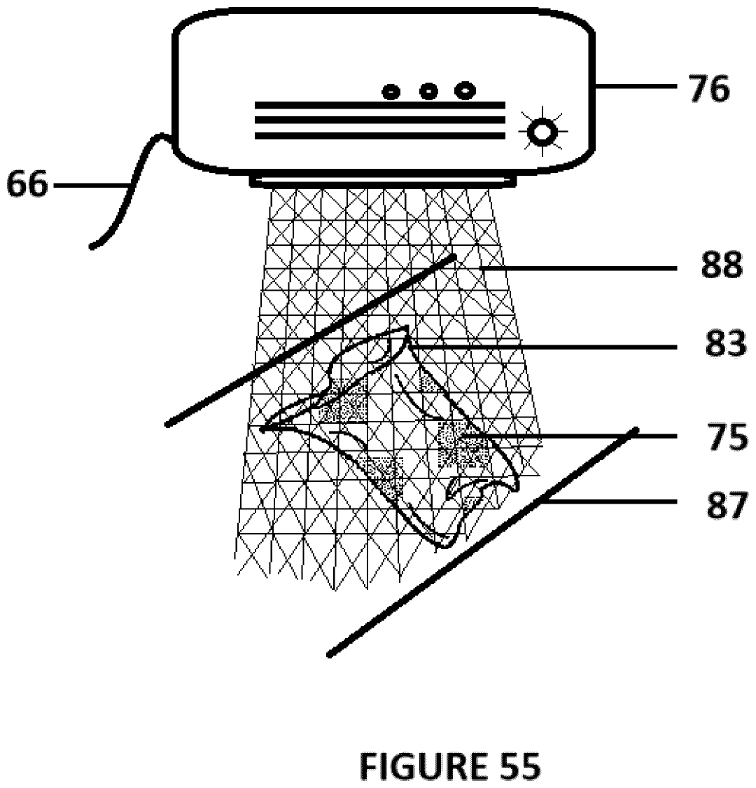

55) FIG. 55 illustrates a digital imaging scanner that has been programmed to scan and recognize the signature of the unique identifying motifs on hydraulically crushed SPC while they are moving upon conveyor belts of waste and recycling facilities for the purpose of programmatically scanning the unique identifying the SPC on the waste and recycling facility's conveyor belt so it can be auto-sorted downstream into its respective recycling bin.

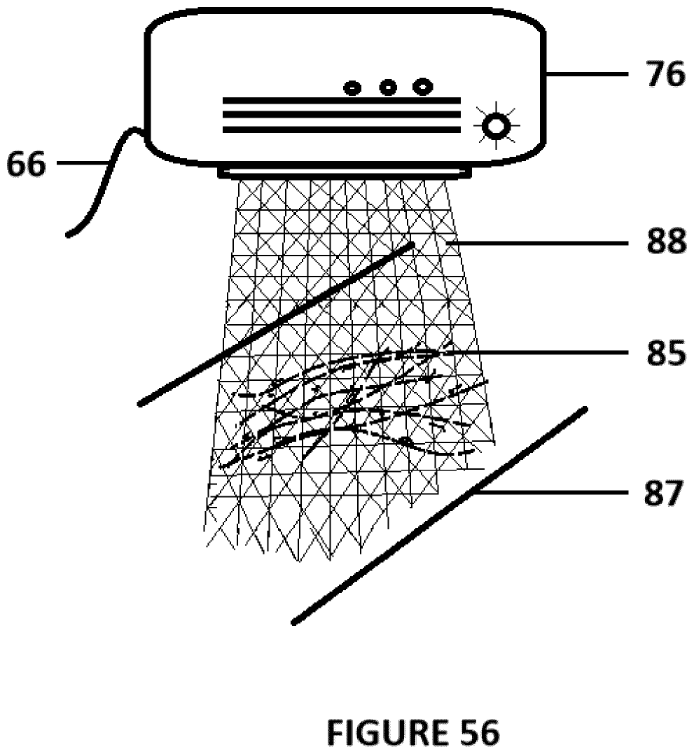

56) FIG. 56 illustrates a digital imaging scanner that has been programmed to scan and recognize the signature of the crushed CCCC fragments of hydraulically crushed CCCCs while they are moving upon conveyor belts of waste and recycling facilities for the purpose of scanning the fragments of the CCCC while they are moving on the waste and recycling facility's conveyor belt so they can be auto-sorted downstream into their respective recycling bin.

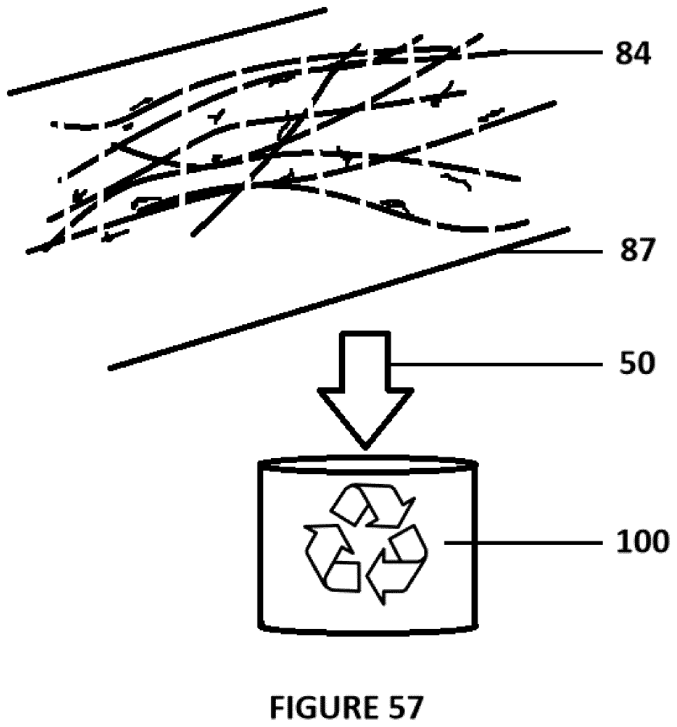

57) FIG. 57 illustrates the crushed and fragmented composites of a CCCC that have been identified for sorting and are on the moving conveyor belt of the waste and recycling facility and being sorted into their respective recycling bin.

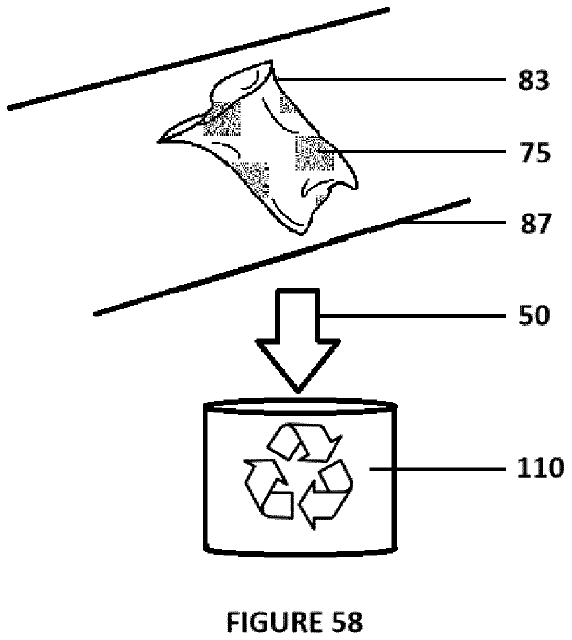

58) FIG. 58 illustrates a hydraulically crushed SPC with the imprints of its unique identifying motifs that has been identified for sorting and is on the moving conveyor belt of the waste and recycling facility and being sorted into its respective recycling bin.

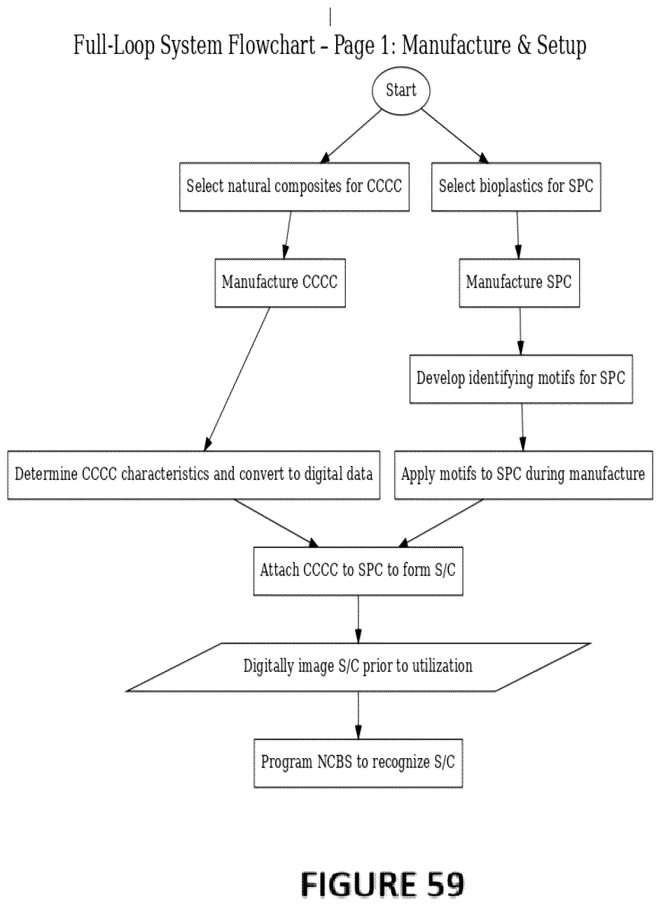

59) FIG. 59 illustrates Flow Chart 1 illustrates the manufacturing phase of the full-loop system. This includes the selection of biodegradable composites for the condensation collecting coupling (CCCC), the selection of bioplastics for the single-use plastic cup (SPC), and their respective manufacturing processes, along with the development of identifying motifs and conversion of CCCC characteristics into digital data.

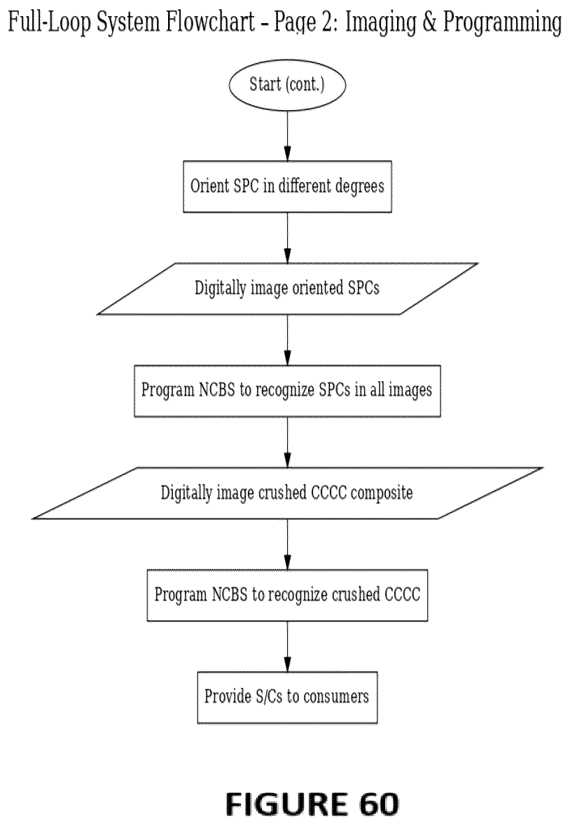

60) FIG. 60 illustrates Flow Chart 2 illustrates the pre-utilization and utilization phase of the full-loop system. This includes the integration of the CCCC and SPC into an assembled system (S/C), digital imaging of the system prior to use, and the programming of the networked cloud-based server (NCBS) to recognize identifying motifs and attributes of the S/C for subsequent reclamation.

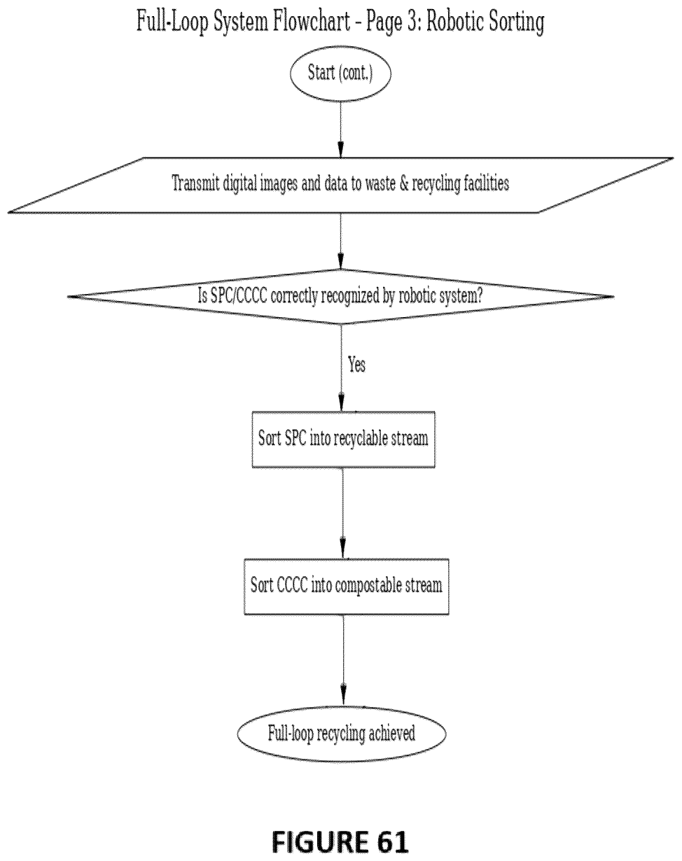

61) FIG. 61 illustrates Flow Chart 3 illustrates the post-utilization data integration and reclamation phase of the full-loop system. This includes digital imaging of hydraulically crushed SPCs and CCCCs, programming the NCBS to recognize these images in multiple orientations, and transmitting all relevant data to networked robotic sorting machines at recycling facilities for automated identification, sorting, and reclamation of the S/Cs into appropriate recycling streams.

### PREFERRED RNC COMPOSITE OF HEMP FIBER AND HURD

Those skilled in the art in the field of endeavor of the present invention will recognize and appreciate the quality of single-use, biodegradable, eco-friendly composites such as hemp, for the utility of wiping a table of leftover pooled water from condensation that dripped from a cup while also limiting taxing of natural resources. Returning then to the theme of the variance in biomass, the inventor of the present inventor, within the present invention's preferred embodiment in relation to a composite that the RNC is comprised of, hemp, sees a reduction of biomass utilization. See following.

Hemp paper is more eco-friendly leading to less deforestation than paper formulated from trees. When farmed with regenerative, organic practices hemp replenishes the soil it is grown in and absorbs CO² from the atmosphere, accordingly, hemp is also a carbon negative crop. As the hemp plant is pest and disease resistant, farming hemp necessitates no chemical pesticides or fertilizers. For these matters, hemp fiber is more eco-friendly for the environment than conventional paper produced from trees. Also, hemp is more the twice as recyclable as paper. These factors lead to; less pollution, less water usage and pollution of water and air pollution. As well, hemp contains anti-bacterial properties, lending its utilization to better hygiene. See Hygiene.

Manufacture from hemp also produces fewer greenhouse gas emissions. Paper products that are breaking down in landfill produce methane gas. Though recycling of hemp mitigates the production of methane. For these matters, as well as the engaging factor of the absorbent properties of hemp fiber, the inventor of the present invention regards hemp as a micro-hurd and having an aerated water permeable and pliable binding agent as the composite of preference for the present invention's preferred embodiment.

### DETAILED DESCRIPTION OF THE INVENTION

A Recycle Narrating Coupling, (RNC) for; 1) absorbing condensation droplets emanating on the sidewall of a Liquid Carrying Container, (LCC), 2) absorbing liquid that is on a surface, and notably 3), animating an ecological educational recycling narrative.

In view then of the first claim of present invention as an RNC is it herein understood as a method of directing utilized drinking cups into the infrastructure of recycling whereby the narratives propagate upon the RNC at the critical juncture of utilization of an ensemble. And when the audience, commonly someone utilizing the LCC for containing a chilled beverage, and likewise consuming the beverage, who is herein also understood as a “Utilizer” of an ensemble, within the immediacy of utilization of using the ensemble, and at a critical juncture of electing to dispose or recycle the ensemble, by methods of the method of ecological education as illustrated herein, the utilizer integrates the abstract concepts of ecological education into a matter of practical application and the utilizer, based upon the novelty of the present invention, elects to recycle the ensemble more often than contemporary general practice of recycling plastic cups, so the abatement of plastic cups reaching landfills is achieved. In practicing this procedure, the person as mentioned abates LCCs from being dispatched to landfills, and accordingly, enhances the quality of the environment by contributing to the maintenance of the basic life-sustaining natural elements of water and soil.

In the first view of the present invention the RNC is comprised of at least one of each of the following; a composite, a capillary, a ply, a reservoir region, a shape involving an outer shell, an undercarriage, a center section, an upper rim, an interior cabin, an ink, and whereby, the RNC being comprised of a shape that is formed with at least a substantially horizontally planar undercarriage, a substantially vertical outer shell, an upper rim, a form-fitted interior cabin, and a center section. And the shape of the RNC is formed for maximizing the utilities of the present invention in such a way that the utilities are unified in the sense that each utility is interwoven with the others.

The RNC may be manufactured independently from the LCC, as a standalone RNC. The RNC may also be manufactured concurrently with the LCC as a form-fitted ensemble (LCC/RNC). The LCC being comprised of plastic and comprising a shape consisting of a sidewall, and whereby a dimension of the RNC's sidewall in relation to a dimension of a portion of the LCC's shape is formed to accompany the LCC at a substantially lower portion of the LCC, and whereby a substantially lower portion of the LCC fits securely into the RNC's interior cabin. Its composite involves a type of organic bioplastic that in their natural state are usually hydrophilic and can be made increasingly hydrophobic by adding additives or surface treatments during production. These additives can include hydrophobic substances or coatings such as though not limited to bioplastics with modified starch that reduce the hydrophilic properties of bioplastics. And beeswax can be added to make bioplastics that are more resistant to water vapor transmission. As well, cellulose esters can be made with C6-fluorinated carboxylic acid and cellulose. These cellulose esters are greaseproof, biodegradable, and hydrophobic and are protein-based films that can made with fibrous proteins like keratin, which are water-resistant. This composition provides in-use structural hydrophobic properties to the ensemble so the benefit of the present invention may be easily enjoyed.

In the first view of the present invention the RNC's composite possesses highly hydrophilic auto-molecular liquid absorbent methods and may be comprised of a composite such as though not limited to hemp. And, the RNC's composite has a ply with a dimension and is comprised of variant particle concentrations, that are engineered to suit the utilities of the present invention and as well engineered with a bio-degradable eco-friendly binding agent that supplements the structural integrity of the composites during utilization and holds fast the composite of the hemp of which it is comprised. As the RNC's composite is comprised of hemp, it is herein understood that hemp has highly hydrophilic auto-molecular liquid absorbent methods that can absorb condensation that has pooled on a surface through the formation of it substantially planar undercarriage, through its upper rim and through its substantially vertical outer shell when condensation is emanating upon the sidewall of the LCC and is being drawn downward by gravity to the upper rim and the substantially vertical outer shell of the RNC. In performing these first two functions, the composite of hemp achieves its utilities without the invention of any human effort. This quality is of essence to the present invention, in light of how it is specified herein, particularly for the benefit of the person utilizing the ensemble and the artisan, herein understood as a restaurateur. Such a quality is once again beneficial to both parties as no human effort, and in the case of the restaurateur, no human effort and likewise no expenditure, and in fact cost savings are realized through the provisions of these utilities. It should therefore be understood that both parties will enjoy the present invention's benefits.

As the RNC's composite is comprised with a liquid reservoir region that is embedded within the dimension of the substantially vertical outer shell of the RNC's ply, and the hemp that the RNC's composite is comprised of, has as part of its natural state, highly hydrophilic auto-molecular liquid absorbent methods and in view of its aforementioned structural engineering it can absorb, expand, and stow a volumetric of liquid within the RNC's reservoir region of the substantially vertical outer shell of the RNC's composite. The condensation that emanates upon the outer shell of the LCC is water and is considered as part of the present invention's disclosure, a ‘natural resource’ that is implemented for the purpose of the utilities of the present invention.

In relation to the ply of the RNC's substantially horizontally planar undercarriage, it contains hallow cored liquid conveying capillaries that are embedded within the ply's dimension and are truncated with orifices for liquid inlet and outlet. The hallow cores also have methods to absorb water through every part of their tubular shaped composite and convey it as illustrated herein to the capillaries' liquid outlet orifices. Within this structural design and its dynamic the liquid conveying capillaries that are embedded within the RNC's ply composite and are truncated at a border of the center section of the RNC with liquid inlet orifices and are arranged to horizontally radiate from the border of the center section of the RNC and extend radially through the RNC's undercarriage and into the RNC's outer shell and bend upwards into the substantially vertical outer shell of the RNC and into the liquid reservoir region of the RNC where the liquid conveying capillaries are truncated with orifices that comprise liquid outlets, provide methods to convey water to the precise location where it may be implemented for its utilities. Through a naturally occurring phenomenon, the RNC's liquid conveying capillaries that are comprised with hallow cores provide methods to convey fluid through the liquid conveying capillaries in parallel and against a gravitational field through methods that are induced by capillary action originating from the RNC's composite, and induced by a vacuuming effect that originates from the expansion of the RNC's outer shell as it absorbs and stows condensation and expands, and as a novel benefit of the present invention, requires no human effort to do so.

In relation to the RNC's composite and the overarching premise of the present invention, it is comprised of a biodegradable, eco-friendly, and recyclable composite that is imprinted with a water activated invisible ink imprint that has methods to interact with the water that is stowed within the precise location of the RNC's reservoir region and activate an invisible ink that is imprinted upon the outer shell of the composite's reservoir region of the RNC. The invisible ink methods of interaction with the water that is stowed within the RNC's reservoir region activates the invisible ink into animating the invisible ink into a visible recycle ecological educational narrative, such as ‘Recycle’ and a recycle emblem that is imprinted upon the reservoir region of the substantially vertical outer shell of the composite of the RNC for the purpose of ecologically educating the person utilizing the ensemble so the person tentatively and more often, because of the attractive immediacy of the animation and its ecological educational narrative, recycles the ensemble, thereby achieving the overarching premise of recycling the hemp composite and plastic cup ensemble by contributing to the restoration or maintenance of the basic life-sustaining natural elements, notably, the air, water and soil.

### In View of Claim 2 of the Invention

The invention is claimed within its second claim as a process of enhancing the infrastructure of recycling ECPC, notably plasticenes and notably through recycling single utilization plastic cups (PCs) coupled with an Eco-friendly Coupling EC. The processes set forth within claim 2 of coupling a water activated ink imprinted eco-friendly composite on the ECPC, involves a water activated invisible, or alternatively an ink this is originally tinted to match the composite of the ECPC coloration and is thereby camouflaged prior to contact with condensation. Once contact with condensation occurs ink imprint undergo a colorized phase transition upon the ECPC that animates an ecological educational recycling narrative upon the ECPC during real-time in-use utilization with an ecological educational recycling narrative, such as though not limited to the term, ‘Recycle’ and a recycle emblem. As the term is not limited to ‘Recycle’ and a recycle emblem it may be termed in creatively employed ecological slogans of a variety of text formats and graphical designs that may be fashioned to address ecological education through novel methods of presenting the ecological educational narratives. The aim of the novelty of creativity that may be employed through methods set forth in the present invention is to refresh and renew the current practice of constantly imprinting the same term, recycle or recycle emblem upon a cup. It should also be recognized that some imprinting is not colorized or even imprinted. Commonly, a recycle term or emblem is embossed upon the sidewall of a cup and sometimes embossed as translucent because the material it is being embossed upon, plastic, is as well translucent. These stale, outdated and timeworn factors diminish contrast and likewise visibility and suggest that there is little value in recycling the cup because no effort was made to make the narrative more artful. The present invention composes the narratives as more artful and is directed towards arousing caring about recycling by providing creatively colorized and ever-changing engaging narratives. See following.

These creatively colorized and ever-changing engaging narratives may include such slogans as, ‘Go Green, Recycle’, ‘Earth and You is Love’, ‘Nature needs something in return’, ‘Recycle me, I'll see you later’, ‘Reduce, Reuse, Repurpose, Recycle’, ‘Today, recycle for a better tomorrow’, ‘Eat, Sleep, Recycle’, ‘Don't be a punk! Recycle your junk!,’ ‘Hey puppy, recycle this cuppy,’ ‘It's a small planet, Recycle,’ ‘Recycle—for the Kids,’ ‘Recycling Rocks,’ and ‘Recycling plastic feels fantastic!.’ When print productions slogans are varied during the imprinting process and scrambled during packaging a variety of slogans will be available when the cups are in use and games can be played. One person may have one slogan, and another have another slogan, and they may ask one another, “What does yours say?” “Mine says . . . ” and the other person may say, “Mine says . . . .”

Imprinting graphical representations of relevant context such as though not limited to items such as trees, animals, the air, water and soil, hands pitching in to recycle, people participating, the earth, the earth in someone's hands, children, adults, the elderly, persons of all backgrounds, and imagery of distinct parts of the world are creative processes that the present invention's embodiments supply. Moreso, as graphic artists and those with marketing backgrounds begin to take part in the fresh new format for presenting recycling narratives that the present invention provides, there will be a sense of boundless merit that comes to the objective of the present invention, that is, to increase ‘ecological educational engagement’ and likewise materially enhance recycling. Engagement of people through these various refreshing slogans and graphics are key to the earth's ecology as the aforementioned activities highlight recycling interest of people utilizing the plastic cups so the persons will likely be more prone to recycle their cups and consequentially increase the percentage of plastic cups that are being recycled.

In light of the tampography printer being connected to a network such as though not limited to the World Wide Web (WWW), it should be understood that the method of programming the tampography to imprint various slogans and graphical images upon the substantially outer shell of the composite of the ECPC may be performed locally or remotely. Through either programming method the slogans and imagery may be changed in rapid succession to reflect socially relevant catch phrases that may be trending, reflect dialectical colloquialisms, display different languages, and be programmed to address people of various ideologies in a manner that reflects their interest towards recycling.

As the tampography printer is computerized and connected to a network such as the WWW, the present invention may exploit technological advancements such as though not limited to artificial intelligence (AI), Quantum computing, and next generation technologies. Such technologies as AI gather information and produce output in near real time speed and such information can be forwarded to the computer of the tampography, or the type of printer that the printing artisan is utilizing to imprint the slogans and graphics upon, and the imprints can reflect AI determinations as to what content to imprint upon the RNC's composite. Through the same methods, when Federal mandates from departments such as the ‘Food and Drug Administration’ (FDA) needs to be disseminated to the public, AI has the agility to recognize such initiatives and remotely program computerized printers to imprint the information in relation to Federal, State, County, City or Zip codes, so local individuals will be duly advised of such information. Such procedure leads to the rapid deployment and shipping of plastic cups to various regions and establishments and equally engages consumers with fresh new appeals and the percentages of recycling of plastic cups, predicated upon the narratives, inspires people to integrate the concepts into practical applications so recycling percentages will tend to strengthen.

Within these abstract concepts, often serious, often catchy narratives, the methods of the real-time in-use water activated ink imprinted animated ecological educational recycling narrative that is imprinted upon the ECPC ecologically educates one handling the ECPC, and integrates the abstract concepts of ecological education into a matter of practical application and more often directs the utilized ECPC to the infrastructure of plasticene recycling. Accordingly, enhancing the infrastructure of plasticene recycling and the quality of the environment by contributing to the maintenance of the basic life-sustaining natural elements of the air, water, and soil.

In view of claim 2, its composite is comprised of at least one of each of the following, a composite, a capillary, a ply, a reservoir region, a shape involving an outer shell, an undercarriage, a center section, an upper rim, an interior cabin, an ink, and the processes of claim 2, involve at least, forming, through a manufacturing process, a composite, the PC's composite being comprised of a shape that is formed with a substantially horizontally planar undercarriage, a substantially vertical outer shell, an upper rim, a form-fitted interior cabin, and a center section. The quality of this arrangement suits the case of function of the present invention so the one utilizing the ECPC makes little to no effort to see the purpose of the coupling's narratives through its handy ecological educational narratives.

Within these processes the manufacturing of the PC may be accomplished independently from the manufacture of an EC, as a standalone PC. As well, in another process of manufacturing, the coupling of the LCC to the RNC may be accomplished during manufacturing of an EC and PC, ECPC. Each manufacturing form may be predicated upon consumer demand in relation to manufacturing efficiencies.

The shaping of the EC during manufacturing processes, shapes the EC with a shape consisting of a sidewall, and whereby a dimension of the EC's sidewall in relation to a dimension of a portion of the PC's shape being formed during manufacture to accompany the PC at a substantially lower portion of the PC, and whereby a substantially lower portion of the RNC fits securely into the PC's interior cabin. Such structural engineering effects are taken into consideration in like fashion to most manufacturing processes where form follows function.

In terms of formulating through manufacturing processes, the EC's composite is formulated so the EC's composite possesses highly hydrophilic auto-molecular liquid absorbent methods with a composite such as though not limited to hemp. And the formulation of the hemp's composite, through its manufacturing processes, is comprised of a ply with a dimension and whereas the hemp's ply's dimension is comprised of variant particle concentrations and a binding agent. The variant particle concentrations regulate the movement of water within the composite as water tends to flow to a region with less resistance. As well, the formulation of the hemp's composite through its manufacturing processes, and its methods of highly hydrophilic auto-molecular liquid absorbency freely absorbs condensation that has pooled on a surface through its substantially planar undercarriage, and through its upper rim and through its substantially vertical outer shell when condensation is emanating upon the sidewall of the PC and is being drawn downward by a gravitational field to the upper rim and the substantially vertical outer shell of the RNC, thereby channeling the water to the position in the PC's composite where it may realize its functional utility.

The structuring of the composite through its manufacturing processes, comprises the composite so its liquid reservoir region is embedded within the dimension of the substantially vertical outer shell of the PC's ply, and is formulated, through its manufacturing processes, so the PC's composite's highly hydrophilic auto-molecular liquid absorbent methods are comprised with methods to absorb, expand, and stow a volumetric of liquid within the EC's reservoir region of the substantially vertical outer shell of the EC's composite, and likewise realize its functional utility. This feature is achieved by arranging, through its manufacturing processes, the EC's composite so the ply of the RNC's substantially horizontally planar undercarriage contains hallow cored liquid conveying capillaries that are embedded within the ply's dimension and are truncated with orifices for liquid inlet and outlet, for conveying the water to the precise location where it may best realize its functional utility.

The organization of the EC's composite through its manufacturing processes provides it with liquid conveying capillaries. Its liquid conveying capillaries are embedded within the EC's ply composite and are truncated at a border of the center section of the EC with liquid inlet orifices and are arranged to horizontally radiate from the border of the center section of the EC and extend radially through the EC's undercarriage and into the EC's outer shell and bend upwards into the substantially vertical outer shell of the RNC and into the liquid reservoir region of the EC where the liquid conveying capillaries are truncated with orifices that comprise liquid outlets. This organization provides an organized aqueduct effect that efficiently transfers water to a utilitarian position as mentioned above. Such organization sets the stage for the amination of the water activated invisible ink from being invisible upon the outer shell of the EC to visible upon the outer shell of the EC when the water-ink interaction occurs.

The EC is formulated through its manufacturing processes, so the EC's liquid conveying capillaries are comprised with hallow cores that provide methods to convey fluid through the liquid conveying capillaries hallow cores in parallel and against a gravitational field through methods that are induced by capillary action originating from the EC's composite, and induced by a vacuuming effect that originates from the expansion of the EC's outer shell as it absorbs and stows condensation and expands. This process is a naturally occurring phenomenon that requires no human effort and is achieved in light of the composite of the hemp's methods to do so. As well the composite is formulated, through its manufacturing processes, so the EC's composite is comprised of a biodegradable, eco-friendly, and recyclable composite. As illustrated throughout the present invention's disclosure, the preferred embodiment of the composite being that of hemp. As well the EC can be individually wrapped in an organic apron or sleeve that protects its structural integrity from the point of manufacture to the point of utilization.

In view of programming the computerized and network connected imprinting machine for the purpose of having it readied for imprinting creative ecological educational narratives upon the outer shell of the EC, a computerized imprinting machine is programmed, virtually or remotely, and the programming is updated as required to imprint the creative ecological educational recycling narratives that are comprised of a water activated invisible ink upon the substantially vertical outer shell of the EC's composite. The imprinting of the EC, imprints creative, tailored, and refreshing ecological educational recycling narratives upon the substantially vertical outer shell of the RNC's composite with the water activated invisible inked ecological educational recycling narrative that are imprinted upon the outer shell of the RNC's composite and that have methods to interact with the water that is stowed within the EC's reservoir region. And the formulation through the methods of a manufacturing processes, provides methods so the water activated invisible ink that is imprinted upon the outer shell of the EC's composite's reservoir region interacts with water that is stowed within the EC's reservoir region and the stowed water and ink interaction animates the inked imprinted creative ecological narratives during in-use real-time utilization of the ECPC, and the interaction promulgates the animated ecological educational recycling narrative that is imprinted upon the substantially vertical outer shell of the RNC from being invisible to visible, or in another sense camouflages to not camouflaged.

The creative colorized animated ecological educational recycling narratives that are imprinted upon the EC's outer shell, and their abstract concepts ecologically educate the person utilizing the coupling, so the person integrates the abstract concepts of ecological education into a matter of practical application and more often elects to recycle the coupling. Within doing so the abatement of plastic cups reaching landfills is achieved, and the quality of the environment through the contribution to the maintenance of the basic life-sustaining natural elements, notably, the air, water and soil and the species that depend on their health are enhanced.

### In View of Claims 3 and 4

The full-loop system for the manufacture, utilization, and reclamation of single-use plastic cups into the infrastructure of recycling, comprising: a prior-to-utilization Single-use Plastic Cup (cup) involving a shell that is characterized with digitized identifying motifs, a Condensation Collecting Coupling comprised of Composites (coupling), and attaching the coupling to the cup, herein known as a “S/C”, a Networked Cloud-Based Server (NCBS), wherein the system embodies a unified lifecycle innovation that integrates: (i) engineered design and material selection during manufacture, (ii) user-interactive features during utilization, and (iii) computerized programmatic intelligent recognition and robotic sorting post-utilization. This full-loop system originates at inception with purposeful design and compostable composites, functions through behavior prompting visual animating indicia during utilization, and revolves in a digital infrastructure that facilitates programmatically automated reclamation, collectively enabling a systemic pathway of manufacture, utilization, and reclamation of the S/C for the purpose of expanding the infrastructure of recycling whereby;

The full-loop system begins at inception whereby a thoughtful approach to an all-encompassing architecture and related method, process and system needs to be developed for the purpose of enhancing and then maintaining the quality of the air, land, and soil by reclaiming composites. Such concepts take into consideration the objectives of viewing the entire cycle of consumer goods, in the present invention, notably single-use plastic cups. Although the concept and likewise the method, process and system of the present invention can be expanded to other composites such as though not limited to aluminum and metals of ferrous and non-ferrous compositions, cardboard, Styrofoam, glass, general plastics, rubberized compositions, and textiles. As well the concept and practice of the present invention can be applied to a wide array of consumer goods, such as though not limited to bottles, containers, boxes, electronic devices, building materials, medical devices, cookware composites and packaging materials.

The method, process, and system, herein where applicable understood as ‘MPS’ begins at the conceptual level where an entire MPS is envisioned to include all areas of manufacture, utilization and post-utilization reclamation of composites, thus a “Full-loop” of manufacture, utilization and post-utilization reclamation of composites. Once fully conceptualize by a POSITA the first action is to a) select, prior to manufacture of the RNC, EC or coupling, herein collectively understood as a ‘coupling’, naturally occurring binding agents and naturally occurring composites involving heterogeneous particle compositions with varying concentrations exhibiting intrinsic hydrophilic absorption and retention properties such as though not limited to hemp-fiber and hemp hurd, and then transitioning into b) manufacturing the coupling from the composites.

Once the composites of the coupling are selected and the coupling is manufactured the next action or step is in c) selecting, prior to utilization of the cup, bioplastics exhibiting hydrophobic properties; LCC, PC or SPC, herein collectively understood as a ‘single-use plastic cup’ or simply ‘cup’, though the concept of the invention and its production and practice can extend to non-single use plastic cup, and then, d) manufacturing the cup from the bioplastics. Once this task is accomplished the POSITA will e) digitally develop identifying motifs that characterize cups according to their unique traits, such as though not limited to material composite, size, coloration, and composite thickness for the purpose of determining them as recyclable single-use plastic cups. Then, f) then the determining characteristics and the unique traits of the coupling will be acquired and converted into digital data will characterize and be the unique traits of the cups will be performed.

Next, g) is the task of characterizing the prior to utilization cup during manufacture with identifying motifs such that the identifying motifs appear upon the shell of the prior to utilization cup will be implemented such that the cups contain motifs that provide computerizes sorting machine information that directs that computerized robotic sorting machine about how to sort the cups. After this task, the POSITA will, h) attach, manually or mechanically through automated machinery, the coupling to the cup prior to utilization of the cup and in doing so form what is herein known as an S/C. Once the coupling is attached to the cup, likely within though not limited to the recess of the subjacent structural rib of the cup, the POSITA will i) digitally imaging the prior to utilization cup prior to its utilization that is characterized with identifying motifs that appear upon the shell of the cup and has an attached coupling, herein often referred to as the S/C.

A pair of two tasks of programming and recognition tasks will be performed after the coupling is attached to the cup. The first being, j) programming the computer of the NCBS to recognize a prior to utilization S/C. This first task is completed so that the NCBS have a baseline digital image of a prior to utilization S/C for such reasons that may involve though not be limited to the eventuality that an S/C is not hydraulically crushed prior to arriving in a waste and recycling facility. The digital image may also inform an operator of the systems in the waste or recycling facility about what the uncrushed cup looks like for informational reasons that may lead to better sorting. The second task of the pair of two tasks will include k) programming the computer of the NCBS to recognize a hydraulically crushed cup that is characterized with identifying motifs upon its shell within a digital image of the hydraulically crushed the cup. The reason that this task is performed is that single-use plastic cups that have been placed in recycle bins of commercial places and residential homes are often collected by recycling trucks that have hydraulic crushers or compactors that hydraulically crush the materials and composites that collect and carry away to waste and recycling facilities. Once the trucks arrive they dump their contents into the waste and recycling facilities machinery whereby the cups will then be placed upon a conveyor belt and be digitally imaged, inclusive of their unique motifs that characterize their composites and then be programmatically sorted into their respective bins. As the cups during their collection, transportation and dumping into the waste or recycling facilities and then being placed on conveyors belts made be oriented in any degree the next task of the POSITA will be to l) orient the hydraulically crushed cup that is characterized with identifying motifs on its shell at multiple different degrees and digitally imaging the hydraulically crushed cup that is characterized with identifying motifs upon its shell and is orientated in multiple different degrees. In doing so the unique motifs will be likely to be detected, imaged and utilized for sorting purposes. In the event that material is imaged by the waste or recycling facility and is not recognized as part of the full loop system the material may be left alone for collection or sorting by other operations. In this instance a response of ‘No’ and its related compartment of a rectangle would appear in the flow chart associated with this document. Though as such operations are presently not integral to the concept of the present invention, no such operation appears at this time, though could appear at this time or in the future. In correlation with this procedure the or a POSITA will also m) program the computer of the NCBS to recognize the cups in multiples of digital images of the hydraulically crushed cups that are characterized with identifying motifs on their shells and are oriented in multiple different degrees. This procedure will ensure that the cups, despite their orientation on the conveyor belts, will be recognized, digitally imaged, and sorted into their proper bins.

A like procedure will be in place for the composite of the hydraulically coupling as once the S/C is crushed the coupling is shattered and loosened from the cups and is in pieces. As it contains compostable composites it is prized returning to the manufacturing facility where it was originally fabricated, to a like facility or it may be utilized for varying agricultural or industrial purposes. Thus, it as well is part of the full loop of the concept of the present invention. As mentioned this procedure is performed in like fashion as the procedure for the cup whereby the POSITA will n) digitally image a hydraulically crushed composite of the coupling and upload the digital image of the hydraulically crushed composite of the coupling into the computer of the NCBS and the a POSITA will o) program the computer of the NCBS to recognize the composite of a hydraulically crushed coupling in a digital image of the hydraulically crushed coupling. Digitally imaging items are common to those that practice the art of digitally imaging items. And programming computers to recognize items in digital images is common to those that practice the art of programming computers to recognize items in digital images. For these reasons those that are ordinarily skilled in the respective arts will know and appreciate their respective art. They will have the capacity to perform these procedures inclusive of all details involved in doing so as they are part of the common functions in the fields of endeavor to which their art pertains.

The next task involves a POSITA that is involved in the field of endeavor of restauranteering or a field that serves beverages in plastic cups or any sort of container. Serving beverages to customers is quite common in this field and likewise it a common event at restaurants and establishments that serve beverages. These establishments are always on the lookout for improving customer service and convenience and will appreciate the utility of the S/C in light of its utility of natural condensation absorption through its ergonomic user-friendly architecture that make their customers and their experiences at their restaurants or cafes feel thought of. As such, they will appreciate feeling appreciated and likely have a mindset of mutuality and engage in the spirit of recycling by placing their utilized S/C into a recycling bin. Accordingly, the restaurateurs will p) deploy the S/Cs to consumers of S/Cs for utilization and recycling of the S/Cs. This activity is critical to the full loop of the concept of the invention and likewise the invention, through its system of attaching the condensation collecting coupling to the cup that provides an elegant form of conscientiousness to the restaurateurs' customers. These effects are detailed in the “Introduction to the Narrative of: “Psychological of Ergonomics and its Motivations in Light of Customer Convenience and Influence on Recycling Efforts” of this document. In light of these considerations and through experimentation in field operations, collection and analyzation of data in pre-deployment of the S/Cs comparative to analyzation of data during deployment and operation of the S/Cs the refinement of the practice and objective of the S/C will be borne out through ongoing practice as the spirit and mindset of the customer in relation to recycling single-use plastic cups, notably those that are fashioned as an S/C will improve and the objectives of the present invention of providing for customer convenience and increasing the infrastructure of recycling will be realized.

As the present invention encompasses a full-loop system for manufacture, utilization and reclamation of single-use plastic cups into the infrastructure of recycling the material in claim 3 is further characterized as transmitting the digital images and data through the network of its NCBS to networked waste and recycling sorting facilities that contain networked computerized waste and recycling programmatic robotic sorting machines. A POSITA in the art will readily recognize and perform the technological techniques that are required to transmit the digital data through the network as such applications are among the most ordinary practices in the respective field of endeavor. Upon transmission and arrival at the waste and recycling sorting facilities transmit the digital images and data will be transmitted by a POSITA to the facilities networked computerized waste and recycling robotic sorting machines in like manner and do so in order that the facilities' computers programmatically recognize the identifying motifs of the hydraulically crushed cups and the determining characteristics of the coupling that have been converted into digital data and digital images of the coupling and robotically target, sort and reclaim hydraulically crushed cups and hydraulically crushed composites of the CCCCs into the infrastructure of recycling thereby effectuating a full-loop system for revolving the manufacture, utilization and reclamation of hydraulically crushed cups and hydraulically crushed composites of the CCCCs into the infrastructure of recycling.

### Chilled Beverages and the Commercial Benefits of the Present Invention

Beverages are often served chilled or iced in an LCC when warmer atmospheric conditions are prevailing. When warm air comes into contact with the sidewall of an LCC that has been chilled by the liquid within it, heat is transferred from the warm air as it contacts the colder sidewall of the LCC resulting in a loss of heat in the surrounding air causing water vapor to lose energy. Once a sufficient amount of thermal energy is lost, the water vapor condenses into liquid water, condensation droplets, on the sidewall of the LCC. As the liquid of the beverage in the LCC is colder than that of the atmosphere it is contained within, particularly when the beverage has been refrigerated or chilled with ice and is considerably colder than the atmosphere it is contained within, the conditions for the formation of condensation droplets are heightened. This set of conditions induces a molecular reaction whereby the state of water vapor of the atmosphere that the LCC is contained within will change states, condense, and convert vapor to liquid and form water droplets on the sidewall of the LCC as illustrated immediately above. The water droplets then are drawn downward by a gravitational field onto a surface that the LCC is placed upon forming a pool of water on the surface that the LCC is placed upon. As described herein, this set of conditions creates a problem of pooling water on surfaces for restaurateurs and beverage serving establishments and is one of three problems that the present invention solves.

As well the present invention mitigates dripping of condensation onto food items while the ECPC is being held by a patron and transferred back and forth between its resting place and the beverage's consumer. As well, it mitigates dripping of condensation onto patron's apparel and anywhere the ECPC is being transported, as often times patrons are not stationary at tables. In doing so, that is to say, mitigating dripping, less water pools on the floor of an establishment. A further benefit therein becomes evident, there is less water pooling on the floor, indoors or outdoors of an establishment and slipping hazards are reduced and likewise, less litigation occurs, saving the establishment's reputation, time, and money.

Benefits of the present invention in relation to the aforementioned series of disclosures become readily available; they are dynamical in relation to purposing. That is to say, the embodiment of the EC while accompanying a PC is novel in terms of efficiency. Prior art requires at least two (2) separate embodiments to accomplish the first two tasks of maintaining a dry surface and/or manually drying a wet surface. For example, one instrument may be an absorbent wrap set around the exterior of a PC, often makeshift and improvised, for the purpose of preventing condensation from reaching a surface that the ECPC is placed upon. And at least one separate drying apparatus to dry a wet surface, such as though not limited to towels, paper napkins and sponges.

### Restaurateur Artisans in Relation to Social and Ecological Responsibilities

Of particular significance to restaurateurs, who are herein understood as ‘artisans’ of the present invention very well know the habits of their patrons, and hence, are ‘experts’ in the field of endeavor of restauranteering. A key aspect of achieving the present invention's goal is by efficient deployment of ECPCs. Corporate sponsorship of ecological and socially responsible practices are heightened and reflect well in the public's outlook when practicing new eco-friendly initiatives. Such practices are well viewed in the public's opinion and often lead to increased sales. As well, corporate entities know that numerous patrons locate and utilize paper napkins to wipe away pooled water from previous patrons' cups prior to sitting, principally when the restaurant is busy, and activity is brisk, and they wish to be immediately seated. Such activity is often beneficial, though it also causes a multitude of inefficient logistics for establishments and disenchantment of their patrons in view of the patrons needing to clear a table of leftover condensation. Of specific note, this practice causes the patrons to reluctantly either set down their beverages as they may have to locate and go to the napkin dispensary when it is not already placed on the table, as is frequently the case. Then, after taking any number of napkins they are self-tasked with wiping the table of residual water of prior patrons' cups condensation, then they need to bring the wet paper napkins to the recycle bin and return to their table. All of these actions reduce pleasant customer experiences, a highly prized business strategy for customer acquisition and retention.

Moreover, the variance of biomass between the apparatuses utilized to dry and/or keep dry a surface whereupon condensation has pooled is considerable. In one method, cleaning products such as paper napkins are used as needed or more often liberally, or cloth towels that later require washing. In general, as patrons assume the tasks of drying a table of condensation from previous patrons, when a server is not there to do so, as is often the condition when the restaurant is busy as previously described, they are not disposed to be frugal with supplies that are made available by the restaurant. Patrons will, locate, take, and use an inordinate number of paper napkins as also mentioned in previous paragraphs, in order to soak up the residual condensation and then dispose of them. Or, when the disposal bin is not within convenient distance, they may leave the wet napkins in an improper place to be found later by employees or future patrons. This activity, in cumulative total, impacts the cleanliness and profit margins as employees need to locate and dispose of the wet napkins. The present invention precludes all these pursuits.

In one view of practicing the present invention, a number of congenial patrons who are socially conscious may take an initiative to utilize their ECPC s prior to departing and dry pooled liquid from other tableware they were utilizing and accordingly, place their ECPCs in a recycle bin. In doing so, other potential less congenial patrons may view such practice as conscientious and may be more inclined to patronize the restaurant and partake in the practice of utilizing the purpose of the ECPCs. In another view, when patrons frequent a restaurant, perhaps an outdoor or sidewalk cafe and the temperature, dew point and atmospheric conditions, in relation to the temperature of liquid inside a PC are conducive to forming condensation droplets on the sidewall of the PC and such condensation drips to and pools on the surface of a table or the like, and the patrons complete their experience and leave their PCs on the table and depart, an employee can readily utilize their ECPCs to dry the surface of the table from the pooled condensation.

Sometimes patrons have an unattached coaster, however they are beverage is not placed on their coaster and condensation droplets that are dripping from a PC are causing wetting of a surface or of their foods, and other surfaces such as though not limited to counters, bar tops and more particularly floors where it causes a slipping hazard leading potentially to litigation, the present invention methods of stowing water within the reservoir region of the RNC mitigates such potential litigation. A prominent benefit becomes apparent when PCs are left behind (see drawings) they will automatically absorb pooled water and perform a job function of an employee that would otherwise need to be paid to perform, consequentially saving labor hours and money. As an employee would perform the same task, there is no additional labor nor loss of money. In fact, there is a saving as the ECPCs are immediately at the employee's disposable, and tablecloths do not need to be utilized and washed.

### Hygiene

Restaurants often receive reviews in relation to cleanliness in local media outlets. When a municipal inspector visits a restaurant to check for cleanliness violations the inspector notes all violations, inclusive of though not limited to unclean tablecloths lying about the restaurant. Current and prospective patrons review the inspector notations and form opinions about the restaurant. The present invention would abate these notations as there would be fewer wet napkins and tablecloths lying about in the restaurant in random spots.

As the establishment utilizes the same cleaning cloth between tables, the utilizer may as well unwittingly transfer biohazards between the tables or throughout the establishment in the form of leftover food particles and the presence of any pathogens left behind by patrons. Such creates a clear and evident necessity for a novel invention such as the present invention in that it prevents and wicks pooled surface water and while doing so, potentially collects leftover food particles and pathogenic biohazards and whereby such effects are immediately disposed of as described herein. The inventor of the present invention notes that these benefits are corollary effects of the present invention. It should be understood, however, that in view of these corollary benefits, hygiene at restaurants that utilize the methods of the present invention are enhanced, and in turn, lessens potential violations. Restaurateurs actively seek out these types of benefits, and the present invention provides them.

### Novelty and Non-Obviousness

Artisans in the field of endeavor to which the present invention pertains, notably restaurateurs, will be surprised with an apparatus that wicks and stows water to an uncommonly touched place on a PC. Upon first glance at a PC that has an accompanying EC artisans may momentarily wonder what it is. They will soon, perhaps during experimentation and trial, discover the novelty of the present invention. Such surprise lends itself to the concept that what the artisans are utilizing is novel to them. This concept enhances the present invention's patentability in view of its non-obviousness to those ordinarily skilled in the art of utilization of disposable tableware.

### Prime Functioning Properties

As the EC accompanies a PC at a substantially lower section of the PC, the gravitational field that the accompaniment is contained within, draws the condensation, water droplets downwards in the direction of the EC. Once the water droplets contact the composite of the EC the auto-molecular reaction of the composite of the EC, as the EC's composite is hydrophilic, and polar interactions between water and the molecules of the solid, in the present invention the preferred embodiment of hemp that is processed in accordance with global food safety initiative standards and is textured into a micro-hurd, and having a water permeable aerated binding agent and being comprised of though not being limited to at least one of the following; Ground flax, Pectin, Guar gum, Psyllium husk or Xanthan gum as such aerated binding agents favor partitioning of the water into the hemp's fibers and takes place as the water droplets are absorbed by the composite and stowed in the RNC's reservoir region.

As the composite of the hemp's ply fibers within the EC's reservoir region is of a lesser particle concentration than other regions of the EC's composite, much like the two sides of a bath towel, the water remains stowed within the EC's reservoir region. As the water droplets are stowed in the EC's reservoir region and as water molecules are molecularly attracted to one another, they charge the RNC's molecular status and prime it for water molecules that are in or will be in the hallowed capillaries in the EC's undercarriage and effectually create a priming sequence whereby a vacuum effect is generated by the water molecules in the reservoir region of the RNC that creates a vacuuming influence on the water molecules in the capillaries that encourages them to flow horizontally then upwards at the composite's junction of the outer shell and substantially vertical sidewall toward the EC's reservoir region. The aforementioned vacuuming effect in tandem with the capillary action that works against a gravitational field, further enables water within the RNC's hallowed capillaries to flow into the EC's reservoir region.

### Properties of the Preferred Embodiment

The functional properties that are specified herein of the present invention, inclusive of its auto-molecular and hydrophilic properties of the preferred composite of hemp with its micro-hurd, and forming it into the shape of the EC, that is held fast post production by the water permeable and pliable aerated binding agent, and the capillaries with their capillary action and inlet and outlet of water at the capillaries' orifices, that can be performed paralleled and against a gravitational field that the formation of the invention provides, and wicking, conveying and the stowing of liquid by methods of a reservoir region within the EC's reservoir region are set apart in terms of being beyond the ordinary labors of those ordinarily skilled in the art to which the present invention pertains.

As the liquid conveying capillaries are embedded within the ply of the EC, are hallowed core and contain and inlet and outlet orifice that are truncated at the border of the center section of the EC and radially extend towards the outer wall of the EC, and whereas the liquid conveying capillaries embedded within the ply of the EC are angled at the intersection of the substantially planar undercarriage and the vertical wall of the EC and extend vertically within the RNC and are truncated with an orifice at a dimension from the intersection of the vertical wall and the substantially planar undercarriage of the EC. And the causes and effects of capillary action that the auto-molecular forces as illustrated herein, that cause the present invention to transfer and maintain water in a reservoir region in light of the molecular effects of cohesion that are afforded in the present invention lend it novelty. In view of the hallowed core capillaries extending radially from the center section of the composite of the EC, the illustrated formation of the capillaries is intended to be presented in an illustrative though not limiting sense. The capillaries could take the formation of a honeycomb, hexagon, herringbone lattice, interconnect concentric circles, geometric or amorphous shapes thereof to convey liquid into the EC's reservoir region.

### Manner of Utilization

As artisans grip the upper section and away from the EC, it increases cleanliness as neither patrons nor employees will come into contact with liquid. The overarching shape of the EC in another rendition may be compartmentalized within a portion of the PC that is recessed for having methods to be placed into an automobile's cup holder. Hence, utilization of the present invention requires no touching of liquid absorbing apparatuses. Conversely, in present art, some patrons, after wiping water will utilize a secondary round of paper towels to dry their hands because of touching liquid. To that point, some employees balance between cleaning and serving. Sometimes employees touch cleaning instruments such as tablecloths and then serving plates. Opportunity for transference of food particles and biohazards becomes evident. In the utilization of the present invention, and unlike the present art of ordinary paper towels, namely napkins and tablecloths that distribute water in random patterns within their fibers, the present invention uniquely transfers water to a reservoir region. Consequently, employee's and patrons' fingers do not need to touch the wet sections of the drying apparatus when drying a wet surface as they will grip an upper section of the LCC, as mentioned, away from the liquid. These factors improve hygiene, cleanliness, and patron satisfaction. All of which not only have a commercial advantage, though also a social advantage in terms of enhancing cleanliness and hygiene.

### Enabling a Person Ordinarily Skilled in the Art

For purposes of enabling a person ordinarily skilled in the art (POSITA) of endeavor to which the present invention pertains the following sections will provide the Manufacturer of Compostable Cups (MCC) with a comprehensive guide for configuring the coupling through the molding process, to make and use the present invention, the RNC and alternatively the ECPC, for case of legibility herein, the RNC, are illustrated within the following sections (A.1), (B.2), and (C.3) are provided. The sections, taken in their entirety, provide: (a) Sufficient Detail: about the invention, such as its structure, composition, composites, inclusive of molecular sequences, and process steps, so that one skilled in the relevant art can understand how to produce and use the invention, including information about the materials, methods, or mechanisms required to carry out the functional utility of the invention, (b) Breadth of Claims vs. Disclosure: the scope of the claims are commensurate with the disclosure in this specification and provide sufficient detail to support the full breadth of the claims, (c) This specification provides enough information so that only routine experimentation is needed to implement the invention, (d) Full Disclosure: this specification, within its claims, abstract, specification and drawings, describes both how to make the invention and how to use it. For example, it outlines the steps, components, and functionality necessary to achieve the intended results, (e) Specific and Generalized Descriptions: the present invention as well provides specific examples of the invention's working embodiments and describes the invention in general terms to cover broader applications, (f) its drawings illustrate how the MCC's functional embodiments and the invention's intended use help the MCC visualize the invention, and (g) as mentioned above and in relation to the utility of the invention it is described, when taken this specification in its entirety, in a way that its utility (practical purpose or use) is apparent to someone skilled in the art as it emphasizes the invention with clarity, completeness, and support for the subject matter disclosed in its claims.

(A.1), (B.2), and (C.3), and their Variations and Permutations for Formulating and Configuring the RNC

Variations and permutations, also understood as ‘the number of possible arrangements for a specific set of elements, or configurations and composite profiles of the RNC are provided herein and are directed toward the singular invention and singular species of the claims, the RNC. The variations and permutations of configurations and composite profiles are: (A.1) Formulating the Compostable Composites of the RNC's Coupling Embodiment and Molding the Configuration of the Compostable Composite of the RNC's Coupling Embodiment, (B.2) Formulating the Hemp Plastic Composite and Molding the Embodiment of the Hemp Plastic Cup Configuration of the RNC by Utilizing the Injection Molding Method and, (C.3) Formulating the Modular Hemp Plastic Composite of the RNC's Cap and Screw Configuration and Material preparation for the hemp-based couple that is performed by the MCC for the blow molding process and Hemp Fiber and Hurd Sourcing

The RNC as a Unified Apparatus in Light of Variations of Formulations and Configurations The level of detail in relation to sections (A.1), (B.2), and (C.3), and each part of the specification section taken in its entirety should be sufficient to allow a person of ordinary skilled in the art to replicate the invention based on the information provided in this document. This includes outlining materials, steps, and various configurations of the RNC. Thus, and for the purpose of enabling one who is ordinarily skilled in the field of endeavor to which the present invention pertains, the MCC, as illustrated throughout this document, to make and use the present invention, the variations and permutations are inclusive of, though not limited to the best mode of practice, or preferred embodiment, are herein illustrated. Though configuration variations, permutations and composite potentials exist, the RNC, under every configuration or permutation is considered as a unified apparatus, it is the invention that is pointed out by the claims is the singular invention towards which the claims disclose.

### (A.1) Formulating the Compostable Composite of the RNC's Coupling Embodiment and Molding the Configuration of the Compostable Composite of the RNC's Coupling Embodiment

To meet the dual goals of functionality and sustainability, the MCC must formulate the compostable composite for the RNC's coupling embodiment with precision. This formulation process combines key materials such as jute, coir or more specifically, hemp fiber, hemp hurd, and natural binding agents such as agar agar (C₁₂H₁₈O₉ₙ) and Wheat Starch (C₆H₁₀O₅ₙ) each selected for their unique chemical properties and contributions to the coupling's overall structural integrity, moisture absorption, and biodegradability. The composite's formulation requires a meticulous balance between these components to ensure the coupling's durability during use, its biodegradability post-use, and its efficient moisture absorption. The RNC's coupling serves as a moisture-management system designed to attach seamlessly to the cup's base, preventing condensation from accumulating on the cup's exterior. By retaining condensation within the coupling, the composite maintains hygiene and user convenience. This document provides a detailed guide for the MCC in creating this composite material, covering the preparation of the raw materials, the precise ratios required, and the processes necessary for achieving a compostable, eco-friendly coupling.

### Material Composition and Chemical Profiles

The primary components of the compostable composite include hemp fiber, hemp hurd, agar agar, and Wheat Starch. Each material has been chosen for its specific properties, which collectively yield a durable and moisture-absorbent coupling material. The following chemical profiles are provided to add specificity for one who is ordinarily skilled in the art of the manufacture of hemp-based composites. They highlight why hemp fiber and hurd are complementary in composite formulations. The high cellulose content of hemp fiber provides tensile strength, while the higher lignin concentration in hurd ensures moisture resistance and rigidity, making them ideal for creating a durable, compostable composite. The chemical sequences for hemp fiber and hemp hurd primarily reference their major components, cellulose, and hemicellulose, as well as lignin, which varies in structure and lacks a specific, repeatable chemical formula due to its complex and irregular polymer structure. Below are the chemical sequences for cellulose and hemicellulose as they relate to hemp fiber and hurd.

### Hemp Fiber and Hemp Hurd (Cellulose and Hemicellulose)

The chemical profiles of hemp fiber and hemp hurd, including cellulose, hemicellulose, and lignin, are provided solely to assist one ordinarily skilled in the art in understanding their composition as it pertains to their use in the disclosed composite materials. The present invention does not claim any novel chemical composition of cellulose, hemicellulose, lignin or any other composite synthetic or naturally occurring.

The hemp fiber and hemp hurd molecular sequence may include though are not limited to the following: (1) Cellulose: (C₆H₁₀O₅)ₙ, cellulose is a polysaccharide with a repeating unit of glucose, where (C₆H₁₀O₅)ₙ represents its structure. The value of “n” indicates the degree of polymerization, typically ranging from hundreds to thousands of glucose units linked by β (1→4) glycosidic bonds. This structure gives cellulose its fibrous, strong qualities, (2) Hemicellulose: generally approximated as (C₅H₈O₄)ₙ for the main pentose sugar units. Hemicellulose is a heterogeneous polysaccharide composed of various sugar monomers, including xylose, mannose, galactose, rhamnose, and arabinose. While it lacks a singular, repeating chemical formula, it is often simplified as (C₅H₈O₄)ₙ for the pentose-rich structure, with “n” representing the polymer length, though it is generally shorter than cellulose chains. This branched, amorphous structure imparts flexibility to hemicellulose, (3) Lignin: Lignin does not have a fixed chemical sequence due to its complex, cross-linked structure of phenolic monomers, including p-coumaryl, coniferyl, and simply alcohols. It is typically represented by a random network of these phenolic units linked by C—C and C—O—C bonds, which vary depending on the plant source and processing. Since lignin lacks a specific molecular formula and polymerizes in a highly irregular manner, it is challenging to represent with a single repeating unit. However, its presence in high quantities in hemp hurd provides rigidity, moisture resistance, and durability, making it integral to the properties of both hemp fiber and hurd in composite formulations.

### Formulation of the RNC's Compostable Composite

Formulation of the RNC's compostable composite may include though is not limited to the following: (1) Hemp Fiber: The core structural element of the composite, hemp fiber is characterized by its high cellulose content, ranging from 55-72%, which contributes significantly to the strength and rigidity of the coupling. Cellulose provides tensile strength, while the fiber's hemicellulose content (15-25%) adds flexibility, enabling the composite to withstand handling and regular use. The small amount of lignin (3-5%) within the hemp fiber adds structural rigidity, while trace elements such as pectin (0.9-1.2%) and waxes (0.5-1.5%) serve to reduce water absorption at a microscopic level, contributing to the coupling's moisture management capabilities. This unique chemical composition makes hemp fiber an ideal candidate for applications that demand both durability and moisture resistance, while still allowing the coupling to compost efficiently, (2) Hemp Hurd: Hemp hurd, the woody inner core of the hemp plant, complements hemp fiber by providing additional rigidity due to its distinct composition. It contains lower levels of cellulose (35-40%) than hemp fiber but has a higher concentration of lignin (20-30%), which adds to the material's moisture resistance and structural stability. Hemicellulose content in hurd (20-25%) also supports flexibility, which, when combined with the binding agents, helps maintain the coupling's integrity under typical environmental conditions. By balancing the cellulose and lignin levels, hemp hurd enhances the coupling's resistance to wear, even with regular condensation exposure, (3) agar agar (C₁₂H₁₈O₉ₙ): Serving as the primary binder, agar agar is a polysaccharide extracted from red algae that provides both adhesive strength and biodegradability to the composite. Its molecular structure allows for strong hydrogen bonding with cellulose, helping to unify the hemp fiber and hurd into a cohesive material. agar agar's polysaccharide chains contribute to its strength as a binder while allowing the material to break down fully in composting environments. This balance of durability and environmental compatibility is essential for creating a coupling that performs well and aligns with the RNC's sustainability goals, (4) Wheat Starch (C₆H₁₀O₅ₙ): Wheat Starch, composed of the polysaccharides amylose and amylopectin, reinforces the composite by adding additional binding strength without compromising its compostable nature. The amylose chains in Wheat Starch contribute to the rigidity and stability of the composite, while the branched structure of amylopectin provides flexibility. Wheat Starch's compostable properties ensure that the coupling decomposes naturally post-use, leaving no harmful residues in the environment.

### Formulation Ratio and Blending Process of the Aggregate

Creating an effective compostable composite requires the MCC to determine the ideal ratio of each component and will often be determined by the intended utility of specific clients for the purpose of ensuring the coupling's mechanical integrity and moisture management while adhering to eco-friendly standards. A typical base ratio is 30:70 (hemp fiber to binder), though this can be adjusted depending on performance testing and specific product requirements. This balance allows the composite to be sufficiently strong for practical use, while also retaining flexibility and biodegradability.

To prepare the aggregate for blending, begin with the hemp fibers and hurd, which are essential for providing the structural foundation. Hemp is naturally hydrophilic, meaning it readily wicks moisture, so precise drying of the fibers is critical. The aggregated organic compound, of the hemp, exhibits a porous microstructure and hydrophilic properties that enable it to absorb water. The material's cellulose-rich composition facilitates the adsorption of water molecules through capillary action and hydrogen bonding, wherein the fibers draw moisture into interstitial spaces within the aggregate. This absorption process is influenced by the compound's surface area, porosity, and the hydrophilic nature of its constituent organic polymers, allowing it to retain water within its matrix until equilibrium with the surrounding environment is achieved. Accordingly, the MCC should dry hemp fibers and hurd to a moisture content below 0.02% to avoid moisture-induced defects like steam bubbles or voids in the final composite. Using a dehumidifying dryer set between 80° C. and 100° C., dry the hemp components for 2 to 4 hours. This process ensures that the fibers retain their structural integrity without introducing excess moisture, which could lead to issues such as warping or weak bonding during the molding process. Following the drying phase, the hemp fibers are cut to a uniform length of approximately 2 to 4 millimeters though are not limited to such dimensions. This specific fiber length improves flow properties within the composite, facilitating an even distribution during the blending process. Uniformity in fiber length is critical to achieving a consistent material texture, as it prevents clumping and enables the binder to encapsulate each fiber adequately. Proper encapsulation is essential for a homogeneous composite that remains structurally sound under regular handling and use.

With the hemp components prepared, the MCC proceeds to the blending phase, where agar agar and Wheat Starch are introduced as binding agents. The primary binder, agar agar, is initially dissolved to create a viscous solution, activating its adhesive properties. This is achieved by heating the agar agar until it reaches a fluid state, typically between 85° C. and 90° C., where its polysaccharide chains expand and allow it to bond effectively with the cellulose in the hemp fibers and hurd. The molecular structure of agar agar (C₁₂H₁₈O₉ₙ) facilitates strong hydrogen bonds with cellulose, contributing to the durability of the composite while ensuring biodegradability. Simultaneously, Wheat Starch is incorporated into the blend. To achieve optimal results, the MCC should dissolve the Wheat Starch in a separate solution before mixing, as this promotes even dispersion throughout the composite. The amylose and amylopectin chains in Wheat Starch provide additional binding strength, ensuring that the composite remains cohesive and flexible under use. Once dissolved, the Wheat Starch is combined with the agar agar solution, creating a robust binder matrix that enhances the structural integrity of the composite.

### Melt Blending Process for Uniform Distribution

Once the binding agents are prepared, the MCC proceeds with the melt blending process. This involves heating the hemp fiber and hurd along with the agar agar and Wheat Starch solutions to ensure even distribution and a consistent texture throughout the composite. Melt blending is performed at temperatures between 120° C. and 140° C., a range that ensures thorough mixing without degrading the fibers. During this process, the binding agents encapsulate each fiber, resulting in a stable, homogeneous composite material. Temperature control is essential during melt blending, as overheating can damage the fiber structure, while insufficient heat may lead to incomplete binding. Continuous monitoring allows the MCC to maintain optimal viscosity, ensuring the composite is pliable enough for molding but structurally sound for use. The melt blending process also facilitates the formation of micro-pores within the composite, which are essential for the coupling's moisture-absorption capabilities. These pores form naturally as the binders cool around the fibers, creating small capillaries that draw in and retain condensation.

### Quality Control and Material Consistency

After blending the slurry, the composite undergoes quality control checks to verify its consistency and readiness for molding. The MCC should inspect samples for uniform texture, ensuring that the fibers are evenly distributed and that the binding agents have fully encapsulated each fiber. This inspection is essential for preventing weak points in the final composite that could compromise the coupling's performance or compostability. To confirm the composite's structural properties, the MCC conducts tensile and flexural tests on sample batches. These tests assess the composite's resistance to stretching and bending, ensuring that the material can withstand regular handling. Additionally, thermal analysis, using techniques like Differential Scanning calorimetry (DSC), evaluates the composite's stability under heat. These tests confirm that the composite will maintain its form and functionality even in warm or humid conditions, as might be encountered in storage or use. Environmental compliance tests further confirm that the composite meets biodegradability standards. Sample composites are placed in controlled composting environments, where the MCC monitors their decomposition over time. These tests ensure that the material breaks down fully without leaving harmful residues, aligning with the RNC's commitment to sustainable, eco-friendly products.

### Final Preparation for Storage

Once the composite passes quality control, it is prepared for storage to maintain its consistency and performance until molding. Hemp-based composites are sensitive to moisture, so they must be stored in climate-controlled conditions to prevent reabsorption of humidity. The MCC should store the composite in sealed, moisture-resistant containers to preserve its optimal moisture content. Controlled storage conditions help to prevent premature degradation of the binder and fibers, ensuring that each batch retains the desired properties and is ready for efficient molding. Routine checks on storage conditions are advised, as fluctuations in humidity can affect the composite's performance. By maintaining consistent moisture levels, the MCC ensures that the composite will perform predictably across production runs, delivering a reliable, eco-friendly coupling for the RNC.

By following these formulation steps with precision, the MCC can create a compostable coupling composite that meets both the functional requirements and environmental objectives of the RNC. The careful selection and preparation of materials, combined with a meticulous blending process, ensure that the coupling is robust, absorbent, and fully compostable. This formulation process exemplifies the balance of durability and sustainability, producing a high-quality coupling that fulfills the RNC's mission of eco-conscious consumer convenience.

Molding the Configuration of the Compostable Composite of the RNC's Coupling Embodiment

The molding of the compostable composite for the RNC's coupling embodiment requires a carefully controlled process to ensure that the final product achieves the intended structural integrity, moisture absorption, and eco-friendly properties. Each stage is carefully designed to transform the pre-formulated composite into a durable, compostable coupling that meets the dual objectives of functionality and environmental responsibility. The molding process for the RNC coupling may use though is not limited to compression molding due to its efficiency in shaping dense composites while maintaining even distribution of material. Compression molding ensures that the composite retains its structural strength and provides consistent moisture absorption, creating a coupling that functions effectively with cold beverages. This method, executed with precision, allows for the formation of micro-pores within the composite material-essential for capturing condensation while preventing structural compromise.

### Molding Setup and Equipment Preparation

The molding of the RNC coupling begins with setting up the compression molding machine, which is critical for shaping the composite into its final configuration. The MCC should ensure that the mold design meets the specific requirements of the coupling, which include a slightly tapered shape that fits securely around the base of the RNC. The mold should incorporate micro-textures or small pore features to assist in moisture absorption without compromising the composite's integrity. The molding setup and equipment preparation process may include though is not limited to the following: (1) Temperature Settings: Preheat the mold to a temperature range of 150° C. to 180° C. This temperature range activates the binding agents within the composite (agar agar and Wheat Starch) and ensures that they fully encapsulate the hemp fibers and hurd, providing a stable, cohesive structure. The temperature must be carefully controlled to avoid degradation of the hemp fibers, which can lead to brittle or weak areas within the final coupling, (2) Pressure Levels: Set the compression pressure within a range of 500 to 1500 psi. This pressure level is essential for densely compacting the composite material, reducing air pockets, and forming a uniform, structurally sound coupling. The high pressure ensures that the fibers and binder distribute evenly throughout the mold, which is critical for achieving the coupling's strength and consistent thickness, (3) Mold Design: The mold should be configured to incorporate micro-pores, essential for the coupling's moisture absorption capability. These micro-pores form naturally as the binder cools around the fibers in the composite, creating capillaries that draw in condensation. The mold's design should allow for controlled pore formation, ensuring they are small enough to prevent structural weakening but large enough to facilitate efficient condensation absorption. Once the mold setup is complete, the MCC should prepare the composite material by heating it to the appropriate temperature to ensure a smooth flow into the mold cavity. This initial heating is vital for maintaining an even consistency, as any variations in material flow can result in an uneven distribution, compromising the coupling's performance.

### Compression Molding Process

With the composite material and mold prepped, the MCC can proceed with the compression molding process. This phase involves several stages that transform the composite into the coupling's final shape while enhancing the structural integrity and moisture-handling properties essential for its functionality. The compression molding process may include though is not limited to the following: (1) Loading the Composite Material: The pre-formulated composite is loaded into the mold cavity, where it is distributed evenly to ensure consistent thickness across the entire coupling. The MCC must ensure that the material fills the mold cavity completely, as gaps or thin areas can lead to weaknesses in the coupling structure, (2) Initial Compression: Apply an initial compression to the material to begin shaping it within the mold. This preliminary stage allows the composite to settle, filling any micro-cavities within the mold's texture to create a cohesive coupling structure. Initial compression should be applied gradually, avoiding sudden force that could disrupt the even distribution of the composite, (3) Full Compression and Dwell Time: After initial compression, the pressure is increased to the target level (between 500 and 1500 psi), where it is maintained for a dwell time of approximately 2 to 5 minutes. During this dwell time, the combination of heat and pressure compacts the composite material densely, which is essential for creating the coupling's final shape and ensuring durability. The dwell time allows the binder to flow fully around the hemp fibers and hurd, creating a stable matrix that will retain the coupling's shape even under moisture exposure, (4) Pore Formation: As the material cools under compression, micro-pores naturally form within the composite. These micro-pores are critical for the coupling's condensation absorption, acting as capillaries that draw in moisture and trap it within the structure. The MCC should monitor the cooling stage closely to ensure that pore formation occurs uniformly, as inconsistent pore sizes can affect the coupling's overall moisture-handling capability. Thus, the compression molding process, with its combination of heat, pressure, and controlled cooling, results in a dense, uniform coupling that meets the required structural specifications. This method also enables the coupling to retain its shape over time, ensuring reliable performance with each use.

### Cooling and Ejection

Once the compression and dwell time are complete, the coupling must be cooled in a controlled manner to solidify the composite fully and lock in its structural properties. The cooling stage is essential for setting the coupling's final shape and ensuring that the binder's adhesion to the fibers remains intact. Cooling and ejection may include though not be limited to the following; (1) Controlled Cooling: Cool the mold gradually, reducing the temperature to 30° C. to 50° C. over a span of 10 to 20 minutes. Controlled cooling helps to prevent internal stress within the coupling, which could lead to cracking or brittleness. Rapid cooling should be avoided, as it may cause uneven shrinking of the composite material, resulting in a misshapen coupling or compromised structural integrity, (2) Mold Opening and Ejection: Once the coupling has cooled to the target temperature, the mold is opened, and the coupling is carefully ejected. The MCC should use ejection pins or other non-invasive methods to remove the coupling without damaging its structure. Careful ejection is crucial, as hemp composites can exhibit increased brittleness along ejection points if handled too abruptly, (3) Post-Molding Inspection: After ejection, each coupling undergoes a visual inspection to check for defects such as cracks, thin areas, or improper pore distribution. The MCC should also conduct spot checks for dimensional accuracy, confirming that the coupling conforms to the specified measurements. These inspections are essential for maintaining product quality and ensuring that each coupling performs as expected.

### Quality Control and Dimensional Consistency

Ensuring the coupling meets dimensional and functional standards is critical for maintaining the RNC's effectiveness and durability. The MCC should implement rigorous quality control measures throughout the molding process, focusing on consistency in thickness, pore distribution, and overall shape. Quality control and dimensional consistency made include though are not limited to the following; (1) Thickness Consistency: Use calipers or laser measurement tools to verify the coupling's thickness. The uniform thickness across the entire coupling is vital for consistent structural integrity and moisture absorption. Variations in thickness may result in weak points, affecting the coupling's ability to retain condensation or withstand handling, (2) Pore Distribution Check: Inspect the coupling for consistent pore formation across its surface. This can be done through microscopic imaging or cross-sectional analysis of sample couplings. Uniform pore distribution is essential for effective moisture management, as uneven pore sizes or spacing can lead to inconsistent condensation retention, (3) Dimensional Tolerances: Verify that the coupling meets the specified dimensions, with particular attention to the diameter and taper that allows it to fit securely around the base of the cup. Dimensional accuracy ensures that each coupling performs consistently, maintaining the RNC's functional design.

### Final Adjustments and Storage

Following quality inspections, the coupling may undergo minor adjustments if needed to enhance its durability or fit. Once the final configuration is achieved, the MCC should store the couplings in climate-controlled conditions to preserve their moisture balance and structural properties. Final adjustment and storage may include though are limited to the following; (1) Post-Molding Adjustments: If any inconsistencies are noted, the MCC may conduct minor trimming or reshaping to ensure each coupling meets design standards. This could involve smoothing edges or adjusting the fit to align with the RNC's functional requirements, (2) Climate-Controlled Storage: Store the couplings in sealed, moisture-resistant containers within a climate-controlled environment. This precaution prevents moisture reabsorption, which could alter the coupling's dimensions or compromise its compostable properties. Proper storage ensures each coupling maintains its form and functionality until it is ready for final assembly.

By following this molding precisely, the MCC can reliably produce a coupling for the RNC that meets both structural and environmental specifications. The combination of careful compression, controlled cooling, and rigorous quality control creates a coupling that captures condensation efficiently, adheres to compostability standards, and provides users with a high-quality, eco-friendly beverage solution. This molding configuration process aligns with the RNC's goal of sustainable manufacturing, offering a product that supports environmental stewardship while meeting consumer needs.

### (B.2) Formulating the Hemp Plastic Composite and Molding the Embodiment of the Hemp Plastic Cup Configuration of the RNC by Utilizing the Injection Molding Method Formulating the Hemp Plastic Composite

Several methods of molding plastic are available to MCCs. They include though are not limited to the methods of injection molding, blow molding, compression molding and extrusion molding. For the purpose of enabling one who is ordinarily skilled in the field of endeavor of manufacturing plastic cups or hemp plastic cups, throughout this document understood as the MCC, detailed instructions for producing the RNC are provided so the MCC may make and use the RNC without undue experimentation. As ‘injection molding’ is the most common method of manufacture of plastic and hemp plastic cups the manufacture of the RNC herein is set upon the injection method of manufacturing the RNC. The following step-by-step instructions outline and convey the best mode of carrying out the manufacture of the RNC embodiment of the present invention through the entire injection molding process using hemp plastic, covering the equipment, material handling, stages of production, and required operating conditions.

Formulating the hemp plastic composite for the MCC's molded products requires a systematic and carefully controlled process to meet both structural and environmental standards. This process begins with the selection of biodegradable polymers and natural fiber fillers, designed to create a blend that provides durability, flexibility, and sustainability in the end product. As the MCC moves through the composite formulation, the MCC will ensure that each material is selected, prepared, and blended with attention to the unique challenges and specifications of hemp fiber composites. The following contains a step-by-step approach to guide the MCC through creating a reliable and eco-friendly hemp plastic composite. Natural fiber fillers include agar agar, a polysaccharide with the formula (C₁₂H₁₈O₉)ₙ, valued for its binding properties and biodegradability, and Wheat Starch, (C₆H₁₀O₅)ₙ, a strong, compostable binder made of amylose and amylopectin. These enhance cohesion without compromising compostability.

The steps for formulating the hemp plastic composite may include though may not be limited to, (1) Step 1: Material Selection and Ratios The basis of the hemp plastic composite formulation is a balance between biodegradable polymers, such as polylactic acid (PLA) or polycaprolactone (PCL), and natural hemp fibers. PLA and PCL are renewable and biodegradable polymers, providing strength and flexibility that are essential for products like molded cups. PLA, for example, is sourced from renewable resources like corn starch or sugarcane and offers a good degree of stiffness and durability. PCL, on the other hand, is more flexible and has a lower melting temperature, making it suitable for applications where a softer, more pliable end product is desired. The hemp fibers, with high cellulose content (55-72%), also contain hemicellulose (15-25%) for flexibility, lignin (3-5%) for rigidity, and pectin (0.9-1.2%) for bonding. For a reliable balance between strength and case of molding, start with a 30:70 ratio of hemp fibers to PLA or PCL, respectively. This proportion ensures the composite provides enough structural integrity for the final product while still being manageable in the molding process. However, note that adjusting this ratio slightly can affect the properties of the end material. Increasing the fiber content could increase strength but also cause brittleness, while decreasing fiber content may affect both stiffness and eco-friendliness. This starting point will allow the MCC to fine-tune properties based on performance tests or additional product requirements. The hemp fibers, with high cellulose content (55-72%), also contain hemicellulose (15-25%) for flexibility, lignin (3-5%) for rigidity, and pectin (0.9-1.2%) for bonding, 2) Preparing the Hemp Fibers, to ensure that the hemp fibers contribute optimally to the composite's strength and structure, it is essential to prepare them properly. Begin by cutting the hemp fibers to a uniform length, typically between 2 and 5 millimeters. Fibers longer than this can interfere with the flow properties of the composite during the molding process. When the fibers are of consistent length, the mixture will blend more evenly, allowing uniform material flow and reducing potential weak points. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance. After cutting, hemp fibers must be dried to a specific moisture content to prevent steam bubbles or other moisture-related defects during molding. Hemp fibers are hydrophilic, meaning they absorb moisture from the air. Excessive moisture can lead to issues during injection molding, so the MCC should aim to dry the hemp fibers to a moisture content of less than 0.02%. Using a dehumidifying dryer set between 80° C. and 100° C., let the fibers dry for approximately 2 to 4 hours. This step is critical in ensuring the fibers maintain integrity without compromising the final product's quality through warping, voids, or cracks caused by trapped moisture. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance, 3) Polymer Preparation and Palletization, PLA or PCL polymers also need to be carefully managed to ensure a high-quality blend. Like hemp fibers, these polymers should be dried to prevent any excess moisture from introducing defects. Once both the fibers and polymers reach their optimal moisture content, they are ready to be blended. For this, the MCC will employ melt blending, a technique that heats the polymer until it becomes viscous, allowing the hemp fibers to disperse thoroughly. During the melt blending process, pay close attention to the temperature and blending time to avoid fiber degradation and maintain a uniform dispersion. After heating and blending, allow the composite to cool before extruding it into pellets or granules. These pellets streamline the feeding process into the injection molding machine, helping to ensure consistent flow and quality in the final molded product. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance, (4) Incorporating Additives for Enhanced Performance, depending on the desired properties of the final product, the MCC may choose to add plasticizers or coupling agents to the blend. For example, a plasticizer like glycerol can help reduce brittleness of the final product, improving flexibility and user comfort. This can be particularly useful when producing items like cups, where the material must withstand regular handling and pressure without cracking. In addition to plasticizers, coupling agents are useful for enhancing the adhesion between the polymer matrix and the hemp fibers. Coupling agents such as silane or maleic anhydride grafted polymers improve the bond between the hydrophobic PLA/PCL and the hydrophilic hemp fibers. This step is essential for the composite's overall strength, as it minimizes the chance of fiber pull-out under stress, leading to a sturdier product. Use these additives as directed for their specific formulations to avoid imbalance that may affect the final product's consistency and strength. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance, (5) Ensuring Proper Fiber Dispersion, to optimize the composite's performance, the MCC will need to achieve uniform fiber dispersion within the polymer matrix. This requires managing fiber separation to prevent clusters, which could compromise the molded item's integrity by introducing weak points. Processing the blend through a twin-screw extruder will apply both heat and shearing force, aiding in the even separation and dispersion of the hemp fibers within the polymer. Set the extruder to the appropriate temperature range, avoiding excessive heat that could degrade the fibers. With proper control over the heat and shearing, the extruder allows for a smooth, consistent blend, crucial for maintaining quality during injection molding. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance, (6) Conducting Quality Assurance and Testing, before moving on to molding, quality assurance testing is essential to verify that the composite meets the necessary standards. Testing for the Melt Flow Index (MFI) is a reliable way to assess the material's flowability under heat. A high MFI indicates better flow, which is ideal for injection molding, but overly high values could mean the fibers are degrading or separating under the heat. Aim for an MFI that strikes a balance, ensuring smooth mold filling without compromising fiber integrity. Next, perform tensile and flexural tests to confirm the composite's resistance to stretching and bending. These tests will confirm whether the material can withstand the stresses it will encounter in the molded product's end use. In addition, thermal analysis using Differential Scanning calorimetry (DSC) or Thermogravimetric Analysis (TGA) can provide insight into the composite's thermal stability, ensuring the material remains robust under the heat applied during molding, (7) Final Adjustments and Material Storage, with the testing complete and the hemp plastic composite meeting quality standards, take any final steps to address areas where performance can be optimized. This could involve slight adjustments in the polymer-to-fiber ratio, changes in plasticizer levels, or even adjustments to extruder settings to improve fiber dispersion. Once the composite is fully formulated and tested, it is essential to store it in a controlled environment. Hemp fibers are sensitive to humidity, and prolonged exposure can alter the moisture balance achieved during preparation. Store the composite in a humidity-controlled area with minimal exposure to air, and keep it sealed in moisture-resistant containers to preserve the integrity of the material. Proper storage ensures that each batch of composite performs consistently, allowing the MCC to maintain quality across production runs, (8) Preparing for Injection Molding, when the material is ready for molding, ensure that the pellets are introduced to the machine in small, consistent amounts to maintain even heating and flow. The injection molding machine's settings, including temperature and pressure, should match the thermal and flow characteristics of the hemp plastic composite. For PLA-based blends, set the barrel temperature between 160° C. to 220° C., whereas PCL-based composites will require slightly lower temperatures. During the molding process, monitor the temperature, injection speed, and pressure. The injection pressure should typically range between 500 and 1500 psi, ensuring that the material fills the mold evenly without degrading the fibers. This delicate balance of injection speed and pressure is crucial for managing the higher viscosity characteristic of hemp fiber composites, (9) Ongoing quality monitoring, as production proceeds, continues to monitor both the composite material and the molded product. Visual inspections, regular cycle time checks, and periodic tensile or flexural tests will help ensure that the material maintains its desired characteristics. Proper monitoring reduces the likelihood of defects and ensures that each item meets the quality standards set for the hemp plastic composite. By following these comprehensive steps, the MCC can efficiently formulate a high-quality hemp plastic composite that meets structural, environmental, and performance standards. This detailed approach balances the unique properties of hemp fibers with biodegradable polymers, resulting in an eco-friendly material that enhances the durability and sustainability of molded products. The careful attention given to each step-from fiber preparation and polymer blending to testing and storage-ensures the MCC can reliably produce high-performance, environmentally conscious products that meet market demands and reduce environmental impact. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance, 10) Set Up the Injection Molding Machine, once the hemp plastic composite is prepared, the MCC will set up the injection molding machine. The machine should have a clamping force ranging from 100 to 300 tons, depending on the size and thickness of the cups. For larger cups or to increase output, the MCC can use machines with a clamping force of up to 500 tons. The machine consists of two key units: (a) the Injection Unit, where the hemp plastic granules are melted using a reciprocating screw. For PLA-based hemp plastic, the MCC should set the barrel temperature to 160° C. to 220° C. For PCL-based composites, the temperature should be adjusted to a slightly lower range of 160° C. to 180° C. And (b) the Clamping Unit, which secures the mold during injection. The mold, designed for the RNC consists of two halves: the cavity, which forms the outer shape, and the core, which shapes the inside of the cup. It is essential to ensure the mold is correctly fitted and well-maintained to facilitate efficient operations, (11) Load and Inject the Material, with the machine set up, the MCC will load the dried hemp plastic granules into the extruder hopper. The material should be fed evenly into the machine to ensure consistent quality. The reciprocating screw inside the injection unit heats the material to the required molten state. Once the proper consistency is achieved, the molten plastic is ready for injection. The injection pressure should be set between 500 and 1500 psi to ensure smooth flow into the mold without degrading the fibers. The MCC should carefully control the injection speed and pressure to manage the higher viscosity caused by the hemp fibers. At this stage, the molten material is injected into the mold cavity under these controlled conditions. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance, (12) Cooling and Solidification, once the mold is filled with molten hemp plastic, the material cools and solidifies inside the mold cavity. For the RNC's production, mold cooling is a critical process that ensures uniform wall thickness and dimensional accuracy. The mold temperature should be maintained between 30° C. and 50° C. by circulating water or oil through temperature control channels built into the mold. The MCC will note that the cooling time for the hemp plastic cups typically ranges from 20 to 40 seconds, depending on the size and thickness of the cups. Proper cooling is essential to prevent warping or shrinkage in the final product, (13) Ejection of the Molded cups, after cooling, the mold opens, and ejector pins remove the solidified cups from the mold cavity. The MCC should be cautious during this step, as hemp plastic can sometimes be more brittle than traditional plastics, particularly at the ejector points. If the ejection process encounters resistance, the MCC should inspect the mold for buildup caused by the hemp fibers and clean, as necessary. Smooth ejection is vital to preserving the integrity of the finished product. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance, (14) post-processing, following cjection, the RNC may require minimal post-processing. The MCC should inspect each cup for flash, which is the excess material that sometimes forms along the parting line of the mold. Flash should be carefully trimmed away to ensure clean, smooth edges. To further enhance durability, the MCC may apply an annealing process. This involves heating the cups to 70° C. to 90° C. for 15 to 20 minutes to relieve internal stress and strengthen the material. While this step is optional, it is recommended for applications where additional toughness is required, (15) Monitor Production Cycle Times, the entire production cycle for each RNC hemp plastic cup, including material injection, cooling, and ejection, lasts between 30 and 50 seconds. The MCC should adjust machine settings to optimize cycle times based on mold design and material characteristics. This allows the MCC to produce up to 1,200 cups per hour with a single-cavity mold. For higher production output, the MCC can utilize a multi-cavity mold (e.g., a 4-cavity mold), increasing production capacity to up to 4,800 units per hour. Such scaling is an efficient way to boost production while maintaining quality, (16) Maintain Optimal Operating Conditions, for continuous, efficient production of the RNC, the MCC should perform regular maintenance on the injection molding machine, especially when processing hemp plastic. Over time, hemp fibers can accumulate inside the machine's barrel or around the screw, leading to blockages or inconsistencies in the material flow. Routine cleaning and inspection after each production run help prevent these issues. Ensuring that the dryer, hopper, and temperature control systems are functioning properly is also essential for maintaining consistent material quality. Even minor fluctuations in temperature or moisture content can have significant effects on the final product's quality. The hemp fibers, with high cellulose content (55-72%), also contain hemicellulose (15-25%) for flexibility, lignin (3-5%) for rigidity, and pectin (0.9-1.2%) for bonding. Waxes and fats (0.5-1.5%) minimize water absorption, improving moisture resistance, (17) Handling Special Operating Considerations for Hemp Plastic, the MCC should account for the unique properties of hemp plastic during the production of the RNC. Hemp fibers increase the viscosity of the plastic composite, which requires using lower screw speeds and reduced back pressure to avoid excessive shear forces that could degrade the fibers. Fine-tuning the injection parameters is necessary to prevent voids or weak points in the cups. Additionally, the MCC should be vigilant about moisture control, as hemp plastic composites are sensitive to humidity. The material should be stored in a humidity-controlled environment and kept in moisture-resistant containers until ready for use. This precaution helps maintain the material's integrity throughout the production process, and (18) Quality Control and Testing, after producing the RNC, the MCC should implement stringent quality control checks to ensure all products meet the required standards and client requests. The MCC should inspect each cup for warping, shrinkage, cracks, or other deformities, which may indicate cooling or material preparation issues. The cups should also be consistent in size, weight, and wall thickness. Performing strength tests help to verify the durability and structural integrity of the cups under various conditions. The MCC should also ensure color consistency if pigments are used in the hemp plastic composite. Uneven coloring could indicate improper material blending or inconsistencies in temperature control during processing.

### Findings (B.2)

By following this comprehensive method of manufacture, the MCC can efficiently produce high-quality the RNC hemp plastic cups through the injection molding process. Success lies in thorough preparation, precise control over operating conditions, and regular maintenance of the machinery. While handling hemp plastic composites requires special attention to moisture control, fiber distribution, and cooling, the MCC can achieve an elevated level of efficiency and sustainability in production by following the method of manufacture as illustrated herein. Through the injection molding method, the RNC will be formed to address its two primary utilitarian benefits of consumer convenience and eco-conscious sustainability that maintains the quality to the life sustaining elements of the air, water and soil in the sense that it will contribute to a more environmentally responsible future by offering an eco-friendly alternative to traditional plastic cups in light of the compostable nature of the RNC.

To ensure that the RNC consistently meets its performance standards, rigorous quality control processes are conducted by the MCC by utilizing manual and automated systems. Manual quality control may consist of though not be limited to visual inspection, pull tests and spin test and checking for a snug bond between the cup and coupling. Manual quality control checks also supplement automated inspections, with sample batches undergoing real-world testing where cups filled with cold beverages are placed in warm environments to assess the coupling's condensation-absorbing effectiveness. In this instance of the RNC's alternative embodiment option where the cup and coupling are manufactured separately, as a cap and screw configuration, automation and manual quality controls procedures may be utilized to check the proper fitting of the cup and coupling by screwing them together and checking for the same set of quality control as in the preferred embodiment of glueing the cup and coupling together. For this, either or both automated machines and the MCC's manual effort may screw a coupling to a cup and check for a snug fit and test its absorbency quality by filling the RNC with a chilled liquid such as water and placing it in warm environment so that condensation forms on the outer shell of the cup and streams into and is properly absorbed by the coupling. These multi-step quality control measures ensure that each RNC meets the desired standards for both eco-friendliness and performance. Automated systems, such as high-resolution optical sensors and laser measurement technologies, inspect the bond between the cup and coupling, checking for any defects, misalignments, or improper bonding that could affect functionality. These systems verify that the coupling is positioned accurately to capture condensation and that the bond is secure.

### Final Product and Certification

After passing quality control, the MCC prepares the RNC for distribution. Each unit may include compostability certification, in the form of a graphical imprint on the boxing of the CCEs or on the RNC reinforcing its eco-friendly benefits and informing consumers of its recyclability. This certification highlights the RNC's environmental contribution as an alternative to traditional plastic cups, which are often non-recyclable and end up in landfills. By using compostable materials and sustainable production processes, the RNC not only reduces waste but also aligns with growing consumer demand for eco-friendly products. And providing an imprint on the boxing or directly on the RNC coupling or cup embodiment informs the customer of the RNC's recycling benefit at the point of its utilization.

(C.3) Formulating the Modular Hemp Plastic Composite of the RNC's Cap and Screw Configuration and Material Preparation for the Hemp-Based Couple that is Performed By the MCC for the Blow Molding Process and Hemp Fiber and Hurd Sourcing

For the purpose of illustrating the processes of how the MCC can make and use the (RNC), two modular configurations are illustrated herein: (1) Manufacturing processes of threaded structural rib and coupling modularity and (2) Molding the hemp plastic configuration of the RNC's cap and screw configuration. While each of 1 and 2 are illustrated as follows, the illustrations should be understood as representative of the concept of the present invention and its utilitarian purposes. Thus, such illustration should not be considered in a limiting sense though rather in an expansive sense as each of the RNC's embodiments, composites, configurations, and modalities can support variations and permutation of the present invention that may be provided for the principle of specific functional utilities. Each illustration that follows provides further specificity for the objective of enabling one who is ordinarily skilled in the field of endeavor to which the present invention pertains to make and use the RNC in a manner that is consistent the invention's concept.

The MCC first sources the required hemp fibers. In the preferred embodiment the length of the hemp fibers may be (2 mm-4 mm) and hemp hurd (150 microns) though in each instance of fiber and hurd are not limited to such dimensions and may vary in configurations that are not configured to the preferred embodiment. The fibers and hurd would be combined with a suitable biodegradable thermoplastic, such as PLA (Polylactic Acid), PHA, or PBS (Polybutylene Succinate). Next the hemp materials will be blended and compounded with the thermoplastic polymer. This would typically involve mixing the hemp fibers and hurd into the plastic matrix to create a composite material with a specific proportion of hemp (e.g., 30-50% hemp content). Further a compounding process of the hemp fibers, hurd, and polymer are fed into an extruder. In this step, the polymer is melted, and the fibers and hurd are mixed in. This creates a hemp-plastic composite granulate, which is then cooled and pelletized for use in the blow molding process.

### Manufacturing Processes of Threaded Structural Rib and Coupling Modularity

The process of manufacturing the cup for the RNC begins with an injection molding technique similar to traditional bottle manufacturing but adapted to include a threaded structural rib that is comprised of compostable composites and inclusive of though not limited to eco-conscious materials such as hemp plastics, hemp hurd, and fibers. During the molding process, these composites are heated and injected into a mold specifically designed to form the body of the cup along with the threaded section at its base. While the hemp-based composites used in the cup include biodegradable and compostable polymers, ensuring that the entire product can break down leaving a minimum environmental footprint. The threading is precision-molded into the structural rib of the cup, ensuring a snug fit with the coupling when the two embodiments are unified. The inner part of the coupling likewise is threaded during the molding process. Similar to how bottle caps are molded to match the threads of a bottle neck, the coupling's threads are formed precisely to match the cup's structural rib.

Coupling Manufacturing with Threads

The cup's structural rib is crafted to allow for the secure attachment of the coupling via corresponding threads. The creation of these threads is akin to how bottle necks are molded with screw-top capabilities. Precision molds with screw-thread patterns ensure the threads are sturdy enough to handle repeated attachment and detachment without losing structural integrity. The threads are generally formed within the injection mold itself, so there is no additional process required for threading after molding. In a parallel manufacturing process, the coupling for the RNC is also injection molded. The coupling's design is engineered to fit seamlessly onto the cup by screwing onto the threaded section that as well comprises the cup's structural rib. The coupling is made from hemp fiber, hemp hurd, and a natural binding agent such as agar agar or Wheat Starch their chemical formulas are, agar agar (C₁₂H₁₈O₉ₙ) and Wheat Starch (C₆H₁₀O₅ₙ) respectively, which makes the coupling highly absorbent and capable of collecting condensation.

### Creating a Mold for the Coupling

A mold is created through a process known as mold-making, where a negative impression of the desired object is formed in a material that can withstand the molding process. In the case of the coupling for the RNC, the mold would be manufactured using standard mold-making processes. See the following.

### Designing the Mold

The design phase involves creating a 3D model or blueprint of the coupling, see ‘drawings’ section for illustrations of the coupling. Software tools like CAD (Computer-Aided Design) help the designer specify the exact dimensions, including the threading or other attachment mechanisms. Once the design is finalized, the mold material is selected based on the molding process (in this case, molding hemp fiber and hurd). For high-temperature applications, materials like steel or aluminum are typically used, as they can handle the thermal and mechanical stresses that are involved in the molding process. The mold is often machined from the selected material using CNC (Computer Numerical Control) machines. CNC machining uses computer-controlled tools to precisely cut, shape, and finish the mold according to the design specifications. The MCC would then utilize a machining process to ensure the mold has the proper dimensions, surface texture, and features needed for molding the coupling. After machining, the mold undergoes polishing and finishing steps to ensure that the surfaces are smooth. This is especially important as the coupling needs to have a particular surface finish or texture to accommodate the hemp fibers, hurd and binders. The polished mold helps prevent imperfections in the final molded product. Once the mold is completed, it is tested by the MCC by performing trial runs using the intended material (in this case, hemp fiber and hurd and binders). Any adjustments or refinements needed to achieve the desired shape, precision, or functionality are made at this stage. Once the mold reaches a manufacturing readiness state it is then ready to be used in the blow molding or compression molding processes to create the coupling.

Specificity in view of a Blow Molding Process

The hemp composite pellets and binders and mixing agent of water are heated to a specific temperature at which the thermoplastic melts (usually, though not limited to, between 160° C. and 220° C. depending on the polymer). The material is then extruded to form a tube-like structure called a “parison” for the purpose of making a re-form extrusion. The parison is inserted into a mold, and compressed air is blown into it. This inflates the parison to the shape of the mold, forming the desired object, such as a cup or container. Once the material has been blown into the mold, it is cooled, either using air or water, allowing the composite to cool and solidify into the final shape. The hemp fibers and hurd remain embedded in the plastic matrix, providing the cup with added strength and compostability.

Manufacturing of a modular option of the RNC as a thread closure and neck finish

The manufacturing process for the cup and coupling incorporates sustainable methods aligned with the customer convenience and eco-conscious goals of the RNC. The MCC will produce these components individually, focusing on ensuring a precise threaded closure system between the cup and coupling. This procedure will ensure a secure and leak-proof attachment, utilizing technical standards found in bottle and cap design and that are familiar to one who is ordinarily skilled in the art of endeavor to which the present invention pertains.

### Cup Manufacturing Process

As illustrated herein with the manufacturing process of the non-modular RNC, the MCC will select eco-friendly composite materials, primarily hemp plastic mixed with hemp hurd and hemp fibers, to ensure a durable yet lightweight cup. This material composition optimizes strength and structural integrity, while keeping the cup light enough for user convenience and cost-effective production. And the MCC will select hemp plastic, reinforced with biodegradable polymers such as PLA (Polylactic Acid) or PHA (Polyhydroxyalkanoates), to ensure compostability and structural stability. The inclusion of hemp hurd adds rigidity, and hemp fibers will contribute to tensile strength and increase structural integrity of the RNC by reducing risks of warping or cracking during production and use.

### Cup Molding and Threaded Closure Design

The MCC will mold the RNC by using injection or as mentioned above, blow molding techniques, depending on the desired thickness, ranging though not limited to 0.04 cm to 0.64 cm. The threaded closure system will be carefully integrated into the lower portion of the cup's structural rib, using external threads that are fabricated according to the T Dimension, the outer diameter measured across the threads. The thread profile follows a standard “V” shape, optimized for smooth screwing action. Additional key dimensions for the purpose of enabling the MCC to make and utilize the RNC with further dimensions that are illustrated as follows. They are, the E Dimension, the outer diameter of the neck, excluding the threads, where the threads begin. The S Dimension, the distance from the top of the cup's neck to the top-most thread, ensuring an ideal starting point for screwing. And the L Dimension, the total height of the finish, which accommodates all threads for secure attachment. The MCC will utilize these dimensions to ensure precision in thread design, considering thread pitch, the distance between adjacent threads and thread lead the advance of the coupling per rotation. A tighter pitch provides a more secure fit, while a controlled lead ensures smooth attachment with each turn both of which will be determined by the utility of the specific RNC. After molding, optical or laser measurement systems verify the uniformity and accuracy of the threads.

Steps for making the Cup Molding and Threaded Closure

The steps for making the cup molding and threaded closure design may include though not limited to, (1) Pre-Heating and Plasticization: Prior to molding, the hemp-plastic composite pellets are fed into an extruder, where they are pre-heated and plasticized. This process involves heating the pellets to a specific temperature where the composite material softens and becomes pliable, ready for injection. This stage ensures that the material flows uniformly into the mold without any obstructions, reducing the risk of defects in the final product, (2) Injection and Filling Phase: In this step, the plasticized material is injected into the mold cavity under high pressure. The mold cavity, designed specifically for the RNC, includes detailed threading for the structural rib. During this phase, the injection process fills every contour of the mold, particularly focusing on achieving the precise threading and thickness required for the structural integrity of the cup. This ensures that each cup has a consistent shape, strength, and thread alignment, (3) Cooling and Solidification: Once the mold cavity is completely filled, the material undergoes a cooling process. In this phase, water- or air-cooling channels within the mold facilitate rapid cooling, allowing the composite material to solidify and take on its final shape. This controlled cooling minimizes warping or shrinkage, preserving the structural accuracy of the threads and the overall geometry of the cup, (4) De-Molding and Quality Inspection: After the cup has cooled and solidified, it is ejected from the mold using an ejector system. Each cup is then inspected for dimensional accuracy, particularly focusing on thread pitch, lead, and depth using precision measurement tools like calipers or laser scanners. This inspection verifies that the cup will securely and consistently pair with its coupling component, maintaining the ergonomic and eco-conscious design integrity of the RNC, and (5) to certify a snug fit the MCC will utilize compression or vacuum molding, as the coupling will be shaped with internal threads that precisely match the external threads on the cup. The MCC will ensure that the thread profile, pitch, and lead are aligned to create a tight, leak-proof fit, matching the cup's T and E dimensions. These threads are shaped to a standard thread angle, ensuring a secure seal between the components. Then, after molding, the coupling undergoes a curing process in infrared or hot-air ovens to reach optimal moisture content for efficient condensation absorption. Quality checks ensure both absorption capacity and thread alignment. The H Dimension, the neck height from the top to the shoulder, is also verified to maintain structural integrity.

### Modular Option for Assembly During Manufacture or Post Manufacture

For the purpose of enhancing the RNC's utilitarian versatility it be manufactured as a unified apparatus, with the cup and coupling pre-assembled during the manufacturing process. This option allows manufacturers to provide an all-in-one product that is ready for use upon delivery. After both the up and coupling are separately molded, they can be screwed together at the manufacturing site; during manufacture stage assembly. The assembly involves using machines that align the cup and coupling, allowing the threaded section of the cup to securely attach to the threaded interior of the coupling. This method ensures that the coupling is firmly in place and ready to perform its condensation-collecting utility from the moment the customer receives the product. In this pre-assembled format, the RNC is shipped as a fully unified unit. This approach is ideal for clients who prefer to provide customers with a fully assembled product that is both ergonomic and eco-friendly. For instance, cafes, restaurants, and other venues may find such versatility is advantageous and receive the RNC pre-assembled, ensuring convenience for both the business and its customers. The configurable (RNC) is drawn up with versatile assembly options, tailored to meet the unique requirements of diverse clients and environments. This modular approach allows the cup and coupling to either be assembled during manufacturing or delivered as separate components, ready for on-demand assembly at the point of use. These options provide flexibility and eco-conscious benefits, aligning with the MCC's commitment to sustainable manufacturing and user convenience.

Assembly During Manufacturing as per the above

For clients operating in high-humidity environments or serving cold beverages where condensation is frequent, the RNC can be pre-assembled at the manufacturing stage. This option ensures that the product arrives as a fully integrated, ready-to-use unit, ideal for applications such as cafes, restaurants, or other service venues. The MCC employs advanced precision machinery to align the cup and coupling, allowing the threaded section of the cup to securely attach to the coupling's threaded interior. This attachment is further reinforced by an industry-standard threading system, which guarantees compatibility in neck finish and closure. The thread pitch and lead are carefully calibrated to create a secure, leak-proof seal, making the RNC both reliable and durable. The assembly process includes rigorous quality assurance measures. For instance, laser or optical systems may be used to verify proper alignment of the threads and the tightness of the closure, ensuring that every unit meets exacting standards for functionality and longevity. Additional design features may include a tamper-evident band that breaks upon first use, offering users a visible indication of product integrity and safety. The coupling's cap skirt, which houses the internal threads, contributes to the unit's structural integrity, while knurling along the exterior skirt improves grip, enhancing user case when detaching or reattaching the coupling. This pre-assembled configuration provides clients with a turnkey solution that is ergonomic, eco-friendly, and optimized for immediate use, reducing setup time and simplifying customer experience.

Assembly at the point of use

For clients who may not need the condensation-absorbing capability at all times, the RNC can be supplied as separate cup and coupling components as a manual and/or mechanical ‘snap-on’ built-in features like ridges, grooves, tabs, or flexible protrusions. A snap-on configuration is designed to be quick, secure, and sometimes reversible. Such snap-on feature would provide for one or both parts, the coupling, and/or the cup to temporarily flex to allow the connection, then return to their original shape to lock together. As employees or customers would snap the RNC to the cup no tools would be required as the connection is usually made by hand, without adhesives, or fasteners and utilizes frictional engagement to hold the RNC onto the cup. An audible/tactile feedback “swish” or “click” when the parts snap into place indicates proper engagement. This on-demand assembly option is ideal for scenarios where condensation issues are seasonal or variable, such as in regions with moderate climates or venues where beverages are served at different temperatures depending on the season. When conditions warrant, the user can quickly attach the coupling to the cup, transforming it into a fully functional condensation-absorbing unit. This versatility allows businesses to save on material use and manage inventory efficiently, as the coupling only needs to be deployed when necessary.

Alternatively, a cap and screw configuration or modality of the RNC attaching the RNC to a cup enables easy assembly at the process as it is as simple as screwing a cap onto a bottle; it requires no tools and can be completed by users or staff in seconds. The ergonomic design ensures that the coupling can be securely and swiftly screwed onto the cup, with the S Dimension and thread-start positioned for ease of use. This design also incorporates a thread angle and lead that provides smooth, intuitive action when attaching the coupling. Inside, a liner helps create a tight seal to prevent leaks, further enhancing functionality. This user-friendly assembly method enables clients, such as restaurants, to quickly equip customers with the condensation-absorbing functionality when needed, adding a level of flexibility and customization to their service. Therefore, and contingent on client preferences, the MCC will provide flexibility in assembling the cup and coupling. These components can be assembled during or post manufacture and therefore be manufactured individually to allow for assembly at the point of use depending on the environmental conditions. In humid climates, or when cold beverages are often expected to create condensation, the client may request that the RNC be assembled during manufacture and shipped to the client. Thus, the MCC will assemble the cup and coupling during manufacture.

The MCC may use automated systems that use precision machinery to screw the coupling onto the cup's threads. The threading system follows industry standards for neck finish and closure finish compatibility, ensuring the thread pitch and lead create a secure, leak-proof seal. This pre-assembled system undergoes rigorous quality checks, using laser or optical systems to confirm proper thread alignment and closure tightness. Additional elements such as a tamper-evident band may be included, breaking upon first use to indicate whether the assembly has been tampered with. The cap's skirt, which houses the internal threads, provides added strength in terms of structural integrity, and knurling along the exterior skirt of the RNC enhances grip for users when detaching or reattaching the coupling.

### Extended Points of Use and Anticipation of Composites

The following paragraph illustrates points of use that extend beyond the restaurants, cafes, and the like. In doing so, and as manufacturers receive and process orders for the RNC or any of its renditions that are illustrated herein, certain data sets are captured, including though not limited to volumes of production, place of production, areas of distribution from and to, and types of establishments. As a key element of efficient and effective system design pertains to anticipating activity within the system, the data that is captured can inform downstream waste and recycling facilities about expectant composites. Thus an additive element of the present invention is to incorporate the potential of inclusion of such captured data into the digital imaging and composite data that is uploaded into the storage of the NCBS such that it may be transmitted through the network of the NCBS and then forwarded to the waste and recycling facilities for the purposes of synchronizing their respective computerized systems; manufacturer, place of deployment which also contains networked computerized and waste and recycling facilities, for the purpose of preparing the waste and recycling facilities computerized robotic machines and collection bins in advance of the arrival of the anticipated composites and streamlining the concept of the invention's full-loop.

Points of use may extend beyond restaurants, cafes and the like and may include though not be limited to domestic homes, school cafeterias, stadiums, sports venues, food trucks and gymnasiums. As such, and predicated upon the type of point of use, the RNCs may be packaged and shipped to match the needs of the point of use place. For example, while large chain beverage serving companies may be supplied from restaurant supply depots in bulk containers with tens of thousands of RNCs during a single shipment, other places such as supermarkets may have the RNCs packaged in cylindrical containers containing volumes of one hundred or so. In this case, the volume will match a supermarket's patron as the patron is often purchasing food and consumer staples for their home. In the same spirit school cafeterias, stadiums, sports venues, food trucks and gymnasiums will have access to volumes of RNCs that match their respective needs.

### Further Specificity, Assembly at the Point of Use Whereas the Cup and Coupling are Provided Separately

In cases where condensation is variable, minimal, or relatively absent during certain periods of the year, the cup and coupling can be supplied to the client independently. The client, depending upon current ambient conditions, whether wet or dry, can attach the coupling when needed, such as in warmer weather or with cold beverages. The assembly is designed to be as simple and intuitive as screwing a bottle cap onto a bottle, with the S Dimension, thread start, providing case of use. The ergonomic of the RNC's configuration ensures that the coupling can be screwed on securely and swiftly. The thread angle and lead will provide smooth action when turning, while the liner inside the coupling helps create a tight seal, preventing leaks. This versatility not only enhances customer convenience but also reduces unnecessary material use when the coupling is not required. By offering a flexible and adaptable assembly process, the MCC ensures that the RNC meets varying client needs while maintaining eco-conscious values. Whether assembled during manufacturing or at the point of use the RNC provides its functional utilities of enhancing customer experience and promoting environmental sustainability. As such, every step of the process, from material selection to final assembly, is optimized for both functionality and eco-friendliness. Alternatively, as in order to further illustrated the above configurations either a snap-on it or cap and screw fit, and though still considered herein as a unified apparatus, the RNC can be delivered as two separate components, giving users the on-demand versatility to decide when and where to assemble the product. In this option, the cup and coupling are manufactured separately, with the assembly occurring either just before or during the use of the cup. For example, in a restaurant setting, a cold beverage may be served without a coupling on cooler days when condensation is minimal. The restaurant can offer the basic cup without the coupling to save costs. On warmer days, when condensation becomes a more pressing issue, the restaurant can quickly screw the coupling onto the cup, providing the customer with the full benefit of the RNC's condensation-absorbing capabilities. Similarly, the consumer also has the versatility to attach the coupling to the cup at the place of usage. Cups and couplings will be readily available for employees or customers to assemble. The process of doing so is familiar, intuitive, and user-friendly, much like attaching a bottle cap to a bottle. The coupling can be easily screwed onto the cup manually and without any special tools or equipment as doing so on average requires a torsional force between 1.0 to 3.0 Nm (Newton-meters) which is generally the same torsional force to screw a common bottle cap on. This provides end users, restaurants, and patrons alike, with the convenience of choosing whether they want to use the coupling, based on the specific conditions and their preference.

### Environmental and Economic Benefits of Modular Assembly

The enhanced versatility to assemble the RNC at the point of use offers significant ergonomic and economic advantages for clients and end users alike. The modular nature of the configuration means that businesses can control inventory and manage costs by only providing the coupling when necessary, reducing waste and extending the lifecycle of the product. As such, businesses, such as cafes and restaurants, can provide the RNC in its singular configuration, just the cup, on cooler days. This not only reduces the cost of using the full apparatus when not necessary but also minimizes waste. When condensation becomes an issue, the coupling can easily be added, restoring the full functionality of the RNC. The modular design of the RNC is not only practical but also promotes sustainable consumption practices, allowing clients to adjust their usage based on specific conditions. By choosing when to attach the coupling, businesses reduce unnecessary material use, thereby minimizing waste and supporting environmentally friendly practices. Both the cup and coupling are compostable, ensuring that even when the coupling is used, the entire apparatus remains eco-friendly. This configuration helps to reduce plastic waste, contributing positively to the preservation of air, water, and soil quality. In terms of cost-effectiveness, the flexibility to assemble at the point of use allows businesses to control inventory more efficiently. For example, on cooler days when condensation is less likely, cafes and restaurants can offer customers the basic cup without the coupling, reducing costs. On warmer days or in high-humidity environments, they can quickly add the coupling to meet customer needs, restoring the full functionality of the RNC. This adaptability extends the lifecycle of the product and enhances customer satisfaction by providing options that are tailored to real-world conditions.

### Findings (C.3)

Whether assembled during manufacture or post manufacture at the point of use, the RNC's modular configurability provides clients with an efficient, versatile, and eco-conscious solution. The configurations are optimized for both functionality and sustainability, with each embodiment engineered to enhance customer convenience while reducing environmental impact. By offering an adaptable assembly process, the RNC supports sustainable practices, customer comfort and convenience, and the flexibility businesses need to meet variable demands. This approach ensures that the RNC aligns with modern values of environmental stewardship and cost-efficient, practical solutions, making it a valuable asset in service settings. This modularity versatility further contributes to environmental preservation. By giving customers and businesses the option to use only what is necessary, the RNC promotes sustainable consumption practices. Both the cup and coupling are compostable, ensuring that even when the coupling is added, the entire apparatus remains eco-friendly, reducing plastic waste and helping to preserve the life-sustaining elements of air, water, and soil.

Manufacture by a POSITA via Three-dimensional, (3D) printing

Regularly, when those ordinally skilled are presented with a project, a plan is created. Such plan may include though not be limited to; selecting material composites and an aerated binding agent, equipment, and power sources, and working on sets of logistics within the understanding that an amount of general experimentation and production tests may possibly be involved. For the principle of demonstrating to one ordinarily skilled in the art of the production of recyclable tableware a procedure, technique, or way of doing something, especially in accordance with a definite plan it is herein noted that the are numerous methods to produce recyclable tableware. Among methods to produce common recyclable tableware are diverse types of machinery, computerized and/or manually managed, for production runs. Such methods may include though not be limited to injection molding; Computer Numerical Control (CNC) Machining, Polymer Casting, Rotational Molding, Vacuum Forming, Injection Molding, Extrusion, Blow Molding, Die Cutting, Three-dimensional printing (3D), of the aforementioned methods.

In order to enable one ordinarily skilled in the art of the present invention the inventor of the present invention provides at least one method, immediately following, that illustrates how to make and use the present invention's claims. As there are a vast array of production processes and sets and groupings thereof, the inventor of the present invention provides one (1) production method, 3D printing for the objectives of enablement requirements. As such, the inventor of the present points out that there are multiple methods of manufacturing disposable tableware from composites, for instance though not limited to; die cutting, stamping, form-fitting, and extrusion methods and that contain capacity to manufacture disposable tableware. To satisfy enablement requirements and simultaneously provide efficiency in relation to how the present invention may be manufactured by one ordinarily skilled in the art of manufacture of disposable tableware, the inventor of the present invention elects one (1) production method as mentioned above, three-dimensional printing, (3D printing) to illustrate to one ordinarily skilled in the craft of manufacture of disposable tableware how to manufacture the present invention, a EC, as disclosed herein.

Three-dimensional printing is an additive manufacturing process that creates a physical object from a digital design from a composite such as though not limited to hemp pulp or hemp filament for topology optimization. The process works by laying down thin layers of material in the form of liquid or powdered plastic, metal or cement, or in view of the present invention's preferred composite, hemp fibers, which have been minced and blended into pulp of consistencies that are variously concentrated and printed into various portions of the composite of the RNC and with a form-fitting shape that is held fast by a water permeable and pliable aerated binding agent.

### Steps in Relation to how to Manufacture the Present Invention Via 3D Printing.

3D printing of ECs involves at least, though not limited to the following production steps: Step 1, select at least one 3D computerized printer that is suitable for printing disposable tableware from at least the composite of hemp. Situate, power on and warm up the 3D printer in a print production facility. Step 2, create a computerized digital design for at least one RNC in accordance with the parameters of at least one LCC via a ‘stereolithography’, (STL) file, a file format commonly used for 3D printing and computer-aided design (CAD). Step 3, if required, export the STL file to a computer readable medium that will perform the function of the STL. Step 4, choose composite(s), in the preferred embodiment, hemp, though not limited to hemp. Step 5, prepare hemp fiber shives into micro-hurd together with a water permeable and pliable aerated binding agent for retaining the EC's shape post 3D printing by mixing it in a soluble additive such as water to make pulp, and check for texture, consistency, density, and temperature that is applicable for 3D printing. Step 6, choose parameters in relation to criteria, specifications, and tolerances for the function of form-fitting at least one PC to at least one EC through measurable factor forming as defined by a system or sets of conditions for the purpose of performing the operation of three dimensionally printing at least one EC that form fits at least one LCC. Step 7, create a Gcode, (also known as RS-274) a prevalent programming language for Computer Numerical Control (CNC) in computer-aided design and manufacturing (CAD/CAM). G-code provides metric-based numeric control of CAM-controlled equipment such as CNC 3D printers in relation to step 5. Step 8, 3D print at least one RNC as a prototype print, provide ambient drying time, and or utilize a drying oven to dry the RNC then check it with at least one PC to see that it contours securely, and is unable to be removed by general human efforts, within the interior cabin of at least one LCC by utilizing an adhesive and/or by tolerances of snug form fitting, and or by shrinking it through completed drying when it is affixed to at least one PC and refine the design via computerized programming as necessary. Step 9, print at least one more EC and provide drying time, complete or incomplete predicated on step 10, (see step 10) through utilization of ambient air drying and/or a drying oven to dry the RNC, completely or incompletely as predicated by step 10. Step 10, check for proper form fitting of at least one, the most current, PC within the interior cabin of the EC. Step 11, when all of the above meet criteria, specifications and tolerances, 3D print at least one EC, provide for complete drying, curing, and adhere the lower section of the sidewall of at least one PC by utilizing an adhesive and/or by tolerances of snug form fitting, or by shrinking it through completed curing. Step 12, when at least one PC is satisfactorily produced and form-fitted onto at least one EC as per previous steps, perform general experiments and evaluate it by placing a pool of water upon a dry surface (pre-wetting) and checking for proper capillary action, absorbency, expansion and water stowing within the EC's reservoir region and the term, “Recycle” and/or emblem that is imprinted upon the outer shell of the EC via tampography (see Tampography printing) is animating the Recycle message upon the outer shell of the EC as the stowed water in the RNC's reservoir region comes into contact with the water activated ink and that the invisible recycle message is being animated from invisible to visible. Step 13, where and if necessary, refine the steps above step 12, until step 12 is optimized accordingly to meet the functional intentions of the RNC; to maintain a dry surface and/or dry a pre-wet surface and to animate a recycle message from invisible to visible. Step 14, power down, clean and store the 3D printer(s).

### Hydro-Chromatic Ink Printing Upon Outer Shell of the EC

One ordinarily skilled in the art of ink printing would be aware that there are numerous types of inks, surfaces, and machinery in the form of printing machines that may be applied to print with ink. Among the types of ink available are though not limited to hydro-activated inks, pigmented inks, dye-based inks, sublimation inks, and solvent inks of varying opacities. The surfaces that the aforementioned inks may be printed upon may include though not be limited to hemp, paper, plastics, and textiles. The types of printing machines may include though not be limited to, pad printing (also called tampography), digital (inkjet) printers, screen printers, flexographic printing, offset printers, and rotogravure printing machines.

### In Relation to Hydro Chromatic or Hydro Activated Ink Printing Upon the Hemp Composite of the Outer Shell of the RNC, the Printing Process May be Accomplished by the Following Procedure.

As the shape of the EC is a non-flat surface the preferred manner of printing upon the surface of the hemp composite of the EC is ‘tampography’, a printing process that can transfer a 2D image onto a 3D object (e.g., a EC) and is accomplished using an indirect offset (gravurc) printing process involving an image, in the present instance, the term, ‘Recycle and/or emblem’, being transferred from a pad onto a substrate, in the present instance, the hemp composite of the RNC onto a specified place on the outer shell of the EC. Though the method by which the printing process may be achieved can be modified by the printing artisan. The steps by which the tampography printing with hydro-activated ink are; Step 1 select a tampography machine and printing facility that are adequately equipped for printing hydro-activated ink upon the surface of the hemp composite. Step 2 engrave the image as ‘Recycle’ (and/or emblem) onto the tampography printing machine's printing plate. Step 3 select an opaque hydro-activated ink coloration, in the preferred embodiment ‘earth green’ though a full spectrum of colors are available, inclusive of assorted colors to print from in a print run, to the printing artisan. Step 4 power on the tampography printing machine and rotate it to the home position where its closed or sealed ink cup rests over the etched or engraved artwork area of the pad printing plate, cover the image by filling it with the earth green ink. Step 5 activate the tampography printing machine so its closed ink cup moves away from the engraved artwork area and takes all excess ink and exposes the engraved image, and allow it to become exposed to air so its top layer of ink becomes tacky as soon as it is exposed to the air so it can adhere to the transfer pad of the tampography printing machine and later, during print rotational cycling, to the hemp composite of the EC. Step 6 Allow the transfer pad to press downwards onto the printing plate momentarily as it will compress the pad and push air outward and cause the ink to lift and transfer from the engraved image, (Recycle word and/or emblem) area onto the pad. Step (7) Allow the tampography printing machine to cycle so as the transfer pad lifts away, the tacky ink film inside the engraved artwork area is picked up on the tampography printing machine's pad so a modest quantity of ink remains in the tampography printing machine's pad printing plate. Step (8) when the tampography printing machine is cycling and the transfer pad moves forward, the ink cup also moves to cover the engraved artwork area on the printing plate where the tampography printing machine's ink cup will again fill the engraved ‘Recycle’ and/or emblem's image on the plate with the earth green ink in arrangement for the tampography printing machine's next printing cycle upon the hemp composite of the EC's outer shell. Step 9 Allow the tampography printing machine to continue to cycle until its transfer pad compresses down onto the surface of the hemp composite of the EC's outer shell so it may transfer the earth green coloration layer of ink picked up from the printing plate to the EC's hemp composite surface. When the tampography printing machine's printing pad lifts off the EC's hemp composite, it has then applied the ‘Recycle’ word and/or emblem and returns to the home position, hence conducting at least one print cycle of the ‘Recycle’ word and/or emblem upon the surface of the hemp composite of the EC. Step 11 the artisan will provide sufficient drying time for the hydro activated ink upon the hemp composite surface of the EC to fully cure.

### Ink Base

The hydro activated ink's base may be comprised of though not limited to purified water, propylene glycol, or one or more of the following: sodium benzoate, citric acid, methyl paraben or propyl paraben. Each of these bases are common in regularly consumed foods such as carbohydrates, sodium, and food colorings.

### Biodegradable Compostable Pliable Waterproof Translucent Laminating Membrane

Ink is a liquid substance when in fluid form. For the goal of maintaining the structural integrity of the ink after it is imprinted upon the outer shell of the EC, and so it does not transfer from its surface to another, a biodegradable compostable pliable waterproof translucent laminating membrane may be applied, post printing, as an overlay upon the recycling narrative. The composite of the membrane may include though not be limited to beeswax, bioplastics that are manufactured from parts of plants such as sugarcane, eucalyptus, and cassava root.

### DETAILED DESCRIPTION OF SEVERAL VIEWS OF THE DRAWINGS

1) FIG. 1 illustrates a single use plastic cup (1) with and the recess of its integrally formed subjacent structural rib (111).

2) FIG. 2 illustrates an aerial view of a substantially horizontal planar surface (2) of a beverage serving establishment. The surface (2) pertains to a table, shelf, bar top, center console, serving area, or any such surface (2) whereupon beverages are placed in a beverage serving establishment such as though not limited to, restaurants, bars, bakeries, snack shops, and sidewalk cafes.

3) FIG. 3 illustrates a substantially horizontal planar surface (2) of a beverage serving establishment. In the present instance the substantially planar surface (2) is a table at a restaurant that is set with LCC's, (76) cutlery (34) and plates. The surface (2) pertains, shelves, bar tops, center consoles, serving areas, or any such surface (2) whereupon beverages are placed in a beverage serving establishments such as though not limited to, restaurants, bars, bakeries, snack shops, and sidewalk cafes and be set accordingly.

4) FIG. 4 illustrates the Liquid Carrying Container, LCC (76) or cup (1) without an RNC (77). The LCC (76) is presently filled with a volumetric of liquid, in the present instance, water (33). The water (33) is chilled to forty-four degrees Fahrenheit, (44° F.) (35). The temperature of the water (33) keeps the water (33) in a fluid state. The aggregate of the LCC (76) is comprised of though not limited to translucent plasticenes. Other composites may include non-translucent plasticenes, translucent or non-translucent glass, Styrofoam, or paper-based composites. The ambient temperature (26) that the LCC (76) is placed within is eighty-one degrees Fahrenheit, (81° F.) (26). The variance of temperatures between the water (33) and ambient temperature (26) that the LCC (76) is placed within is causing condensation droplets (8) to form on the sidewall (56) of the LCC (76). The condensation droplets (8) are being pulled substantially downward (37) on LCC's (76) sidewall (56) through the effect of a gravitational field (59) and pooling (10) upon the surface (2) that the LCC (76) is placed upon.

5) FIG. 5 illustrates an ensemble (38) of a Liquid Carrying Container LCC (76) or cup (1), and a Recycle Narrating Coupling, (LCC (76)/RNC (77)) residing with the recess of subjacent structural rib (111) of the LCC (76) and the surface (2) that the RNC (77) is placed upon. The RNC (77) has been form-fitted to accompany the LCC (76) as an ensemble (38) upon a substantially lower portion of the RNC (77). The LCC (76) is presently filled with a volumetric of liquid, in the present instance, water (33). The water (33) is chilled to thirty-four degrees Fahrenheit, (34° F.), and whereas the water's (33) temperature keeps the water (33) in a fluid state. The composite (74) of the LCC (76) is comprised of translucent plasticene. In practice the LCC's (76) composite (74) may be comprised of though not limited to translucent plasticenes and further composites may include non-translucent plasticenes, translucent or opaque glass, Styrofoam, or paper-based composites. The ambient temperature that the LCC (76) is placed within is eighty-one degrees Fahrenheit, (81° F.). The variance of temperatures between the water (33) and ambient temperature that the LCC (76) is placed within it is causing condensation droplets (8) to form on the sidewall (56) of the LCC (76) in view of the process of condensation formation. The condensation droplets (8) are being pulled substantially downward (37) on the LCC's (76) sidewall (56) through the effect of a gravitational field (37) and are being absorbed (11) by the highly hydrophilic composite (74), in the preferred embodiment, hemp (12), of the RNC (77) and are being stowed (29) in the reservoir region (51) of the RNC (77). The RNC's (77) reservoir region (51) has expanded (15) on account of the volumetric of water (33) that is being stowed (29) within it. The surface (2) that the LCC (76) is placed upon remains dry in light of the function of the RNC (77).

6) FIG. 6 illustrates a view of the substantially planar undercarriage (7) of the RNC (77).

7) FIG. 7 illustrates an aerial view of the interior cabin (49) of the RNC (77).

8) FIG. 8 illustrates a detail of a condensation droplet (8) that has formed on the sidewall (56) of a LCC (76) and is being drawn downward (37) by a gravitational field (59).

9) FIG. 9 illustrates a detail of a condensation droplet (8) that has been drawn downward (37) on the sidewall (56) of the LCC (76) by a gravitational field (59) and is being absorbed (11), as illustrated by the intermittent line (41) by the composite (74) of the RNC (77).

10) FIG. 10 illustrates a pool of water (33) on a surface (2) as a result of condensation droplets (8) emanating from the sidewall (56) of an LCC (76) and being drawn downward (37) to a surface (2) by a gravitational field (59).

11) FIG. 11 illustrates a pool of water (33) on a surface (2) as a result of condensation droplets (8) emanating from the sidewall (56) of an LCC (76) and being drawn downward (37) to a surface (2) by a gravitational field (37) and that is being absorbed (11) by a RNC (77) that is being manually governed (31) as illustrated by the intermittent line (41).

12) FIG. 12 illustrates hemp (12) fibers particles in micro-hurd pulp that are utilized in the preferred embodiment of the composite (74) of the RNC (77).

13) FIG. 13 illustrates an operative three-dimensional (3D) printer (13) in the process of printing a RNC (77) from aerated hemp (12) fibers particles in micro-hurd pulp. The 3D printer is located in a printing facility (43) and is connected to a power source (44) and contains a volume of micro-hurd particle hemp (12) pulp with an aerated binding agent (30). The 3D printer (13) is computerized (42), and it has been programmed to print RNCs (77) and is presently printing one RNC (77).

14) FIG. 14 illustrates a detailed view of an ensemble (38) of a cup (1) or LCC (76)/RNC (77) with the LCC (76) being securely form fitted into the interior cabin (49) of the RNC (77). The LCC (76) is empty (1) and the RNC (77) unexpanded (14).

15) FIG. 15 illustrates a detailed view of an ensemble (38) of a cup (1) or LCC/RNC (77) with the LCC (76) being securely form fitted into the interior cabin (49) of the RNC (77). The LCC (76) presently contains chilled (44° F.) (35) water (33) and is in a warm atmosphere of (88° F.) (36). Condensation droplets (8) formed and were drawn downward (37) on the sidewall (56) of the LCC (76) by a gravitational field (59) and have been absorbed (11) by the composite (74) of the RNC (77) that is expanded (15) in light of the water (33) being stowed (29) in the reservoir region's (51) substantially vertical outer shell (57) of the RNC (77). 16) FIG. 16 illustrates a cross-sectional view of an unexpanded (14) RNC (77) with its interior cabin (49), upper rim (40), center section (45) and capillaries (19). The RNC's (77) interior cabin (49) is shaped to securely accommodate a substantially lower portion of an LCC (76).

17) FIG. 17 illustrates a cross-sectional view of an expanded (15) RNC (77) with its center section (45), interior cabin (49) and capillaries (19). The composite (74) of the RNC (77) is expanded (15) in light of water (33) being stowed (29) in the reservoir region (51)'s substantially vertical outer shell (57) of the RNC (77).

18) FIG. 18 illustrates an aerial view of the interior cabin (49) of the RNC (77) with its center section (45), and the capillaries (19) that are embedded in the substantially planar undercarriage (7) of the RNC (77) within the ply (46) of the RNC's (77) composite (74).

19) FIG. 19 illustrates a liquid conveying capillary (19). The liquid conveying capillary (19) is embedded within the ply's (46) dimension, it has a hallow core (52), and has orifices on its inlet (27) at the border of the center section of the RNC (77) and its outlet (28) where it is truncated within the RNC's (77) substantially vertical outer shell (57).

20) FIG. 20 illustrates a cross-sectional view of the RNC's (77) substantially planar undercarriage (7), its substantially vertical outer shell (57), liquid conveying capillaries (19), water (33), and the hemp (12) that comprises the composite (74) of the RNC (77). Through the vacuuming effect of the RNC's (77) substantially vertical outer shell (57) that is induced by it expanding (15) water (33) is entering into the liquid conveying capillary (19) and being conveyed through the liquid conveying capillary (19) in the direction (50) of the liquid conveying capillary's (19) outlet (28). Through the vacuuming effect of the RNC's (77) substantially vertical outer shell (57) that is induced by it expanding (15) water (33) is being has been conveyed through the liquid conveying capillary (19) in the direction (50) of the liquid conveying capillary's (19) outlet (28) and is jettisoning from the liquid conveying capillary's (19) outlet (28) and into the substantially vertical outer shell (57) of the RNC (77) where it is being stowed (29) in the reservoir region (51) of the RNC's (77) substantially vertical outer shell (57).

21) FIG. 21 illustrates a detailed aerial view of the outlet (28) orifice of the liquid conveying capillary (19) and its arrangement with the dimension of the ply (46) of the RNC's (77) substantially vertical outer shell (57).

22) FIG. 22 illustrates directions (50) of fluid flow in relation to the center section (45) of the RNC (77). The fluid is being drawn in the respective directions (50) in light of a vacuuming effect induced by the expansion (15) of the RNC's (77) reservoir region (51) and by the capillary (19) action of the RNC's (77) composite.

23) FIG. 23 illustrates directions (50) of fluid flow going into the inlet (27) orifice of the capillary (19), through the capillary's (19) hallowed core (52), and out of the capillary (19) via the capillary's (19) outlet (28) orifice. The fluid is being drawn in the respective directions (50) in light of a vacuuming effect induced by the expansion (15) of the RNC's (77) reservoir region (51) and by capillary (19) action of the RNC's (77) composite (74).

24) FIG. 24 illustrates an inlet (27) of a liquid conveying capillary (19) where it is truncated at the border of the center section (45) of the RNC (77) and with cross sectional views of the hemp (12) that comprises the composite (74) of the RNC (77). Through the vacuuming effect of the RNC's (77) substantially vertical outer shell (57) that is induced by it expanding (15) water (33) is entering into the liquid conveying capillary (19) and being conveyed through the liquid conveying capillary (19) in the direction (50) of the liquid conveying capillary's (19) outlet (28).

25) FIG. 25 illustrates an outlet (28) of a liquid conveying capillary (19) where it is truncated within the substantially vertical outer shell (57) of the RNC's (77) reservoir region (51) and with cross sectional views of the hemp (12) that comprises the composite (74) of the RNC (77). Through the vacuuming effect of the RNC's (77) substantially vertical outer shell (57) that is induced by it expanding (15) liquid is being has been conveyed through the liquid conveying capillary (19) in the direction (50) of the liquid conveying capillary's (19) outlet (28) and is jettisoning from the liquid conveying capillary's (19) outlet (28) and into the substantially vertical outer shell (57) of the RNC (77) where it is being stow in the reservoir region (51) of the RNC's (77) substantially vertical outer shell (57).

26) FIG. 26 illustrates water (33), also understood herein as a water molecule (24) or volumetric of water (33) molecules (24).

27) FIG. 27 illustrates a cross-sectional view of micro-hurd (27) hemp (12).

28) FIG. 28 illustrates a detailed view of one end of a cross-sectional view of micro-hurd (27) hemp (12).

29) FIG. 29 illustrates a cross-sectional view of the expanded (15) substantially vertical outer shell (57) of the RNC's (77) reservoir region (51) in light of water (33) that is being stowed (29) within it and the molecular attraction of water (33) molecules (24) to water molecules (24) through the attraction of the auto-molecular bond (34) between the water (33) and the highly hydrophilic properties of the RNC's (77) composite (74) hemp (12).

30) FIG. 30 illustrates a water (33) permeable aerated pliable binding agent (30) binding a cross-section of micro-hurd hemp (12) together. The water (33) permeable pliable binding agent (30) is integrated within the RNC's (77) substantially vertical outer shell (57) of the composite (74) of the RNC (77) and holds fast the variant concentrations of micro-hemp (12) hurd that are distributed with the RNC's (77) composite.

31) FIG. 31 illustrates a gravitational field (59) acting downward (37).

32) FIG. 32 illustrates an invisible ink (63) earth green colorized swatch (59). In the preferred embodiment, once stowed (29) water (33) within the RNC's (77) reservoir region (51) contacts the invisible ink (63) the reaction between the water (33) and the ink (63) animates a recycle (100) message upon the RNC's (77) outer shell (57) in an earth green color. The earth green color contrasts well upon the earth color of the hemp (12) composite (74) that comprises the RNC's (77) composite (74). As well, the earth green color supports the aesthetic of the recycle (100) narrative and the recycle (100) endeavors to which the present invention is directed.

33) FIG. 33 illustrates a computerized tampography printer (58) that is connected to a network (66) and imprinting (73) an ink (63) recycle (100) message on the outer shell (57) of an RNC (77). The tampography printer (58) is located in a printing facility (43), is connected to a power source (44), and is powered on and operational. The tampography printer (58) has a volume of invisible ink (63) within its well and is imprinting (73) the term, “Recycle” (33) along with a recycle (100) emblem (39) upon the RNC's (77) outer shell (57).

34) FIG. 34 illustrates a cross-sectional point of view of the RNC's (77) reservoir region (51) from the undercarriage (7) of the RNC (77). The RNC's (77) reservoir region (51) is expanding (15) in light of water (33) stowing within it. The water (33) that is stowing within the RNC's (77) reservoir region (51) is contacting the ink (63) that is imprinted (73) on the RNC's (77) outer shell (57) and the reaction between the water (33) and the ink (63) is animating a recycling (33) message from invisible to visible. The reaction sequence, (a., b., c.) of water (33) stowing within the RNC's (77) reservoir region (51) is animating the recycle (100) message into an opaquer message as the RNC (77) stows more water (33) in the RNC's (77) reservoir region (51).

35) FIG. 35 illustrates a cross-sectional point of view of the RNC's (77) reservoir region (51) from the undercarriage (7) of the RNC (77). The RNC's (77) reservoir region (51) is expanding (15) in light of water (33) stowing within it. The water (33) that is stowing within the RNC's (77) reservoir region (51) is contacting the ink (63) that is imprinted (73) on the RNC's (77) outer shell (57) and the reaction between the water (33) and the ink (63) and is animating a recycling (33) message from invisible to visible. The reaction sequence, (a., b., c.) of water (33) stowing within the RNC's (77) reservoir region (51) is animating the recycle (100) message into an opaquer message as the RNC (77) stows more water (33) in the RNC's (77) reservoir region (51).

36) FIG. 36 illustrates the outer shell (57) of the RNC (77) that is expanding as water (33) stows within the RNC's (77) reservoir region (51). The RNC's (77) reservoir region (51) is expanding (15) in light of water (33) stowing within it. The water (33) that is stowing with the RNC's (77) reservoir region is contacting the ink (63) and the reaction between the water (33) and the ink (63) that is imprinted (73) on the RNC's (77) outer shell (57) and is animating a recycle (100) message from invisible to visible. The reaction sequence, (h., i., j.) of water (33) stowing within the RNC's (77) reservoir region (51) is animating the recycle (100) message into an opaquer message as the RNC (77) stows more water (33) in the RNC's (77) reservoir region (51).

37) FIG. 37 illustrates the outer shell (57) of the RNC (77) that is expanding (15) as water (33) is stowing within the RNC's (77) reservoir region (51). The RNC's (77) reservoir region (51) is expanding (15) in light of water (33) stowing within it. The water (33) that is stowing with the RNC's (77) reservoir region (51) is contacting the ink (63) that is imprinted (73) on the RNC's (77) outer shell (57) and the reaction between the water (33) and the ink (63) and is animating a recycle (100) message from invisible to visible. The reaction sequence, (k., l., m.) of water (33) stowing within the RNC's (77) reservoir region (51) is animating the recycle (100) message into an opaquer message as the RNC (77) stows more water (33) in the RNC's (77) reservoir region (51). In light of sequence, ‘m,’ the recycle (100) narrative is fully visible upon the other shell (57) of the RNC (77).

38) FIG. 38 illustrates an ensemble (38), cup (1) or LCC (76)/RNC (77) that is being manually governed (31) to dry a pre-wet surface (2) as indicated by the intermittent line (41). Condensation droplets (8) are emanating upon the sidewall (56) of the LCC (76) and being drawn downward (37) by a gravitational field and are being absorbed by the RNC (77). A ‘Recycle’ (39) term and emblem are visible upon the outer shell (57) of the RNC (77). The surface (2) may be pre-wet in view of condensation pooling (10) from other non RNC (77) bearing cutlery (34), plates or from a previous liquid spill. The RNC (77) is expanded (15) in light of it stowing water (33) in its reservoir region (51).

39) FIG. 39 illustrates an empty (1) ensemble (38), LCC (76)/RNC (77) that has been utilized and is being recycled (33).

40) FIG. 40 illustrates the Networked Cloud Based Server (NCBS) (86) that is connected by the network (66) of the World Wide Web. The NCBS (86) and the computerized devices of the manufacturer (62), artisan (40) and Waste and Recycling Facility (WRF) (64) are all interconnected through the network (86). As all the devices are connected through the network (66) and are programmed by their respective POSITAS (P) (120) they are synchronized for the purpose of information exchange that is vital to efficiency of the full-loop system of the manufacture, utilization and recycling of the SPCs (1) and the CCCCs (14). 41) FIG. 41 illustrates a POSITA (120) determining the characteristics (71) of an SPC (1).

42) FIG. 42 illustrates a unique identifying motif (75) that contains the characteristics (71) of the SPC (1) that were characterized by a POSITA (120).

43) FIG. 43 illustrates a POSITA assigning the unique identifying motif that contains the characteristics of the SPC to the SPC.

44) FIG. 44 illustrates the POSITA (120) uploading (50) the motif (75) that contains the unique characteristics (71) of the SPC (1) into the network (66) and imprinting (80) the motif (75) on the SPC (1). In the present instance the motif (75) is comprised of a DotCode. A POSITA (120) will recognize that a DotCode is a two-dimensional barcode composed of discrete dots arranged in a grid, designed for high-speed marking on moving products, especially in industrial and packaging applications. Unlike traditional barcodes, DotCodes are optimized for fast, on-the-fly printing and can encode alphanumeric data efficiently in small spaces. Additionally, as the drawing and their associated description are intended to be understood in an illustrative rather than a limiting sense other way of marking the cup may include though are not limited to; 1) Infrared-Responsive Ink Motifs ink visible only under infrared (IR) light, which remains detectable even if the cup is crushed or soiled. The IR-responsive inks can encode recycling identifiers that a camera with an IR filter can read, 2) UV-Fluorescent Markings that are invisible under standard lighting, these motifs fluoresce under UV light. Even in dirty or crushed conditions, the motif can be scanned and interpreted by the system if placed strategically (e.g., around the base or inside lip), 3) Embedded RFID-Reflective Micro-Patterns which are microscopic antenna-like patterns embossed or laser-etched into the cup's surface can reflect specific frequencies from RFID or millimeter-wave scanners, allowing passive detection and identification, 4) Spectrally-Unique Pigment Bands (Hyperspectral Signature) which are a narrow ring or section of the cup can be composed of pigments with a spectral signature detectable by hyperspectral cameras, even when mixed in color with the base material. This is particularly effective for crushed forms, 5) Die-Molded Surface Topographies whereby the cup is produced with a die that leaves nearly invisible but structured micro-textures (e.g., patterns of dots, ridges, or bar-style arrays). These could be identified using photometric stereo scanning or 3D vision analysis, 6) Engraved Micro QR or DotCode, whereas instead of printed, the DotCode or QR motif is engraved or micro-embossed into the cup wall. This remains visible to optical scanning systems even after deformation, and doesn't rely on ink or colorants that might degrade, 7) Conductive Polymer Filament Striping which is a narrow filament of carbon-loaded or metallic polymer integrated into the wall or base of the cup, detectable via electromagnetic sensing (e.g., eddy current detection or near-field scanning) and 8) Phase-Change Ink Patches which are thermochromic or photochromic motifs that change appearance based on exposure to heat or light can encode data by dynamically revealing hidden elements under specific facility-controlled conditions (e.g., during scanning under intense lighting). Each of these motifs or features could be considered a subclass of a broader “motif” definition and could be used individually or in combination to increase redundancy and sorting accuracy in automated systems as determined by practice of the invention.

45) FIG. 45 illustrates a digital image (90) of a prior to utilization SPC (1) with the imprint (80) of its unique identifying motif (75) that has been upload (50) into the NCBS (86) by a POSITA (120).

46) FIG. 46 illustrates an SPC (1) imprinted with its unique identifying motif (75) and attached CCCC (14) being reclaimed (50) into the infrastructure of recycling (100) by its consumer (101).

47) FIG. 47 illustrates an SPC (1) that is imprinted with its unique identifying motif (75) being (50) hydraulically crushed (89) flattened and deformed and its CCCC being shattered (84) and falling off of the SPC (1).

48) FIG. 48 illustrates a hydraulically crushed and flattened SPC (1) and its unique identifying motifs (75) that appear on several areas of the SPC (1).

49) FIG. 49 illustrates a digital image (90) of a hydraulically crushed and flattened SPC (1) and its unique identifying motifs (75) that appear on several areas of the SPC (1) that has been uploaded (50) into NCBS (86) by the POSITA (120).

50) FIG. 50 illustrates a prior to utilization unattached CCCC (14). In the present instance the CCCC (14) such that it attaches into the recess of cup's (1) subjacent structural rib. Although as illustration 50 and all illustrations are intended to be illustrative and not limiting the CCCC (14) may be comprised of any form and attached by any means to any part of the CCCC (14). Examples include, though not limited by such examples; 1) the CCCC (14) may be formed to attach around the midsection of the cup and therefore be formed a sleeve or wrap, 2) the CCCC (14) can be comprised of an undercarriage alone, 3) it may be comprised of more than one part and assembled to the cup (1), 4) its shape may be formed integrally as a part of whole of the cup (91), 5) the CCCC (14) may be formed in an Upper-Rim Skirt Formation as a downward-facing collar or skirt that frictionally or loosely hangs from the upper rim or lip of the SPC (1), draping downward and collecting condensation that trickles down the sidewall before reaching the cup's (1) lower half, 6) as a Full-Body configured as a cylindrical or frustoconical sheath that envelops nearly the entire outer surface of the SPC (1), 7) Segmented Band Array composed of a series of ringed segments or modular bands that are spaced vertically along the SPC's (1) sidewall (56), enabling localized collection of streaming condensation (8) and offering modular construction, 8) Footed Pedestal Formation shaped as an extended pedestal base that protrudes beyond the diameter of the SPC's (1) undercarriage (26), providing both elevation and condensation pooling (10) space, optionally with radial fins or channels for flow dispersion, 9) Tripod or Multi-Arm Lattice Configuration configured with three or more spaced arms or lattice-like protrusions that engage the SPC (1) at isolated contact points (e.g., midsection, base, and lower wall) while leaving open areas in between for airflow or visual design, 10) Clamshell-Style Interlocking Halves formed in two opposing, hinged or lockable halves that enclose the SPC's (1) lower half or midsection like a clamshell, offering both protective cushioning and water absorption from multiple contact zones, 11) Integrated Handle Band, the CCCC (14) may include a formed loop or handle component that wraps around a portion of the SPC's (1) body, particularly near its mid-to-upper wall, simultaneously providing grip and functioning as a condensation-absorbent (9) element, 12) Nestable Collar with Flared Lip shaped as a flared upward-facing collar that cups the lower portion of the SPC (1), with the flare extending above the undercarriage or lower sidewall (56) to intercept descending moisture (8) and direct (5) it inward toward a central absorbent cavity.

51) FIG. 51 illustrates the composites (12) of the CCCC (14) being hydraulically crushed (89).

52) FIG. 52 illustrates the composites (12) of the hydraulically crushed (89) CCCC (14).

53) FIG. 53 illustrates a POSITA (120) determining the characteristics (71) of the composite of the CCCC (14) and converting the characteristics (71) such as though not limited to weight, dimensions, molecular structures, colorization, particle density and materials composites to digital data for the purpose of correlating it to the unique identifying motif (75) that will be assigned to the SPC (1). In its preferred embodiment the composite of the CCCC (14) is comprised of hemp fiber and hemp hurd while the CCCC's (14) naturally occurring binding agents (25) and heterogeneous composite materials (51) exhibiting hydrophilic absorbent properties such as agar agar or Wheat Starch. Although the CCCC's (14) may be comprised of any compostable composite and binding agents that exhibits highly hydrophilic properties.

54) FIG. 54 illustrates a digital image (90) of the composites (12) of the hydraulically crushed (84) CCCC that has been uploaded (50) into the NCBS (86) by a POSITA (120).

55) FIG. 55 illustrates a digital imaging scanner (76) that has been programmed by a POSITA (120) to scan and recognize (88) the spectral signature (e.g., Near-Infrared-NIR or Mid-Infrared-MIR) of the spectroscopy of the unique identifying motifs (75) of the hydraulically crushed (83) SPC (1) while they are moving upon conveyor belts (87) of waste and recycling facilities (64) for the purpose of scanning (88) the unique identifying motifs (75) the SPC (1) on the waste and recycling facility's (64) conveyor belt (87) so it can be sorted (50) downstream into its respective recycling bin (110).

56) FIG. 56 illustrates a digital imaging scanner (76) that has been programmed by a POSITA (120) to scan and recognize (88) the signature of the crushed (85) CCCC (14) fragments of hydraulically crushed (89) CCCCs (91) while they are moving upon conveyor belts (87) of waste and recycling facilities (64) for the purpose of scanning (88) the fragments of the CCCC (1) while they are moving on the waste and recycling facility's (64) conveyor belts (87) so they can be machine sorted (50) downstream into their respective recycling bin (100).

57) FIG. 57 illustrates the hydraulically crushed (89) and fragmented (84) composites (12) of a CCCC (14) that have been scanned (88) for sorting (50) and are on the moving conveyor belt (87) of the waste and recycling facility (64) and being sorted (50) into their respective recycling bin (100). Examples of the way the fragments of the CCCC may be auto-sorted via machinery into their respective recycling bin include though are not limited to such inclusions as; 1) Pneumatic Jet Array Divergence a single directional air pulse, a high-resolution array of directional pneumatic jets may be activated in sequence to redirect specific fragments (84) in-flight based on their digital scan (88), causing selected particles to arc or skip off the main belt trajectory into a targeted receptacle. This method allows precise, momentary trajectory corrections for high-speed sorting, 2) Robotic Arm or Soft-Actuator Grasping that is programmed by a POSITA (120) for a picking arm or soft gripper actuator system that responds to the digital identification (88) of a CCCC fragment (84), descending to grasp and remove the specific piece from the moving belt (87) and deposit it into its correct recycling stream (100), his technique is particularly beneficial for irregularly shaped or fragile composites, or 3) Directed Vibrational Channeling a vibrationally actuated deflection panels may be placed beneath or adjacent to the belt (87), producing frequency-specific oscillations that mobilize fragments (84) into branching channels based on their composite resonance or frictional response. This allows fragment redirection without physical contact or propulsion, reducing risk of cross-contamination.

58) FIG. 58 illustrates a hydraulically crushed (89) SPC 91) with the unique identifying imprints (75) that have been scanned (88) for sorting (50) and is on the moving conveyor belt (87) of the waste and recycling facility (87) and being sorted (50) into its respective recycling bin (110). Examples of the ways the hydraulically crushed SPCs (83) may be sorted (50) into their respective recycling bin include though are not limited to such inclusion are; 1) Optical Reflection-Based Sorting Gate that is utilized in cases where the identifying motifs (75) that are embedded in the hydraulically crushed SPC (83) by using optically reflective or refractive material (e.g., near-infrared pigments or translucent barcoding), optical readers confirm classification, and a sorting (50) gate (either a pivoting barrier or sliding chute) is mechanically actuated to separate the SPC (83) into its assigned bin (110) upon passing the reader, 2) Active Flap Deflector System which is a segmented deflector flap embedded along the edge of the conveyor (87) may actuate upon receipt of sorting data. Once the scanned (88) hydraulically crushed SPC (83) is within reach, the flap momentarily raises, diverting (50) the hydraulically crushed SPC (83) laterally into its corresponding bin (110) while allowing non-target items to pass uninterrupted, and 3) a Gravity Drop Chute Sorting where the conveyor (87) may include drop zones at predefined intervals. When the scanned hydraulically crushed SPC (83) with validated identifying imprints (75) reaches a sorting (50) point, a trap door beneath it opens briefly, allowing the hydraulically crushed SPC (83) to fall by gravity into a vertically aligned recycling chute connected into its respective recycling bin (110).

FIG. 59 illustrates Flow Chart 1 of the manufacturing phase of the full-loop system for the manufacture, utilization, and reclamation of single-use plastic cups (SPCs) and condensation collecting couplings comprised of composites (CCCCs). The process begins with the selection of naturally occurring binding agents and heterogeneous composite materials exhibiting hydrophilic absorbent properties for the manufacture of the CCCC. These selected materials are used in the manufacture of the CCCC, which is designed to absorb condensation and be compostable. Concurrently, bioplastics exhibiting hydrophobic properties are selected and used to manufacture the SPC, ensuring that the SPC itself is recyclable. In parallel, identifying digital motifs are developed to uniquely characterize each SPC (1) as recyclable. Characteristics of the CCCCs are determined and converted into digital data for subsequent programmatic recognition. The processes illustrated in FIG. 1 constitute the foundational design and material integration steps within the full-loop system.

FIG. 60 illustrates Flow Chart 2 of the pre-utilization and utilization phases of the full-loop system. During this phase, each SPC is characterized by identifying motifs applied to the SPC's shell during manufacture. The CCCC is attached to the SPC to form an integrated unit referred to as an S/C. Prior to utilization, the S/C is digitally imaged to capture its identifying motifs and structural configuration. These digital images are uploaded to a networked cloud-based server (NCBS), which is programmed to recognize the identifying features of the S/C in its pre-utilization state. This phase may include user-interactive functionality, such as behavior-prompting visual indicia that activate during utilization to prompt recycling behavior, while also maintaining digital traceability through the NCBS.

FIG. 61 illustrates Flow Chart 3 of the post-utilization and data integration phase of the full-loop system. Following utilization, the SPC and CCCC may become hydraulically crushed through the normal course of disposal or transit. Digital images of the hydraulically crushed SPCs and composites of the CCCCs are captured and uploaded to the NCBS. The NCBS is programmed to recognize SPCs and CCCCs from digital images of their hydraulically crushed states by analyzing identifying motifs and composite characteristics. Multiple images in different orientations are processed to enhance recognition accuracy. The digital images and data are transmitted from the NCBS to networked waste and recycling sorting facilities. These facilities contain computerized robotic sorting machines programmed to utilize the transmitted data to identify, target, sort, and reclaim the SPCs and CCCCs into their appropriate recycling streams. The steps illustrated in flow chart 3 completes the full-loop system, providing a unified lifecycle that integrates design, user engagement, and automated post-use reclamation for the purpose of providing customer convenience and expanding the infrastructure of recycling.

### Foregoing Description

The foregoing description presents the best mode contemplated by the inventor for practicing the full-loop method, process, and system of the present invention, detailing its manufacture, utilization, and reclamation in a unified ecological framework. This invention encompasses the integration of behavioral prompting, ergonomic design, recyclable composite materials, and intelligent imprinting to direct single-use plastic cups and their couplings into the infrastructure of recycling. The materials, structures, and processes described herein enable one of ordinary skilled in the relevant arts including sustainable packaging, manufacturing, beverage serving and waste and recycling management to make and use the invention.

The disclosure should be interpreted as illustrative, not limiting. Terms such as “invention,” “system,” “method,” “device,” or “technology” may be used interchangeably depending on context, and singular forms may include plural equivalents. Terminology such as “invention,” “device,” “method,” “process,” “system,” and “apparatus” whereby all nomenclature and acronyms may be and herein often are used interchangeably where context allows. Various embodiments are often referred to utilizing different names and numbers predicated upon the context in which they are described. Where numerals in the drawings are underscored the underscores are intended to denote an area or two embodiments taken collectively.

The specification, drawings, and claims collectively define the scope and function of the invention while inviting further innovation and development. This invention establishes a revolving design paradigm a full-loop system, from premeditated, eco-conscious manufacturing through dynamic user interaction and intelligent post-use reclamation. The invention is specifically engineered to preserve vital environmental resources such as air, water, and soil, while expanding and modernizing recycling infrastructure.

While within the present characterizations of the invention the characterizations refer to the invention as a, 1) Method of directing utilized drinking cups into the infrastructure of recycling. 2) Process of increasing the infrastructure of recycling and, 3) Full-loop system for the manufacture, utilization, and reclamation of single-use plastic cups into the infrastructure of recycling the characterization are directed to the same and singular species. The invention as described herein may be adapted, in part or as a whole, into various sub-systems, modular assemblies, or alternate embodiments, which may be claimed separately or in association to this or in related filings.

Looking ahead, the invention is organized for integration into the evolving landscape of digital and computational innovation. Its data-centric approach to material recognition, imprint encoding, and sorting coordination aligns naturally with advancements in artificial intelligence (AI), machine learning, computer vision, and robotic automation. Moreover, the invention's modular, data-enhanced architecture anticipates future synergies with quantum computing where the vast parallel processing power of quantum systems may allow for optimization of recycling logistics, predictive modeling of material recovery streams, and enhanced pattern recognition across multi-variable environmental data sets.

By embracing current and emerging technologies and integrating them into the full-loop conceptual quality of the present invention they serve as a bridge between ecological design and computational intelligence, enabling a scalable, responsive, and forward-compatible system for circular resource management. Accordingly, the claims appended hereto delineate the metes and bounds of the invention of which at their conceptual level are dually formed to provide for enhancing customer convenience in tandem with increasing the infrastructure of recycling through increasing recycling of single-use plastic cups for the purpose of preserving the life sustaining elements of the air, water and soil.

1. Method of directing utilized drinking cups into the infrastructure of recycling by indicating to drinking cup utilizers through recycling themed imprints that animate from invisible to visible upon a ‘Recycle Narrating Coupling’ (RNC), that accompanies a cup, or ‘Liquid Carrying Container’ (LCC), when assembled, herein understood as an (LCC/RNC), whereas the recycling themed imprints animate upon the RNC during utilization, when the user of the LCC/RNC, herein understood as a ‘utilizer’, utilizes its tandem utilities of condensation absorption and water activated recycling themed imprints such that post utilization of the LCC/RNC it is readied for composting and for the infrastructure of recycling, whereas;
(a) the RNC comprising organic binding agents and organic composites possessing naturally occurring structures exhibiting hydrophilic auto-molecular liquid absorbent properties;
(b) the RNC formed with; (i) an aperture (ii) a substantially horizontally planar undercarriage, (iii) a substantially vertical outer shell comprising a sidewall, (iv) capillaries, (v) a thickness, (vi) a reservoir region, (vii) a rim, (viii) a heel, (ix) a center section, (x) and a dimensioned interior cabin;
(c) the LCC comprising bioplastics exhibiting hydrophobic properties;
(d) the LCC formed with; (i) an aperture, (ii) a substantially horizontally planar undercarriage, (iii) a substantially vertical outer shell, (iv) a flange, (v) and a lower portion comprising a dimensioned compartment;
(e) the RNC manufactured independently of the LCC's manufacture;
(f) alternatively, the RNC manufactured with the LCC;
(g) the LCC's compartment formed such that a dimension of the RNC's interior cabin accommodates a dimension of the LCC's compartment whereby LCC's compartment mounts securely into the RNC's interior cabin;
(h) the RNC's interior cabin mounted into the LCC's compartment prior to utilization;
(i) the RNC, mounted within the LCC's compartment, absorbs condensation emanating upon the LCC's sidewall while it streams into the upper rim of the RNC, and its substantially planar undercarriage absorbs pooled surface condensation during utilization;
(j) the RNC's composite comprising a liquid reservoir region embedded within the thickness of its substantially vertical outer shell, adapted to absorb, expand, and stow a volumetric of condensation;
(k) the thickness of the RNC's substantially horizontally planar undercarriage containing embedded hollow cored liquid conveying capillaries truncated with orifices for liquid inlet and outlet;
(1) the RNC's embedded liquid conveying capillaries, truncated with liquid inlet orifices at a border of the center section of the RNC, arranged horizontally to radiate from the border of the center section of the RNC, extend radially through the RNC's undercarriage, bend upwards at the RNC's heel and extend into the liquid reservoir region of the substantially vertical outer shell of the RNC, truncating with orifices comprising liquid outlets;
(m) the RNC's liquid conveying capillaries comprising hollow cores that provide channels to convey fluid parallel and vertical to a horizontal plane through mechanisms induced by capillary action originating from the properties of the RNC's composite and induced by a vacuuming effect originating from the expansion of its outer shell while absorbing and stowing condensation;
(n) the water activated invisible ink, imprinted by a networked computerized imprinter, imprints recycling themes upon the sidewall of the RNC;
(o) the water-activated invisible ink imprints interact with condensation stowed within the RNC's reservoir region activating the water activated invisible ink and animate the invisible recycling themed imprints into visible recycling themed imprints upon the sidewall of the RNC's composite; and,
(p) the dual utilities of the LCC/RNC function in tandem, wherein its condensation absorption utility and recycling-themed imprints utility visibly indicate its recyclability during utilization and post-utilization facilitate its direction into the infrastructure of recycling.

2. Process of increasing the infrastructure of recycling, by expanding recycling of single-utilization Plastic Cups (PC), by pairing the PC with an Eco-friendly Coupling (EC), the pairing herein understood as an ‘ECPC’ and providing it to a user, herein understood as a ‘Regulator,’ and whereas:
(a) selecting, prior to manufacture of the PC, resources involving biodegradable, eco-friendly, recyclable composites exhibiting hydrophobic properties;
(b) selecting, prior to manufacture of the EC, naturally occurring binding agents and naturally occurring composites involving heterogeneous particle compositions with varying concentrations exhibiting intrinsic hydrophilic absorption and retention properties;
(c) engineering, prior to its manufacture, the structure of the PC with at least: (i) a fluid receptacle, (ii) an outer shell, (iii) a sidewall, (iv) an upper rim, (v) a heel, (vi) a planar undercarriage extending substantially along a horizontal plane, (vii) and a basal section comprising a predetermined dimension for form-fitting engagement with the interior cabin of the EC;
(d) manufacturing, independent of the EC, the PC;
(e) engineering, prior to its manufacture, the structure of the EC with at least: (i) an upper rim, (ii) a heel, (iii) a defined thickness, (iv) a reservoir region, (v) capillary pathways, (vi) a center section comprising a border, (vii) a planar undercarriage extending substantially along a horizontal plane, (ix) a substantially vertical outer shell comprising a sidewall, (x) an interior cabin dimensioned for form-fitting engagement with the basal section of the PC;
(f) manufacturing, independent of the PC, the EC;
(g) pairing, prior to utilization, the EC and PC to form the ECPC;
(h) embedding, through manufacturing processes, the EC's composite with hollowed cored liquid conveying capillaries such that the liquid conveying capillaries comprise an arrangement within the thickness of the composite of the EC's planar undercarriage and comprise truncations at a border of the center section of the EC with liquid inlet orifices and horizontally radiate from the border of the center section of the EC and extend through the EC's undercarriage, bend upwards at its heel to extend into the substantially vertical outer shell of the EC's outer shell and into the porous matrix of the liquid reservoir region of the EC where the truncated liquid conveying capillaries comprise liquid outlet orifices that outlet moving liquid induced by capillary action originating from the EC's composite by a vacuuming effect originating from the expansion of the EC's outer shell while absorbing and stowing water;
(i) formulating, through manufacturing processes, the EC's composite such that the EC's composite hydrophilic liquid absorbent properties absorb pooled surface condensation through its substantially planar undercarriage, and absorb streaming condensation through its upper rim and outer shell when condensation emanates upon the sidewall of the PC and flows into the EC;
(j) programming, by a programming process, a networked computerized imprinting system to apply ecological recycling indicia comprising water-activated invisible ink on the substantially vertical outer shell of the EC's composite and imprinting the water activated invisible ink ecological recycling indicia upon the substantially vertical outer shell of the EC's composite;
(k) formulating, through manufacturing processes, the EC's composite such that the water activated invisible ink imprinted indicia upon the substantially vertical outer shell of the EC's composite interacts with water stowed within the EC's reservoir region during utilization that causes the invisible ink to undergo a dynamic colorized pigment phase that transitions the ecological recycling indicia imprinted upon the outer shell of the EC from invisible to visible;
(l) supplying, through distribution processes, the ECPC to practitioners that provide single-use beverage containers to regulators; and,
(m) displaying, to the regulator of the ECPC, animated ecological recycling indicia imprinted on the outer shell of the EC, wherein the indicia become visible during utilization such that the regulator of the ECPC, post-utilization of the ECPC, regulates it to recycling, thereby increasing the infrastructure of recycling by expanding recycling of single-utilization plastic cups.

3. Full-loop system for the manufacture, utilization, and reclamation of single-use plastic cups into the infrastructure of recycling, comprising: a prior-to-utilization Single-use Plastic Cup (SPC) involving a shell that is characterized with digitized identifying motifs, a Condensation Collecting Coupling comprised of Composites (CCCC), and attaching the CCCC to the SPC, herein known as a “S/C”, a Networked Cloud-Based Server (NCBS), wherein the system embodies a unified lifecycle innovation that integrates: (i) engineered design and material selection during manufacture, (ii) user-interactive features during utilization, and (iii) computerized programmatic intelligent recognition and robotic sorting post-utilization. This full-loop system originates at inception with purposeful design and compostable composites, functions through behavior prompting visual animating indicia during utilization, and revolves in a digital infrastructure that facilitates programmatically automated reclamation, collectively enabling a systemic pathway of manufacture, utilization, and reclamation of the S/C for the purpose of expanding the infrastructure of recycling whereby;
a) selecting, prior to manufacture of the CCCC, naturally occurring binding agents and naturally occurring composites involving heterogeneous particle compositions with varying concentrations exhibiting intrinsic hydrophilic absorption and retention properties;
b) manufacturing the CCCC from the composites;
c) selecting, prior to utilization of the SPC, bioplastics exhibiting hydrophobic properties;
d) manufacturing the SPC from the bioplastics;
e) digitally developing identifying motifs that characterize SPCs as recyclable single-use plastic cups;
f) determining characteristics of the CCCC and converting the characteristics into digital data;
g) characterizing the prior to utilization SPC during manufacture with identifying motifs such that the identifying motifs appear upon the shell of the prior to utilization SPC;
h) attaching the CCCC to the SPC prior to utilization of the SPC, (S/C);
i) digitally imaging the prior to utilization SPC prior to its utilization that is characterized with identifying motifs that appear upon the shell of the SPC and has an attached CCCC, S/C;
j) programming the computer of the NCBS to recognize a prior to utilization S/C;
k) programming the computer of the NCBS to recognize a hydraulically crushed SPC that is characterized with identifying motifs upon its shell within a digital image of the hydraulically crushed the SPC;
l) orienting the hydraulically crushed SPC that is characterized with identifying motifs on its shell at multiple different degrees and digitally imaging the hydraulically crushed SPC that is characterized with identifying motifs upon its shell and is orientated in multiple different degrees;
m) programming the computer of the NCBS to recognize the SPCs in multiples of digital images of the hydraulically crushed SPCs that are characterized with identifying motifs on their shells and are oriented in multiple different degrees;
n) digitally imaging a hydraulically crushed composite of the CCCC and uploading the digital image of the hydraulically crushed composite of the CCCC into the computer of the NCBS;
o) programming the computer of the NCBS to recognize the composite of a hydraulically crushed CCCC in a digital image of the hydraulically crushed CCCC; and,
p) providing S/Cs to consumers of S/Cs for utilization and recycling of the S/Cs.

4. The full-loop system for manufacture, utilization and reclamation of single-use plastic cups into the infrastructure of recycling of claim 3 further characterized as transmitting the digital images and data through the network of its NCBS to networked waste and recycling sorting facilities that contain networked computerized waste and recycling programmatic robotic sorting machines such that the waste and recycling sorting facilities transmit the digital images and data to their networked computerized waste and recycling robotic sorting machines in order to programmatically recognize the identifying motifs on the hydraulically crushed SPCs and the determining characteristics of the CCCCs that have been converted into digital data and digital images of the CCCCs and robotically target, sort and reclaim hydraulically crushed SPCs and hydraulically crushed composites of the CCCCs and sort them into their respective bins or streams of the infrastructure of recycling thereby effectuating a full-loop system for revolving the manufacture, utilization and reclamation of S/Cs into the infrastructure of recycling.
